(19) United States
(12) Patent Application Publication
(10) Pub. No.: US 2010/0024954 A1
(43) Pub. Date: Feb. 4, 2010

(54) APPARATUS AND METHOD FOR MANUFACTURING PHOTOSENSITIVE LAMINATE, PHOTOSENSITIVE TRANSFER MATERIAL, RIB AND METHOD FOR FORMING THE SAME, METHOD FOR MANUFACTURING LAMINATE, MEMBER FOR DISPLAY DEVICE, COLOR FILTER FOR DISPLAY DEVICE, METHOD FOR MANUFACTURING COLOR FILTER, AND DISPLAY DEVICE

(75) Inventors: Hideaki Ito, Shizuoka (JP); Takeshi Ando, Shizuoka (JP); Makoto Shimizu, Shizuoka (JP); Yasuhisa Watanabe, Shizuoka (JP); Nobuyasu Akiyoshi, Shizuoka (JP); Kazuyoshi Suehara, Shizuoka (JP)

Correspondence Address: Solaris Intellectual Property Group, PLLC, 401 Holland Lane, Suite 407, Alexandria, VA, 22314, US

(73) Assignee: FUJIFILM CORPORATION, Minato-ku, Tokyo (JP)

(21) Appl. No.: 12/443,182

(22) PCT Filed: Sep. 21, 2007
(86) PCT No.: PCT/JP2007/069132

§ 371 Date: Mar. 27, 2009

(30) Foreign Application Priority Data
Sep. 27, 2006 (JP) 2006-263386
Sep. 29, 2006 (JP) 2006-269997
Oct. 27, 2006 (JP) 2006-292793
Oct. 27, 2006 (JP) 2006-292976
Oct. 27, 2006 (JP) 2006-292984
Oct. 27, 2006 (JP) 2006-292987
Oct. 27, 2006 (JP) 2006-293013
Oct. 27, 2006 (JP) 2006-293113
Dec. 27, 2006 (JP) 2006-351674
Mar. 9, 2007 (JP) 2007-060227
Apr. 24, 2007 (JP) 2007-114568

(51) Int. Cl. B32B 38/18; G05G 15/04

(52) U.S. Cl. 156/64; 156/361

(57) ABSTRACT

A pasted substrate (24a) is produced by: detecting a half cut site (34) by CCD cameras (72a and 72b) constituting first and second detecting mechanisms (47a and 47b); calculating dislocation amounts (ΔLa and ΔLb) with respect to a reference position for each of photosensitive webs (22a and 22b); driving a rubber roller (80a) according to an arithmetic mean value (ΔL) of the dislocation amounts (ΔLa and ΔLb) to correct the feed amounts of the photosensitive webs (22a and 22b); then conveying a glass substrate (24) to a space between the rubber rollers (80a and 80b); and pasting the photosensitive webs (22a and 22b) thereto. There are also provided a photosensitive transfer material having a thermoplastic resin layer and a photosensitive resin layer, and in which a melt viscosity η_{K} of a photosensitive resin layer at 100° C., and a melt viscosity η_{Cu} of a thermoplastic resin layer at 100° C. satisfy a relationship of η_{K}/η_{Cu}>2.

### FIELD OF THE INVENTION

The first aspect of the present invention relates to an apparatus and a method for manufacturing a photosensitive laminate in which a photosensitive laminate is produced by delivering a substrate and a photosensitive web provided with a photosensitive material layer on a support, to a space between a pair of pressure rollers, and pasting the photosensitive material layer on the substrate.

The second aspect of the present invention relates to a photosensitive transfer material suitable for forming a rib for manufacturing a color filter utilizing an ink jet method, as well as a rib using the material and a method for forming the rib, a method for manufacturing a laminate suitable for preparing a rib such as a black matrix, as well as a member for a display device using this method, a color filter for a display device, a method for manufacturing a color filter, and a display device.

### DESCRIPTION OF THE RELATED ART

In the first aspect of the invention, for example, substrates for liquid crystal panels, printed circuits, and PDP panels are constructed by pasting a photosensitive sheet body (photosensitive web) having a photosensitive resin layer (photosensitive material layer) onto the surface of a substrate. The photosensitive sheet body has a photosensitive resin layer and a protective film sequentially laminated on a flexible plastic support.

Normally, manufacturing apparatuses used for pasting such a type of photosensitive sheet body employ a method in which substrates such as a glass substrate and a resin substrate are conveyed separated with predetermined intervals, and a protective film is peeled off from the photosensitive sheet body corresponding to the range of the photosensitive resin layer pasted on the substrates (refer to Japanese Patent Application Laid Open (JP-A) No. 11-34280 and JP-A No. 2006-23407).

For example, in the manufacturing apparatus shown in FIG. 21, a laminate film (photosensitive sheet body) 1a fed out from a film roll 1 is cut in the film width direction at two positions separated by a predetermined distance in the film conveyance direction leaving a support, by a disk cutter 2a constituting a half cutter 2. Next, a label is adhered to the cover film (protective film) on the front and rear of the cut part by a label adhering mechanism 3, and then the laminate film 1a is supplied to a suction drum 4. From the laminate film 1a supplied to the suction drum 4, the cover film connected by the label is continuously peeled off leaving predetermined remaining portions separated by the cut part, and wound around the cover film roll 5.

The laminate film 1a from which the cover film has been partially peeled off is supplied to a space between a pair of pressure rollers 6a and 6b. In this case, the pressure rollers 6a and 6b are respectively pressed by backup rollers 7a and 7b. Moreover, a substrate 8 is supplied to a space between the pressure rollers 6a and 6b. As a result, the photosensitive resin layer laminated on the laminate film 1a is pressed onto the substrate 8 supplied in the space between the pressure rollers 6a and 6b, forming a photosensitive laminate.

A manufacturing apparatus is also being developed which applies the manufacturing apparatus having such a structure, and pastes a plurality of laminate films 1a in parallel on one sheet of substrate 11 (refer to JP-A No. 2004-333616).

Incidentally, in order to accurately paste the peeled portions of the laminate film 1a from which the cover film is peeled off, onto a desired range of the substrate 8, the laminate film 1a has to be highly accurately fed to a space between the pressure rollers 6a and 6b with reference to boundary portions between the peeled portions and the remaining portions of the cover film.

However, the laminate film 1a comprises a photosensitive resin layer formed on a flexible support film, and is conveyed while a tension is applied thereto, causing concern of dislocation of the boundary portions due to extension occurring during the conveyance. Moreover, since the pressure rollers 6a and 6b paste the laminate film 1a and the substrate 8 while they are heated, the extension of the laminate film 1a is increased particularly in the vicinity of the pressure rollers 6a and 6b.

In this case, if the positions of the boundary portions in the laminate film 1a can be detected in the space between the pressure rollers 6a and 6b, the positions can be adjusted to perform a highly accurate pasting processing. However, in reality, it is impossible to detect the positions of the boundary portions while the laminate film 1a and the substrate 8 are held between the pressure rollers 6a and 6b, since the pressure rollers 6a and 6b interfere with the detection.

Therefore, a disadvantage is pointed out in that, in the case where a produced photosensitive laminate is taken out for examination and the accuracy of the paste position is reduced, processing such as adjustment of the feed amount of the laminate film 1a has to be performed, reducing the producibility, and photosensitive laminates out of the acceptable range are produced, reducing the yield.

On the other hand, time required for pasting the photosensitive resin layer of the laminate film 1a onto the substrate 8 is limited by the tact time of the overall manufacturing apparatus including processing steps after the pasting. Accordingly, in the manufacturing apparatus, the rotational speed and the like of the pressure rollers 6a and 6b is set with consideration of this tact time.

However, when a large number of photosensitive laminates are continuously produced, properties of the pressure rollers 6a and 6b and the laminate film 1a are not fixed at all times. For example, when the frictional coefficients of the surfaces of the pressure rollers 6a and 6b are changed, spaces between the laminate film 1a and the pressure rollers 6a and 6b become slippery, causing concern of fluctuation of the time required for pasting. If the time required for pasting fluctuates, there is concern of a difference in the quality of the produced photosensitive laminates.

Moreover, since the pressure rollers 6a and 6b heat and hold the substrate 8 and the laminate film 1a to laminate, the surface temperature of the pressure rollers 6a and 6b is heated to a temperature capable of sufficiently heating the photosensitive resin layer.

At this time, the laminate film 1a slidably contacts with the surface of the pressure rollers 6a, and thus the laminate film 1a is exposed to a substantially high temperature. Accordingly, the laminate film 1a is easily wrinkled, causing a problem of bubbles generated inside due to wrinkles. As a result, a problem of lowering the laminate quality occurs. Furthermore, if the state of conveyance of the laminate film 1a between the pressure rollers 6a and 6b is uneven, the photosensitive resin layer will have striped unevenness, concentration unevenness, and the like.

Moreover, when a plurality of laminate films 1a are concurrently pasted on one substrate 8, if the individual laminate films 1a are extended differently, the paste positions with respect to the substrate 8 are dislocated, causing concern of producing defective products.

Furthermore, when the laminate film 1a is pressingly bonded to the substrate 8, in order to produce a high quality photosensitive laminate, pressure has to be applied evenly along the longitudinal direction of the pressure rollers 6a and 6b, and thus highly rigid backup rollers 7a and 7b are pressed onto the pressure rollers 6a and 6b.

In this case, as shown in FIG. 22, since the backup rollers 7a and 7b are pressed onto the pressure rollers 6a and 6b by displacing the opposite ends thereof in the arrow directions, then, if the peripheral shapes of the backup rollers 7a and 7b are straight with respect to the axial direction, deformation of the backup rollers 7a and 7b causes an effect as shown in FIG. 23, in that the pressures at point A1 and point A2 corresponding to the opposite ends of the substrate 8 become higher than that of the central portion.

In order to avoid such an unevenness in pressure, a technique is proposed in which the peripheral shapes of the backup rollers 7a and 7b are made into a crown shape to increase the pressure in the central portion (refer to Japanese Patent Application No. 2005-192070). In this case, as shown in FIG. 22, if the opposite ends of the substrate 8 and the opposite ends of the pressure rollers 6a and 6b are set in an approximately same positional relation, there is concern in that, when the pressure rollers 6a and 6b are pressed onto the opposite ends of the substrate 8, the pressures in those parts are increased, becoming a causative factor of wrinkles or the like.

In the second aspect of the invention, in recent years, with development of a personal computer, particularly, a large screen liquid crystal television, there is a tendency that a demand for a liquid crystal display, inter alia, a color liquid crystal display is increased. However, since the color liquid crystal display is expensive, a demand for cost reduction is increased and, particularly, a demand for cost reduction for a color filter which highly influences on the cost is high.

In such a color filter, usually, a liquid crystal is operated as a shutter by providing a coloring pattern of three primary colors of red (R), green (G) and blue (B), and turning on and off electrodes corresponding to respective pixels of R, G and B. Light is passed through the respective pixels of R, G and B, thereby, a color is displayed.

As the conventional method for manufacturing the color filter, for example, a staining method is known. In this staining method, first, a water-soluble polymer material which is a material for staining is formed on a glass substrate, this is then patterned into a desired shape by a photolithography step, and the resulting pattern is immersed in a staining bath to obtain a colored pattern. By repeating this three times, colored pixels (color filter) of R, G and B can be formed.

As another method, there is a pigment dispersing method, and other examples include an electrodepositing method, and a method of dispersing a pigment in a thermosetting resin, performing printing three times for R, G and B, and thermosetting the resin.

In the pigment dispersing method, first, a photosensitive resin layer with a pigment dispersed therein is formed on a substrate, and this is patterned, thereby, a monochromic pattern is obtained. Further, by repeating this step three times, colored pixels (color filter) of R, G and B are formed.

As the pigment dispersing method, there are a coating method and a transferring method. A method of forming a black matrix by the transferring method, and forming pixels of R, G and B by the coating method of performing coating with a slit coater is advantageous in terms of easy formation of pixels, a precision of manufacturing a black matrix, and the cost, and this is known as one of general methods for manufacturing the color filter.

In any of the above methods, in order to perform coloring of, for examples, three colors of R, G and B, it is necessary to repeat the same step three times, and there are a problem of the high cost, and a problem that a yield is reduced due to repetition of the same step. Therefore, as a method of solving these problems, a method of forming a colored pixel by blowing a coloring ink utilizing an ink jet format has been proposed (e.g. see Japanese Patent Application Laid-Open (JP-A) Nos. 59-75205 and 2004-339332).

### DISCLOSURE OF THE INVENTION

In the first aspect of the invention, there is provided a manufacturing apparatus for a photosensitive laminate which produces a photosensitive laminate by: delivering a photosensitive web having a photosensitive material layer and a protective film sequentially laminated, onto a support; forming at least a processing site corresponding to a boundary position between a peeled portion and a remaining portion, in the protective film; peeling off the peeled portion of the protective film; continuously delivering the photosensitive web together with substrates supplied at predetermined intervals, to a space between a pair of pressure rollers; arranging the remaining portion of the protective film between the substrates; and pasting the exposed photosensitive material layer onto the substrate, comprising:

a processing site detector arranged in a predetermined site on a conveyance path for the photosensitive web between a processing section which forms the processing site and the pressure rollers, that detects the position of the processing site formed in the protective film;

a dislocation amount calculation section which calculates the dislocation amount of the processing site with respect to a reference position, detected by the processing site detector; and

a processing site position adjusting section which adjusts the position of the processing site with respect to the substrate, based on the dislocation amount calculated by the dislocation amount calculation section.

In the second aspect of the invention, there is provided a photosensitive transfer material for forming a rib having at least a thermoplastic resin layer and a photosensitive resin layer in this order from a provisional support side, on the provisional support,

wherein a melt viscosity η_{K} of the photosensitive resin layer at 100° C., and a melt viscosity η_{Cu} of the thermoplastic resin layer at 100° C. satisfy a relationship of η_{K}/η_{Cu}>2.

### BRIEF DESCRIPTION OF THE DRAWINGS

FIG. 1 is a schematic diagram of a manufacturing apparatus according to a first embodiment of the first aspect of the present invention.

FIG. 2 is a cross sectional view of a lengthy photosensitive web used for the manufacturing apparatus.

FIG. 3 is an explanatory diagram of the lengthy photosensitive web adhered with adhesive labels.

FIG. 4 is an explanatory diagram of an arrangement of a processing section which forms half cut sites, a processing site detector which detects the half cut site, and a pasting mechanism which pastes a lengthy photosensitive web onto a glass substrate.

FIG. 5 is a configuration block diagram for correction of the dislocation of the half cut sites.

FIG. 6 is an explanatory diagram for when peeling off a protective film from the lengthy photosensitive web.

FIG. 7 is an explanatory diagram of the pasted condition of two photosensitive webs pasted on a glass substrate.

FIG. 8 is a schematic diagram of a manufacturing apparatus according to a second embodiment of the first aspect of the present invention.

FIG. 9 is a configuration block diagram of an adjustment function for the rotational speed of the pressure rollers in a lamination controller.

FIG. 10 is a graph showing the relationship between the time required for pasting by means of a pasting mechanism and the feed amount of a substrate, with parameters of the static frictional coefficient and the ratio of the rotational speeds of the pressure rollers.

FIG. 11 is a graph showing the relationship between the ratio and the static frictional coefficient.

FIG. 12 is an explanatory diagram of another embodiment of the processing site detector which detects a half cut site.

FIG. 13 is a configuration block diagram of a judgement function for the pasted condition in the lamination controller.

FIG. 14 is a graph showing the relationship between the number of laminations and the static frictional coefficient of the pressure rollers.

FIG. 15 is a table showing the relationship between the static frictional coefficient of the pressure rollers, and bubbles and striped unevenness in the photosensitive laminate.

FIG. 16 is an explanatory diagram of the pasted condition of two lengthy photosensitive webs pasted on a substrate by the pressure rollers.

FIG. 17 is a table showing the relationship between the static frictional coefficient and the extension rate evaluation of the lengthy photosensitive web.

FIG. 18 is an explanatory diagram of a structure of the pressure rollers and the backup rollers in the pasting mechanism.

FIG. 19 is a graph showing the relationship between the substrate position and the pressure applied thereto.

FIG. 20 is an explanatory diagram of another structure of the pressure rollers and the backup rollers in the pasting mechanism.

FIG. 21 is a schematic diagram of a manufacturing apparatus according to prior art.

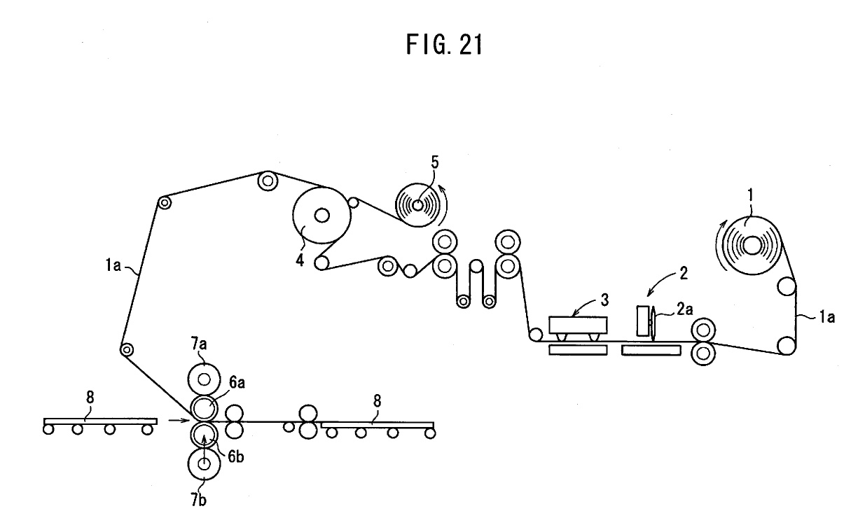

FIG. 22 is an explanatory diagram of a structure of pressure rollers and backup rollers in a comparative example.

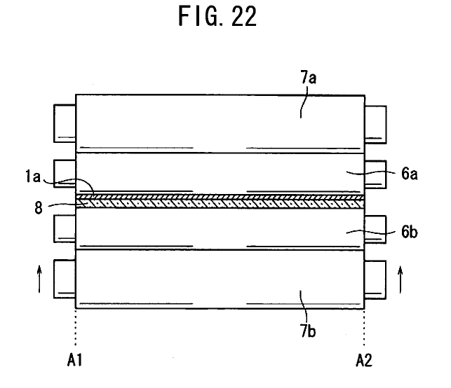

FIG. 23 is a graph showing the relationship between the substrate position and the pressure applied thereto, in the structure shown in FIG. 22.

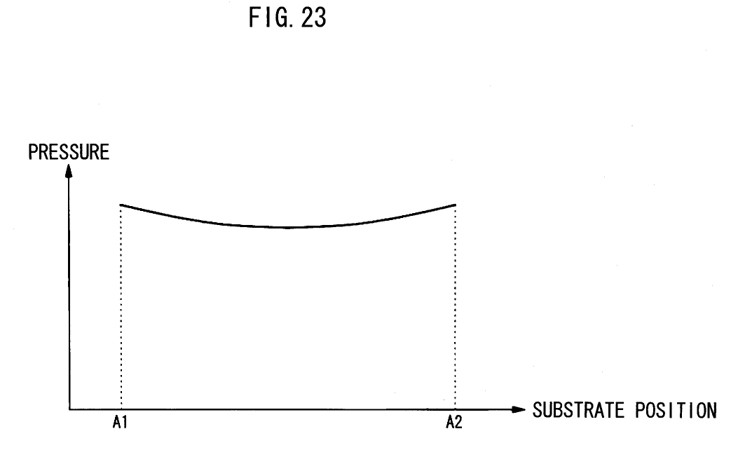

FIG. 24 is a schematic view for explaining a method of measuring a tension, when a laminator conveying system according to the second aspect of the invention is seen from a side direction.

FIG. 25 is a schematic plan view for explaining a method of measuring a tension, when the laminator conveying system of FIG. 24 is seen from an upper side.

### BEST MODE FOR CARRYING OUT THE INVENTION

### First Aspect of the Invention

An object of the present invention is to provide an apparatus and a method for manufacturing a photosensitive laminate capable of maintaining the accuracy of paste position of a photosensitive material layer with respect to a substrate, and capable of efficiently producing a high quality photosensitive laminate.

Moreover, another object of the present invention is to provide an apparatus and a method for manufacturing a photosensitive laminate capable of adjusting the time required for pasting within the tact time, and capable of producing a high quality photosensitive laminate without uneveness.

Yet another object of the present invention is to provide an apparatus and a method for manufacturing a photosensitive laminate capable of producing a high quality photosensitive laminate without mixed bubbles, striped unevenness, concentration unevenness, and the like.

Furthermore, another object of the present invention is to provide an apparatus and a method for manufacturing a photosensitive laminate capable of suppressing the dislocation of the relative paste position of a plurality of photosensitive webs, when a plurality of photosensitive webs are pasted in parallel on a substrate, and capable of producing a photosensitive laminate in an excellent condition.

Moreover, another object of the present invention is to provide an apparatus for manufacturing a photosensitive laminate capable of pressingly bonding the substrate and the photosensitive web with an even pressure force, and capable of producing a high quality photosensitive laminate without wrinkles and unevenness.

The above and other objects features and advantages of the present invention will become more apparent from the following description when taken in conjunction with the accompanying drawings in which a preferred embodiment of the present invention is shown by way of illustrative example.

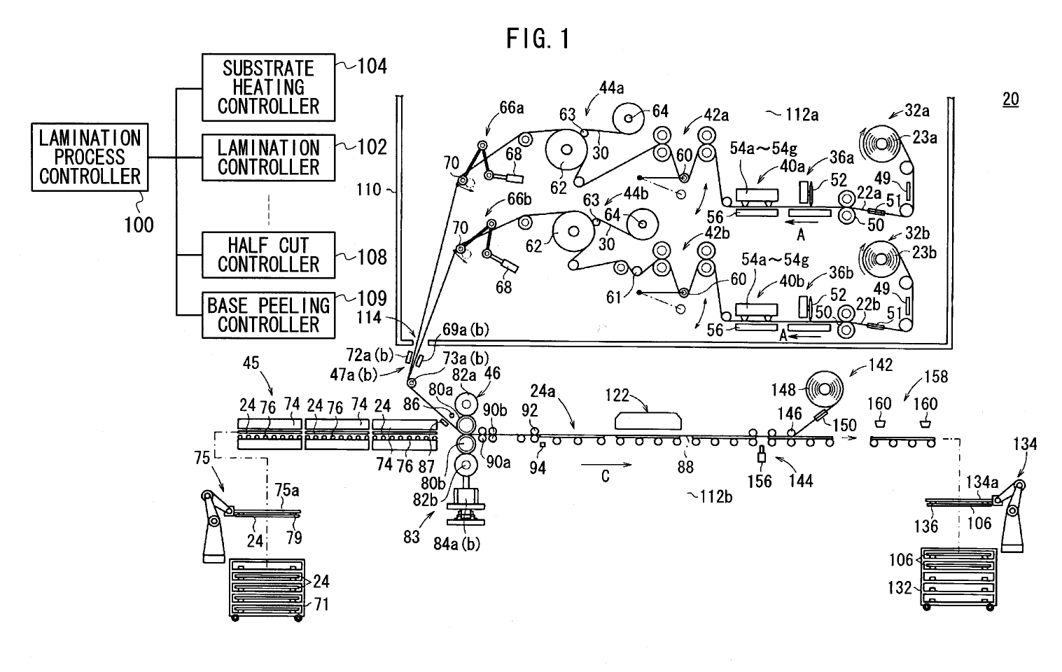

FIG. 1 is a schematic diagram of a manufacturing apparatus 20 for a photosensitive laminate according to a first embodiment of the present invention. This manufacturing apparatus 20 performs heat transfer of respective photosensitive resin layers 28 (described later) of lengthy photosensitive webs 22a and 22b in parallel onto a glass substrate 24, in a production process of color filters for liquid crystal or organic EL, or the like. The photosensitive webs 22a and 22b are respectively set in predetermined width dimensions. For example, the photosensitive web 22a is formed wider than the photosensitive web 22b.

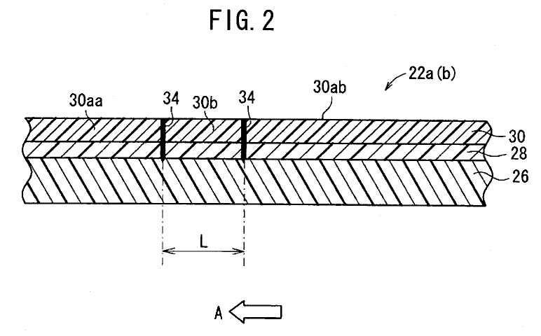

FIG. 2 is a cross sectional view of the photosensitive web 22a or 22b used for the manufacturing apparatus 20. This photosensitive web 22a or 22b comprises a lamination of a flexible base film (support) 26, a photosensitive resin layer (photosensitive material layer) 28, and a protective film 30.

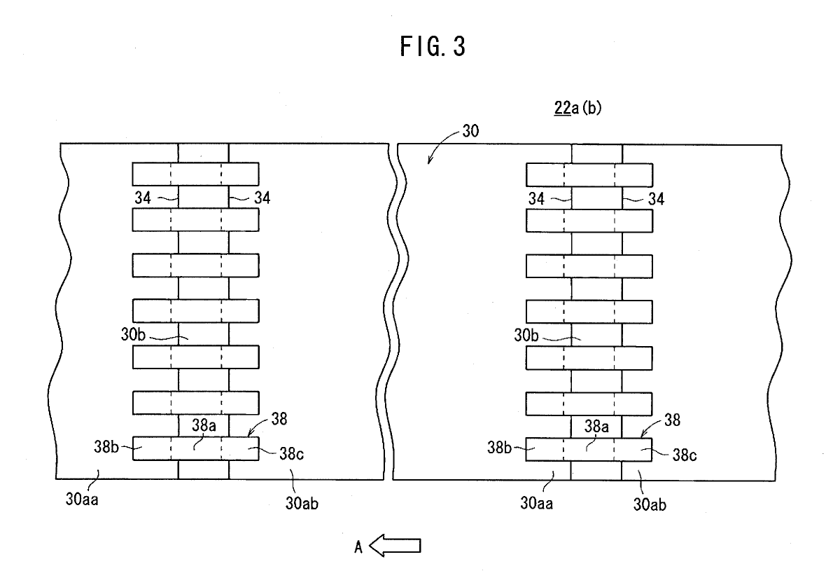

As shown in FIG. 1, the manufacturing apparatus 20 comprises: first and second web delivery mechanisms 32a and 32b which contain two (may be two or more) photosensitive web rolls 23a and 23b around which photosensitive webs 22a and 22b are wound in a roller shape, and are capable of synchronously delivering the photosensitive webs 22a and 22b from the respective photosensitive web rolls 23a and 23b; first and second processing mechanisms 36a and 36b which form a half cut site (processing site) 34 serving as a boundary position capable of being cut in the width direction, in the protective film 30 of the delivered respective photosensitive webs 22a and 22b; and first and second label adhering mechanisms 40a and 40b which adhere adhesive labels 38 (refer to FIG. 3) having partial non adhesive portions 38a, onto the respective protective films 30.

Downstream of the first and second label adhering mechanisms 40a and 40b are arranged: first and second reservoir mechanisms 42a and 42b for changing the delivery of the respective photosensitive webs 22a and 22b from tact feeding into continuous feeding; first and second peeling mechanisms 44a and 44b which peel the protective film 30 from the respective photosensitive webs 22a and 22b at predetermined length intervals; a substrate conveyance mechanism 45 which conveys the glass substrate 24 while being heated to a predetermined temperature, to the paste position; and a pasting mechanism 46 which pastes the photosensitive resin layer 28 exposed by peeling of the protective film 30, integrally in parallel onto the glass substrate 24.

On the upstream side in the vicinity of the paste position in the pasting mechanism 46 are arranged first and second detecting mechanisms 47a and 47b which detect respective half cut sites 34 serving as the boundary positions of the respective photosensitive webs 22a and 22b.

On the downstream side in the vicinity of the first and second web delivery mechanisms 32a and 32b are arranged respective pasting stages 49 for pasting the rear ends of photosensitive webs 22a and 22b that have been almost used and the front ends of photosensitive webs 22a and 22b that are to be newly used. Downstream of the pasting stage 49 is arranged a film terminal position detector 51 for controlling the widthwise dislocation of the photosensitive web roll 23a or 23b due to winding. Here, the film terminal position is adjusted by moving the first and second web delivery mechanisms 32a and 32b in the width direction, however a position adjusting mechanism combined with a roller may be provided to perform the adjustment. The first and second web delivery mechanisms 32a and 32b may have a construction where the shafts on which the photosensitive web rolls 23a and 23b are installed, and which feed out the photosensitive webs 22a and 22b, have multiple shafts, such as double and triple shafts.

The first and second processing mechanisms 36a and 36b are arranged downstream of roller pairs 50 for calculating the diameter of the respective photosensitive web rolls 23a and 23b wound around and contained in the first and second web delivery mechanisms 32a and 32b. The first and second processing mechanisms 36a and 36b respectively comprise a single round blade 52. This round blade 52 runs in the width direction of the photosensitive web 22a or 22b, and forms half cut sites 34 in predetermined two positions on either side of the remaining portion 30b (FIG. 2) of the protective film 30.

As shown in FIG. 2, the half cut site 34 has to cut at least the protective film 30. Practically, in order to reliably cut this protective film 30, the cut depth of the round blade 52 is set so as to cut into an area from the photosensitive resin layer 28 to the base film 26. The round blade 52 employs a system in which the half cut site 34 is formed by moving in the width direction of the photosensitive web 22a or 22b in a fixed state without rotation, or a system in which the half cut site 34 is formed by moving in the width direction while rotating without sliding on the photosensitive web 22a or 22b. Other systems may also be employed in which this half cut site 34 is formed by cutting using laser beams or ultrasonic waves, a knife blade, a press and cut blade (Thomson blade), or the like, instead of the round blade 52.

Two of each of the first and second processing mechanisms 36a and 36b may be respectively arranged apart by just a distance L corresponding to the width of the remaining portion 30b in the conveyance direction (arrow A direction) of the photosensitive webs 22a and 22b, so as to concurrently form two half cut sites 34 on either side of the remaining portion 30b (FIG. 2) of the protective film 30.

The half cut sites 34 are set in the position, for example, are inserted into respective opposite sides of the glass substrate 24 for 10 mm. The portion interposed between the half cut sites 34 between the glass substrates 24 functions as a mask for pasting the photosensitive resin layer 28 onto the glass substrates 24 in a frame form in the pasting mechanism 46 described later.

In order to leave the remaining portion 30b of the protective film 30 corresponding to a portion between the glass substrates 24, the first and second label adhering mechanisms 40a and 40b supply adhesive labels 38 connecting the peeled portion 30aa in front of the peeled side and the peeled portion 30ab in rear of the peeled side. As shown in FIG. 2, in the protective film 30, on either side of the remaining portion 30b, a portion which is previously peeled off is referred to as a front peeled portion 30aa, while a portion which is peeled off later is referred to as a rear peeled portion 30ab.

As shown in FIG. 3, the adhesive label 38 is formed in a strip shape, and is formed from, for example, a resin material which is the same material for the protective film 30. The adhesive label 38 has a non adhesive (including weak-adhesive) portion 38a in the center where an adhesive is not applied, and a first adhesive portion 38b to be adhered to the front peeled portion 30aa and a second adhesive portion 38c to be adhered to the rear peeled portion 30ab on the opposite sides of this non adhesive portion 38a, that is, the lengthwise opposite ends of the adhesive label 38.

As shown in FIG. 1, the first and second label adhering mechanisms 40a and 40b comprise adsorption pads 54a to 54g capable of pasting respectively at most seven strips of adhesive labels 38 separated at predetermined intervals, and are arranged with cradles 56 for holding the photosensitive webs 22a and 22b from the bottom in a freely lifting/lowering manner, in the paste positions of the adhesive labels 38 by the adsorption pads 54a to 54g.

The first and second reservoir mechanisms 42a and 42b comprise a dancer roller 60 which can swing in the arrow direction for absorbing the difference in speed between the tact conveyance of the photosensitive webs 22a and 22b on the upstream side and the continuous conveyance of the photosensitive webs 22a and 22b on the downstream side. The second reservoir mechanism 42b is arranged with a dancer roller 61 for adjusting to synchronize the respective conveyance path lengths of the photosensitive webs 22a and 22b delivered from the first and second web delivery mechanisms 32a and 32b to the pasting mechanism 46.

The first and second peeling mechanisms 44a and 44b arranged downstream of the first and second reservoir mechanisms 42a and 42b respectively comprise suction drums 62 for blocking tension fluctuation on the delivery side of the photosensitive webs 22a and 22b, and stabilizing the tension at the time of lamination. In the vicinity of respective the suction drum 62 is arranged a peeling roller 63, and the protective film 30 peeled from the photosensitive webs 22a and 22b at an acute peeling angle through this peeling roller 63 is respectively wound around the protective film winding section 64, except for the remaining portions 30b.

Downstream of the first and second peeling mechanisms 44a and 44b are respectively arranged first and second tension controlling mechanisms 66a and 66b capable of applying a tension to the photosensitive webs 22a and 22b. The first and second tension controlling mechanisms 66a and 66b respectively comprise a cylinder 68. Under the driving action of the cylinders 68, tension dancers 70 respectively swing to be displaced, and thereby the tension of the photosensitive webs 22a and 22b in slidable contact with the respective tension dancers 70 can be adjusted. The first and second tension controlling mechanisms 66a and 66b may be used as required, or may be omitted.

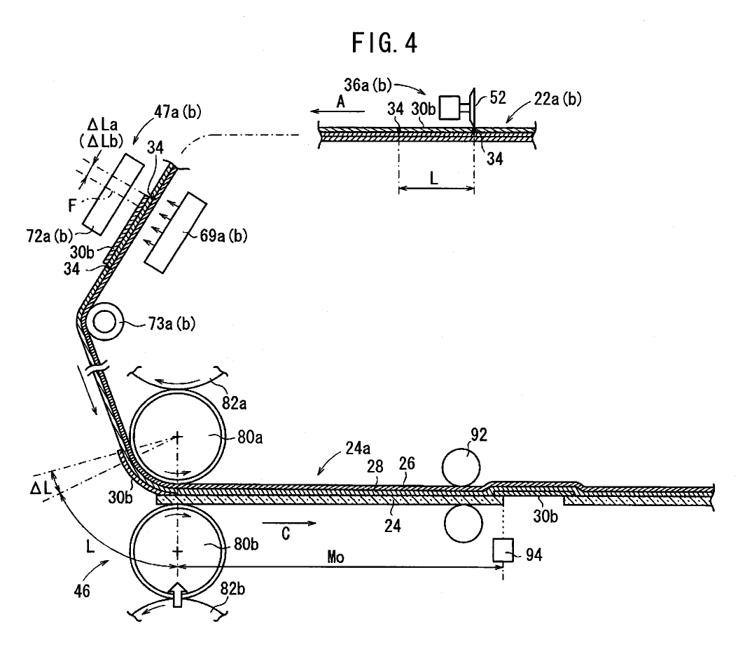

As shown in FIG. 4, the first and second detecting mechanisms 47a and 47b comprise CCD cameras 72a and 72b (processing site detector) serving as area sensors; and illuminating sections 69a and 69b arranged opposingly to the CCD cameras 72a and 72b via the photosensitive webs 22a and 22b; in which illumination light from the illuminating sections 69a and 69b is irradiated onto the CCD cameras 72a and 72b through the photosensitive webs 22a and 22b, and the image of the half cut site 34 is obtained, so as to detect the position of the half cut site 34 with respect to the reference position F set in the CCD cameras 72a and 72b. Regarding the reference position F, the position of the image of a dog set in a predetermined positional relation with respect to the rubber roller 80a, obtained by reading out by the CCD cameras 72a and 72b together with the half cut site 34, can be set as the reference position F.

The substrate conveyance mechanism 45 comprises a plurality of sets of substrate heating sections (such as heaters) 74 arranged on either side of the glass substrate 24, and conveyance sections 76 which convey this glass substrate 24 in the arrow C direction. The substrate heating section 74 can monitor the temperature of the glass substrate 24 at all times, so that, when an abnormality occurs, the conveyance section 76 can be stopped, or a warning can be alerted, and information of the abnormality is sent so as to discard the abnormal glass substrate 24 as a NG product in the following step. This can be utilized for quality control, production control, and the like. In the conveyance section 76 is arranged an air floating plate (not shown), so that the glass substrate 24 floats and is conveyed in the arrow C direction. The glass substrate 24 can be also conveyed by a roller conveyer.

The temperature of the glass substrate 24 is preferably set in the substrate heating section 74 or just before the paste position. The measuring method may involve either a contact type (such as a thermocouple) or a non-contact type.

On the upstream of the substrate heating section 74 is provided a substrate stocker 71 which stores a plurality of glass substrates 24. The respective glass substrates 24 stored in this substrate stocker 71 are taken out by means of attachment to an adsorption pad 79 provided on a hand section 75a of a robot 75, and are inserted into the substrate heating section 74.

The pasting mechanism 46 comprises rubber rollers (pressure rollers) 80a and 80b arranged on the upper side and the lower side, and heated to a predetermined temperature. The surface temperature of the rubber roller 80a is set lower than the surface temperature of the rubber roller 80b. Specifically, the surface temperature of the rubber roller 80a is set within a range of 95° C.±10° C., and more preferably within a range of 95° C.±5° C., while the surface temperature of the rubber roller 80b is set within a range of 120° C.±10° C., and more preferably within a range of 120° C.±5° C. The rubber rollers 80a and 80b are in slidable contact with the backup rollers 82a and 82b. The backup roller 82b on one side is pressed to the rubber roller 80b side by pressurizing cylinders 84a and 84b constituting a roller clamp section 83.

In the vicinity of the rubber roller 80a is movably arranged a contact prevention roller 86 for preventing the photosensitive webs 22a and 22b from being in contact with the rubber roller 80a. In the vicinity of the upstream of the pasting mechanism 46 is arranged a preheating section 87 for preheating the photosensitive webs 22a and 22b to a predetermined temperature. This preheating section 87 comprises a heating device such as an infrared bar heater.

The glass substrate 24 is conveyed through a conveyance path 88 extending from the pasting mechanism 46 in the arrow C direction. This conveyance path 88 is arranged with film conveyance rollers 90a and 90b and substrate conveyance rollers 92. The space between the rubber rollers 80a and 80b and the substrate conveyance rollers 92 is preferably set shorter than the length of one sheet of the glass substrate 24. In the vicinity of the downstream of the substrate conveyance rollers 92 is arranged a substrate front end detection sensor 94 which detects the front end of the conveyed glass substrate 24.

Moreover, downstream of the substrate conveyance rollers 92 are provided a cooling mechanism 122 and a base automatic peeling mechanism 142. The base automatic peeling mechanism 142 is to continuously peel off a lengthy base film 26 pasted on the respective glass substrates 24 which are separated with predetermined intervals, and comprises a prepeeler 144, a peeling roller 146 having a relatively small diameter, a winding shaft 148, and an automatic pasting device 150. Preferably, the winding shaft 148 applies a tensile force to the base film 26 by means of torque control at the time of driving, while feedback control of the tensile force is performed by providing, for example, a tensile force detector (not shown). The prepeeler 144 comprises a peeling bar 156 which can be freely lifted/lowered between the glass substrates 24.

Reheating of the film face to about 30° C. to 120° C. just before the peeling roller 146 prevents the colorant layer from flaking off at the time of peeling, and a high quality laminate surface can be obtained.

Downstream of the base automatic peeling mechanism 142 is arranged a measurement mechanism 158 which measures the area position of the photosensitive resin layer 28 which has been actually pasted on the glass substrate 24. This measurement mechanism 158 comprises, for example, a camera 160 such as a CCD, which captures the glass substrate 24 pasted with the photosensitive resin layer 28.

Moreover, downstream of the base automatic peeling mechanism 142 is provided a photosensitive laminate stocker 132 which stores a plurality of photosensitive laminates 106 in which the area position of the photosensitive resin layer 28 has been measured by the measurement mechanism 158. The photosensitive laminate 106 from which the base film 26 and the remaining portion 30b have been peeled off by the base automatic peeling mechanism 142 is taken out by means of attachment to an adsorption pad 136 provided on a hand section 134a of a robot 134, and is stored in the photosensitive laminate stocker 132.

In the manufacturing apparatus 20 having the above structure, the first and second web delivery mechanisms 32a and 32b, the first and second processing mechanisms 36a and 36b, the first and second label adhering mechanisms 40a and 40b, the first and second reservoir mechanisms 42a and 42b, the first and second peeling mechanisms 44a and 44b, the first and second tension controlling mechanisms 66a and 66b, and the first and second detecting mechanisms 47a and 47b are arranged above the pasting mechanism 46. However, conversely, the structure may be such that mechanisms from the first and second web delivery mechanisms 32a and 32b to the first and second detecting mechanisms 47a and 47b may be arranged below the pasting mechanism 46, the photosensitive webs 22a and 22b may be vertically inverted, and the photosensitive resin layer 28 may be pasted on the lower side of the glass substrate 24. Moreover, the overall manufacturing apparatus 20 may be constructed in a straight line.

As shown in FIG. 1, the overall manufacturing apparatus 20 is controlled by a lamination process controller 100. In respective function sections of this manufacturing apparatus 20, are provided, for example, a lamination controller 102, a substrate heating controller 104, a half cut controller 108, a base peeling controller 109, and the like, which are mutually connected via a process internal network. Furthermore, the lamination process controller 100 is connected to a factory network, and performs information processing for production, such as production control, execution management, and the like, of the manufacturing apparatus 20, based on instruction information (condition setting and production information) from a production management computer (not shown).

The substrate heating controller 104 performs operation control to receive the glass substrate 24 from the upstream step, heat this glass substrate 24 to a predetermined temperature, and supply it to the pasting mechanism 46, and performs information control of the glass substrate 24.

The lamination controller 102 controls the respective function sections as a master of the whole steps, and controls the relative positions between the glass substrate 24 and the respective boundary positions, and the relative positions between the respective boundary positions in the paste positions, based on the positional information of the half cut sites 34 in the photosensitive webs 22a and 22b detected by the first and second detecting mechanisms 47a and 47b.

The half cut controller 108 controls the first and second processing mechanisms 36a and 36b, and forms the half cut site 34 in a predetermined position of the photosensitive webs 22a and 22b.

The base peeling controller 109 peels off the base film 26 from the photosensitive webs 22a and 22b that has been pasted on the glass substrate 24, performs operation control to convey it as the photosensitive laminate 106 to downstream, and performs information control of the photosensitive laminate 106.

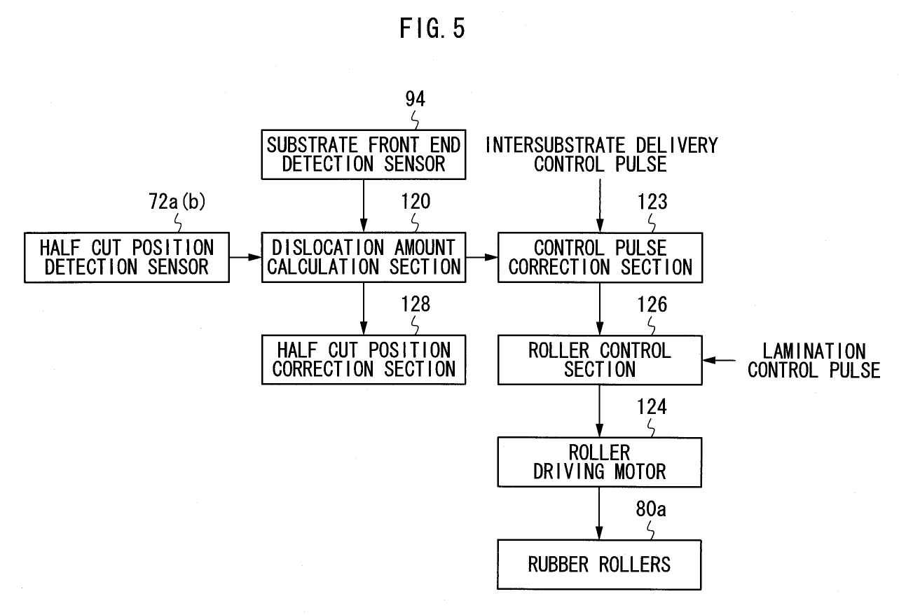

FIG. 5 is a configuration block diagram of a function for correcting the dislocation of the half cut site 34.

In this case, the lamination process controller 100 has a dislocation amount calculation section 120 which, when the front end of the glass substrate 24 is detected by the substrate front end detection sensor 94, compares the position of the half cut site 34 detected by the CCD cameras 72a and 72b with the reference position F, and calculates the dislocation amounts ΔLa and ΔLb of the half cut sites 34 in the respective photosensitive webs 22a and 22b with respect to the reference position F.

The lamination controller 102 comprises: a control pulse correction section 123 (processing site position adjusting section) which corrects the intersubstrate delivery control pulse for delivering the remaining portions 30b in the protective film 30 between the glass substrates 24, based on the dislocation amounts ΔLa and ΔLb of the half cut sites 34 calculated by the dislocation amount calculation section 120, to adjust the position of the half cut sites 34 with respect to the glass substrates 24; and a roller control section 126 which controls a roller driving motor 124 which rotates the rubber rollers 80a in accordance with the corrected intersubstrate delivery control pulse. To the roller control section 126 are supplied the corrected intersubstrate delivery control pulse, and the lamination control pulse for pasting the photosensitive resin layer 28 of the photosensitive webs 22a and 22b onto the glass substrate 24.

The half cut controller 108 has a half cut position correction section 128 which, when at least one of the dislocation amounts ΔLa and ΔLb of the half cut sites 34 calculated by the dislocation amount calculation section 120 exceeds a predetermined acceptable amount, or when the difference between the dislocation amounts ΔLa and ΔLb exceeds a predetermined acceptable amount, corrects the position of the half cut sites 34 by means of the first and second processing mechanisms 36a and 36b, based on the dislocation amounts ΔLa and ΔLb mentioned above.

The inside of the manufacturing apparatus 20 is partitioned into a first clean room 112a and a second clean room 112b by a partition wall 110. The first clean room 112a stores mechanisms from the first and second web delivery mechanisms 32a and 32b to the first and second tension controlling mechanisms 66a and 66b, and the second clean room 112b stores mechanisms of the first and second detecting mechanisms 47a and 47b and thereafter. The first clean room 112a and the second clean room 112b are communicated through a through section 114.

Next is a description of the operation of the manufacturing apparatus 20 having the above structure, in association with the manufacturing method, as follows.

Firstly, the photosensitive webs 22a and 22b are delivered from the respective photosensitive web rolls 23a and 23b attached to the first and second web delivery mechanisms 32a and 32b. The photosensitive webs 22a and 22b are conveyed to the first and second processing mechanisms 36a and 36b.

In the first and second processing mechanisms 36a and 36b, the round blade 52 is moved in the width direction of the photosensitive webs 22a and 22b, to cut the photosensitive webs 22a and 22b from the protective film 30 into an area from the photosensitive resin layer 28 to the base film 26, forming the half cut site 34 (refer to FIG. 2). Furthermore, as shown in FIG. 1 though FIG. 4, the photosensitive webs 22a and 22b are stopped after being conveyed in the arrow A direction, corresponding to the width L of the remaining portion 30b in the protective film 30, and the half cut site 34 is formed under the travelling action of the round blade 52. As a result, the photosensitive webs 22a and 22b are provided with the front peeled portion 30aa and the rear peeled portion 30ab on either side of the remaining portion 30b (refer to FIG. 2).

The width of the remaining portion 30b is set with reference to the distance between the glass substrates 24 supplied to a space between the rubber rollers 80a and 80b of the pasting mechanism 46, with a proviso that the photosensitive webs 22a and 22b are not extended.

Next, the respective photosensitive webs 22a and 22b are conveyed to the first and second label adhering mechanisms 40a and 40b, and a predetermined paste site of the protective film 30 is arranged on the cradle 56. In the first and second label adhering mechanisms 40a and 40b, a predetermined number of the adhesive labels 38 are attached and held by the adsorption pads 54b to 54g, and the respective adhesive labels 38 are integrally adhered to the front peeled portion 30aa and the rear peeled portion 30ab, bridging over the remaining portion 30b of the protective film 30 (refer to FIG. 3).

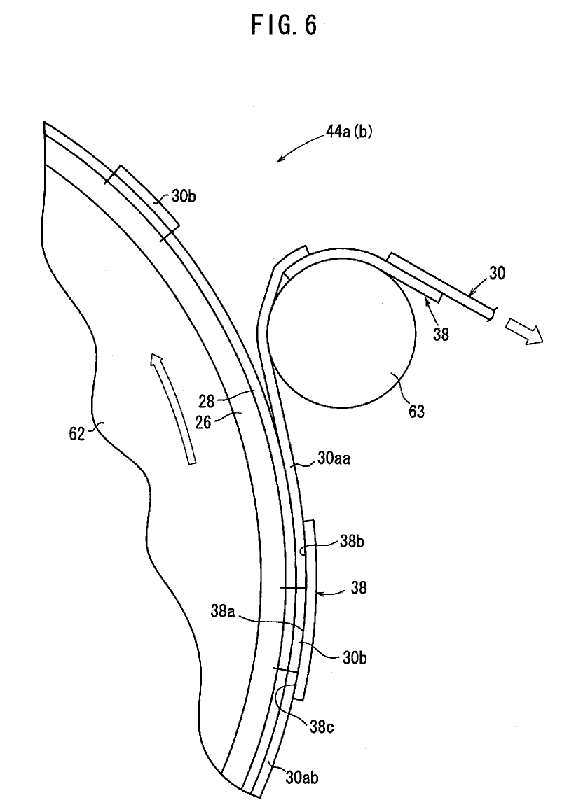

For example, as shown in FIG. 1, the photosensitive webs 22a and 22b adhered with the seven adhesive labels 38 are continuously conveyed to the first and second peeling mechanisms 44a and 44b, after the tension fluctuation on the delivery side is prevented through the first and second reservoir mechanisms 42a and 42b. In the first and second peeling mechanisms 44a and 44b, as shown in FIG. 6, the base film 26 of the photosensitive webs 22a and 22b is attached and held on the suction drum 62, and the protective film 30 is peeled off from the photosensitive webs 22a and 22b leaving the remaining portions 30b. This protective film 30 is peeled off through the peeling roller 63, and wound around the protective film winding section 64.

After the protective film 30 is peeled off from the base film 26 leaving the remaining portion 30b under the action of the first and second peeling mechanisms 44a and 44b, the photosensitive webs 22a and 22b are subjected to the tension adjustment by the first and second tension controlling mechanisms 66a and 66b, and further the half cut sites 34 are detected by the CCD cameras 72a and 72b of the first and second detecting mechanisms 47a and 47b.

In this case, with a proviso that the photosensitive webs 22a and 22b are not extended, the length of the conveyance path between the pasting mechanism 46 and the first and second detecting mechanisms 47a and 47b is set, so that the preceding half cut site 34 on the front peeled portion 30aa side is arranged in a predetermined position between the rubber rollers 80a and 80b, when the CCD cameras 72a and 72b detect the half cut site 34 on the rear peeled portion 30ab side in the reference position F (FIG. 4).

Here, after the CCD cameras 72a and 72b detect the half cut site 34 on the rear peeled portion 30ab side, the photosensitive webs 22a and 22b are conveyed by just the distance L corresponding to the width of the remaining portion 30b of the protective film 30 and stopped, while the preheated glass substrate 24 is conveyed to the paste position under the action of the substrate conveyance mechanism 45. The glass substrate 24 is temporally arranged between the rubber rollers 80a and 80b corresponding to the paste position of the photosensitive resin layer 28 of the parallel photosensitive webs 22a and 22b.

Next, by lifting the backup roller 82b and the rubber roller 80b, the glass substrate 24 is inserted between the rubber rollers 80a and 80b with a predetermined pressing load. The roller control section 126 (FIG. 5) drives the roller driving motor 124 based on the lamination control pulse, to convey the photosensitive webs 22a and 22b and the glass substrate 24 under the action of the rotating rubber roller 80a. As a result, the respective photosensitive resin layers 28 in parallel in the orthogonal direction to the arrow C direction are heated and melt to be transferred (laminated) onto the glass substrate 24. In this case, assuming that the photosensitive webs 22a and 22b are not extended, the photosensitive resin layer 28 of the photosensitive webs 22a and 22b is accurately transferred from the half cut site 34 on the rear peeled portion 30ab side onto a predetermined site in the glass substrate 24.

The lamination condition is such that the speed is 1.0 m/min to 10.0 m/min, the temperature of the rubber rollers 80a and 80b is 80° C. to 140° C., the rubber hardness of the rubber rollers 80a and 80b is 40 degree to 90 degree, and the pressing load (linear load) of the rubber rollers 80a and 80b is 50 N/cm to 400 N/cm.

Moreover, the lamination condition is set such that the static frictional coefficient μ of the upper rubber roller 80a in contact with the flexible base film 26 of the photosensitive webs 22a and 22b with respect to the flexible base film 26 is within a range of 0.15≦μ≦1.8, and more preferably within a range of 0.15≦μ≦0.7 or 1.1≦μ≦1.8. Setting of the static frictional coefficient μ within this range enables avoidance of situations in which bubbles are mixed between the glass substrate 24 and the photosensitive resin layer 28, and situations in which striped unevenness, concentration unevenness, uneven pasted condition, and the like occur. On the other hand, setting of the static frictional coefficient μ within a range of 0.1≦μ≦1.0 enables reduction of the extension rate of the photosensitive webs 22a and 22b, so that the relative dislocation of the photosensitive webs 22a and 22b with respect to the glass substrate 24 can be set within an acceptable range.

Furthermore, if the lamination condition is set such that the rotational speed of the upper rubber roller 80a is higher than the rotational speed with reference to the overall tact time of the manufacturing apparatus 20 which produces a photosensitive laminate having the photosensitive resin layer 28 pasted on the glass substrate 24, with a ratio g within a range of 1.0≦g≦1.017, then a high quality photosensitive laminate can be produced for a time within the tact time, as described later.

When the substrate front end detection sensor 94 detects the front end of the glass substrate 24, and the lamination of one sheet of the photosensitive webs 22a and 22b onto the glass substrate 24 through the rubber rollers 80a and 80b is completed, the rotation of the rubber roller 80a is stopped while the glass substrate 24 onto which the photosensitive webs 22a and 22b have been laminated (hereunder, also referred to as pasted substrate 24a) is clamped by the substrate conveyance rollers 92.

Then, the rubber roller 80b is moved away in the direction separating from the rubber roller 80a to release the clamp, and the rotation of the substrate conveyance rollers 92 is started to convey the pasted substrate 24a in the arrow C direction by just the distance L corresponding to the width of the remaining portion 30b in the protective film 30, resulting in that the half cut site 34 on the rear peeled portion 30ab side in the protective film 30 is moved to a predetermined position in the vicinity of the lower side of the rubber roller 80a. On the other hand, the next glass substrate 24 is conveyed toward the paste position through the substrate conveyance mechanism 45. By repeating the above operation, the pasted substrates 24a are continuously produced.

At this time, as shown in FIG. 4, pairs of respective ends of the pasted substrate 24a are covered with the remaining portion 30b. Accordingly, when the photosensitive resin layer 28 is transferred onto the glass substrate 24, the rubber rollers 80a and 80b are not blotched by the photosensitive resin layer 28.

The pasted substrate 24a that has been laminated by the pasting mechanism 46 is passed through the cooling mechanism 122 and cooled, and is then transferred to the prepeeler 144. In this prepeeler 144, the peeling bar 156 is inserted and lifted between the glass substrates 24, to thereby lift the protective film 30 between the glass substrates 24, so as to peel it from the rear end and the front end of the adjacent glass substrates 24.

Next, in the base automatic peeling mechanism 142, the base film 26 is continuously wound from the pasted substrate 24a under the rotating action of the winding shaft 148. Furthermore, after the detachment due to a trouble stop, or cutting at the time of separation of a defective product, the front end of the base film 26 of the pasted substrate 24a whose lamination processing has been newly started and the read end of the base film 26 that has been wound around the winding shaft 148, are automatically pasted through the automatic pasting device 150.

The pasted substrate 24a from which the base film 26 has been peeled off, is supplied to an examination station comprising the measurement mechanism 158. In this examination station, while the glass substrate 24 is positioned and fixed, images of the glass substrate 24 and the photosensitive resin layer 28 are taken by four cameras 160. Then, by the application of image processing, the paste position is calculated.

The pasted substrate 24a in which the paste position of the photosensitive resin layer 28 is confirmed, is taken our by the robot 134, and is stored as the photosensitive laminate 106 in the photosensitive laminate stocker 132.

Incidentally, in the above description, the proviso is such that the photosensitive webs 22a and 22b delivered from the first and second web delivery mechanisms 32a and 32b are supplied to the pasting mechanism 46 without being extended. However, in the reality, the flexible photosensitive webs 22a and 22b are extended for a predetermined amount by the effect of tension or heat, causing concern in that the photosensitive resin layer 28 can not be highly accurately transferred to the predetermined position of the glass substrate 24.

Here, when the substrate front end detection sensor 94 detects the front end of the glass substrate 24, and the conveyance of the photosensitive webs 22a and 22b and the glass substrate 24 is stopped, the CCD cameras 72a and 72b constituting the first and second detecting mechanisms 47a and 47b obtain images containing the half cut site 34, and supply these to the dislocation amount calculation section 120. Based on the supplied images, the dislocation amount calculation section 120 calculates the dislocation amounts ΔLa and ΔLb of the position of the half cut site 34 with respect to the reference position F of the CCD cameras 72a and 72b. The reference symbols of the dislocation amounts ΔLa and ΔLb are set to + for the upstream side of the position where the photosensitive webs 22a and 22b are supplied with respect to the reference position F, and − for the downstream side thereof.

If the calculated dislocation amounts ΔLa and ΔLb are within a predetermined acceptable amount, the dislocation amount calculation section 120 supplies the dislocation amounts ΔLa and ΔLb to the control pulse correction section 123, and adjusts the intersubstrate delivery amount of the photosensitive webs 22a and 22b.

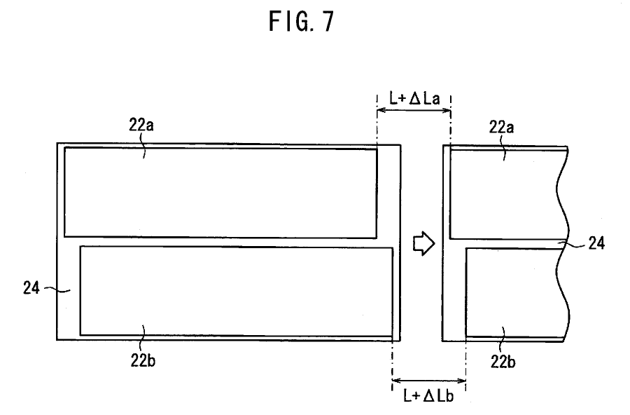

Here, the manufacturing apparatus 20 concurrently pastes two sheets of photosensitive webs 22a and 22b onto one sheet of glass substrate 24, using the common rubber rollers 80a and 80b. In this case, since the positions of the half cut sites 34 of the respective photosensitive webs 22a and 22b differ depending on; the difference in the properties of the photosensitive webs 22a and 22b, errors in adjustment of the respective sections in the manufacturing apparatus 20, and the like, then as shown in FIG. 7, the paste positions of the photosensitive webs 22a and 22b with respect to the glass substrate 24 are displaced.

Therefore, assuming that the dislocation amount ΔL is the arithmetic mean value ΔL(=(ΔLa+ΔLb)/2) of the dislocation amounts ΔLa and ΔLb of the half cut sites 34 of the respective photosensitive webs 22a and 22b with respect to the reference position F, the control pulse correction section 123 corrects the intersubstrate delivery control pulse based on this dislocation amount ΔL, and supplies the corrected value to the roller control section 126. The roller control section 126 drives the roller driving motor 124 according to the corrected intersubstrate delivery control pulse, and delivers the photosensitive webs 22a and 22b by just the corrected amount which is the addition to the distance L (subtraction in cases where the dislocation amount ΔL is −). As a result, the dislocation of the half cut sites 34 of two sheets of the photosensitive webs 22a and 22b is corrected to the average. In cases where three sheets or more of photosensitive webs are concurrently pasted on one sheet of substrate, the correction may be performed by obtaining the arithmetic mean value of the dislocation amounts of the respective photosensitive webs.

In this case, assuming that photosensitive webs 22a and 22b to be transferred on one sheet of glass substrate 24 are between the pasting mechanism 46 and the first and second detecting mechanisms 47a and 47b, the paste starting position of the preceding photosensitive webs 22a and 22b onto the glass substrate 24 is adjusted by the dislocation amount ΔL of the half cut site 34 in the following photosensitive webs 22a and 22b. However, considering that a large extension of the photosensitive webs 22a and 22b will not occur between the pasting mechanism 46 and the first and second detecting mechanisms 47a and 47b, then when many sheets of pasted substrates 24a are to be continuously produced, dislocations of the half cut sites 34 are not accumulated, and the paste starting position of the photosensitive webs 22a and 22b onto the glass substrate 24 can be highly accurately adjusted.

Instead of adjusting the feed amount of the photosensitive webs 22a and 22b based on the dislocation amount ΔL, the delivery timing of the glass substrate 24 for arranging the paste starting site of the glass substrate 24 in a predetermined position between the rubber rollers 80a and 80b, may be adjusted.

On the other hand, when at least one of the dislocation amounts ΔLa and ΔLb calculated by the dislocation amount calculation section 120 exceeds a predetermined acceptable amount, or when the difference between the dislocation amounts ΔLa and ΔLb exceeds a predetermined acceptable amount, there is concern in that adjustment of the intersubstrate delivery control pulse may affect the tact time relating to the production of the photosensitive laminate 106. In this case, the concern is dealt with not by adjusting the intersubstrate delivery control pulse, but by correcting the processing position of the half cut site 34 by means of the first and second processing mechanisms 36a and 36b.

That is, the half cut position correction section 128 calculates a value which is a multiplication of the arithmetic mean value ΔL of the dislocation amounts ΔLa and ΔLb times a predetermined coefficient α that is set within a range of 1.0 to 1.5, as the position adjustment value ±ΔL·α. The first and second processing mechanisms 36a and 36b change the processing position of the half cut site 34 by just the amount of the position adjustment value ±ΔL·α, to form the half cut site 34 in the photosensitive webs 22a and 22b. According to the plus or minus of the dislocation amounts ΔLa and ΔLb, if it is +, the position adjustment value −ΔA·Δ is selected so that the processing position comes to the downstream side of the photosensitive webs 22a and 22b, and if it is −, the position adjustment value +ΔL·α is selected so that the processing position comes to the upstream side of the photosensitive webs 22a and 22b. In this case, setting of the coefficient α within a range of 1.0 to 1.5 to adjust the forming position of the half cut site 34, enables a reduction in the number of corrections with respect to the accumulation of dislocations.

The manufacturing apparatus 20 serving as the first embodiment uses two photosensitive web rolls 23a and 23b, however it is not limited to this, and one photosensitive web roller, or three or more photosensitive web roller may be employed. Moreover, this is the same in the second embodiment described as follows.

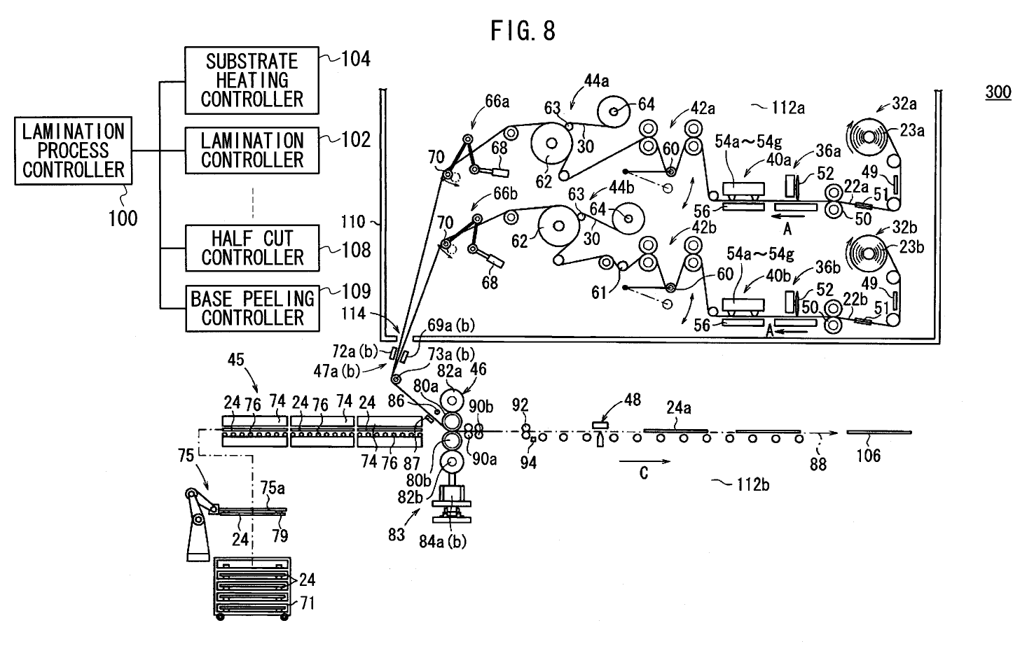

FIG. 8 is a schematic diagram of a manufacturing apparatus 300 for a photosensitive laminate according to the second embodiment of the present invention. The same reference symbols are used for components the same to those in the manufacturing apparatus 20 for a photosensitive laminate according to the first embodiment, and detailed description thereof is omitted.

The manufacturing apparatus 300 is arranged downstream of the pasting mechanism 46, and comprises an intersubstrate web cutting mechanism 48 capable of integrally cutting the photosensitive webs 22a and 22b that are between respective glass substrates 24.

In the manufacturing apparatus 300 having such a structure, similarly to the abovementioned first embodiment, the pasted substrate 24a laminated by the pasting mechanism 46 is conveyed in the arrow C direction. Then, when the space between the pasted substrates 24a comes to the position corresponding to the intersubstrate web cutting mechanism 48, the intersubstrate web cutting mechanism 48 integrally cuts the two photosensitive webs 22a and 22b that are between the pasted substrates 24a while moving in the arrow C direction at a conveyance speed the same as that of the pasted substrates 24a.

After this cutting, the intersubstrate web cutting mechanism 48 is returned to a predetermined standby position, while the base film 26 and the remaining portion 30b are sequentially peeled off (sheet peeling) from the pasted substrate 24a to thereby produce the photosensitive laminate 106.

Next is a description of an embodiment for producing a high quality photosensitive laminate 106 without unevenness, by adjusting the time required for pasting of the photosensitive webs 22a and 22b onto the glass substrate 24 within the tact time, in the manufacturing apparatus 20 shown in FIG. 1 or the manufacturing apparatus 300 shown in FIG. 8.

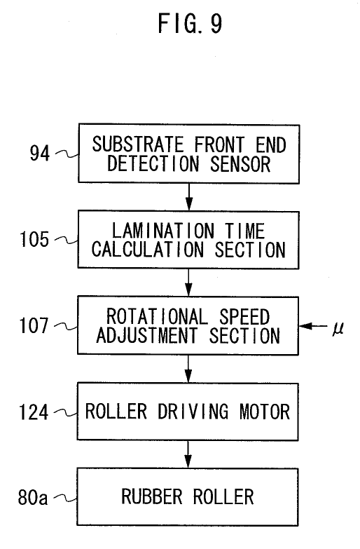

As shown in FIG. 9, the lamination controller 102 comprises: a lamination time calculation section 105 which calculates the lamination time based on the front end detection signal of the glass substrate 24 supplied from the substrate front end detection sensor 94; a rotational speed adjustment section 107 which adjusts the rotational speed of the rubber roller 80a based on the static frictional coefficient μ of the rubber roller 80a and the calculated lamination time; and a roller driving motor 124 which drives the rubber roller 80a based on the adjusted rotational speed.

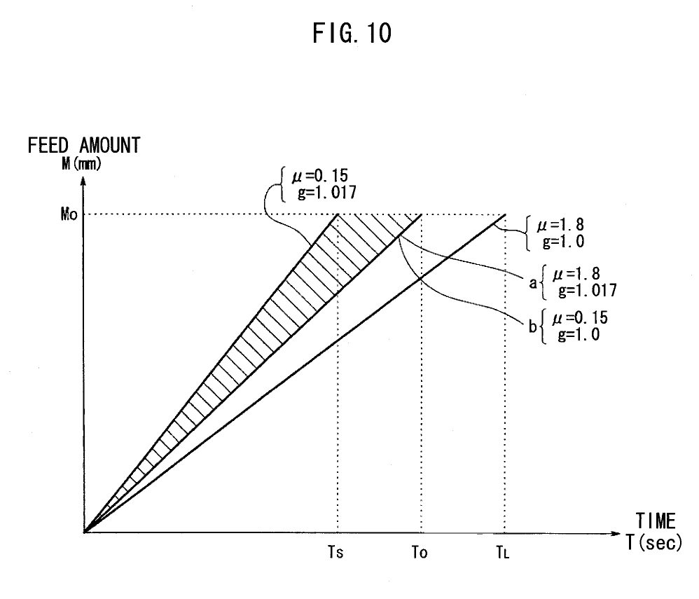

FIG. 10 shows measured results of relationship between the time T elapsed from the start of pasting the photosensitive resin layer 28 onto the glass substrate 24, and the feed amount M of the glass substrate 24, with variation of the static frictional coefficient μ of the rubber roller 80a with respect to the flexible base film 26, and the ratio of the set rotational speed with respect to the computational rotational speed of the rubber roller 80a capable of feeding the glass substrate 24 by just a predetermined amount M₀, serving as the pasting range, in the tact time T₀.

In this case, even if the setting is such that the static frictional coefficient μ=1.8 and the ratio g=1.0, in other words, the rotational speed of the rubber roller 80a is ideal for completing the pasting in the tact time T₀, the obtained result shows that the time T_{L} required for pasting is longer than the tact time T₀. The reason is considered to be that, since the static frictional coefficient μ of the rubber roller 80a is large, the photosensitive webs 22a and 22b are extended by the rubber roller 80a, resulting in the elongation of time T for completing the pasting.

If the setting is such that the static frictional coefficient μ=1.8 and the ratio g=1.017, in other words, the rotational speed of the rubber roller 80a is higher than the ideal rotational speed for completing the pasting in the tact time T₀, the obtained result shows that the time T required for pasting matches the tact time T₀. Moreover, similarly, if the setting is such that the static frictional coefficient μ=0.15 and the ratio g=1.0, the obtained result shows that the time T for completing the pasting matches the tact time T₀. Furthermore, if the setting is such that the static frictional coefficient μ=0.15 and the ratio g=1.017, the obtained result shows that the time T for completing pasting becomes a time Tₛ which is shorter than the tact time T₀.

In summary of the above results, it is understood that the time required for pasting T can be shortened by setting the rotational speed higher than the ideal rotational speed of the rubber roller 80a for completing the pasting in the tact time T₀, and by decreasing the static frictional coefficient μ of the rubber roller 80a with respect to the flexible base film 26. Moreover, pasting can be completed in a stable processing time within the tact time T₀ by setting the ratio g of the rotational speed of the rubber roller 80a and the static frictional coefficient μ thereof in a range shown by the hatching in FIG. 10. In this case, since the processing time is stabilized, a high quality photosensitive laminate without unevenness can be stably produced.

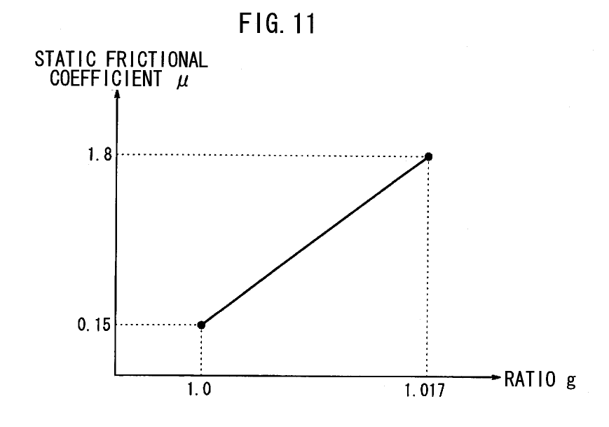

FIG. 11 shows the relationship between the static frictional coefficient μ and the appropriate ratio g capable of pasting within the tact time T₀ based on the above results. In this case, the rubber roller 80a can be adjusted to an appropriate rotational speed by the lamination controller 102 comprising the structure shown in FIG. 9.

That is, the time from the start of lamination by means of the rubber roller 80a until the completion of the lamination and detection of the front end of the glass substrate 24 by the substrate front end detection sensor 94, is calculated by the lamination time calculation section 105, and the calculated lamination time is supplied to the rotational speed adjustment section 107. When the lamination time is judged to have a possibility of exceeding the tact time T₀, the rotational speed adjustment section 107 obtains the ratio g capable of obtaining the appropriate lamination time, using the relationship of FIG. 11, based on the static frictional coefficient μ of the rubber roller 80a, and adjusts the rotational speed of the rubber roller 80a according to the ratio g. As a result, the lamination processing of the photosensitive laminate can be performed within a stable processing time which does not exceed the tact time T₀.

Since the static frictional coefficient μ to be supplied to the rotational speed adjustment section 107 fluctuates due to continuation of the lamination processing, it is desirably measured for example, at the time of periodic maintenance, and is supplied to the rotational speed adjustment section 107.

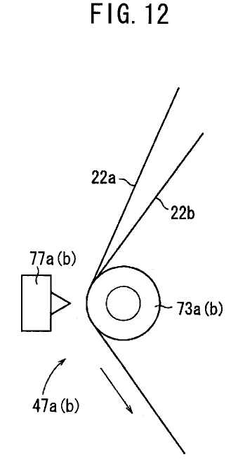

In this embodiment, the first and second detecting mechanisms 47a and 47b may have a structure as shown in FIG. 12.

That is, the first and second detecting mechanisms 47a and 47b comprise photoelectronic sensors 77a and 77b such as a laser sensor and a photosensor, and these photoelectronic sensors 77a and 77b are arranged opposed to the backup rollers 73a and 73b. The photoelectronic sensors 77a and 77b directly detect a change caused by the difference in level due to a wedge-shaped tongue-and-groove portion of the half cut site 34 and the thickness of the protective film 30, or a combination thereof, and set this detection signal as the boundary position signal. An image detection device such as a noncontact displacement gauge or a CCD camera may be used instead of the photoelectronic sensors 77a and 77b.

The positional data of the half cut site 34 detected by the first and second detecting mechanisms 47a and 47b is statistically processed and graphed in real time, and a warning can be alerted when an unevenness abnormality, or deviation occurs.

Moreover, the half cut site 34 does not have to be directly detected, and a mark position may be formed by; making a hole or a notch in the vicinity of the first and second processing mechanisms 36a and 36b corresponding to this half cut site 34, providing a hole or a notch by means of laser processing or aquajet processing, or providing a marking by means of an inkjet or a printer, and this mark position can be detected as a boundary position signal.

Next is a description of an embodiment for producing a high quality photosensitive laminate 106 without mixed bubbles and striped unevenness, in the manufacturing apparatus 20 shown in FIG. 1 or the manufacturing apparatus 300 shown in FIG. 8. In this embodiment, the first and second detecting mechanisms 47a and 47b may have a structure as shown in FIG. 12.

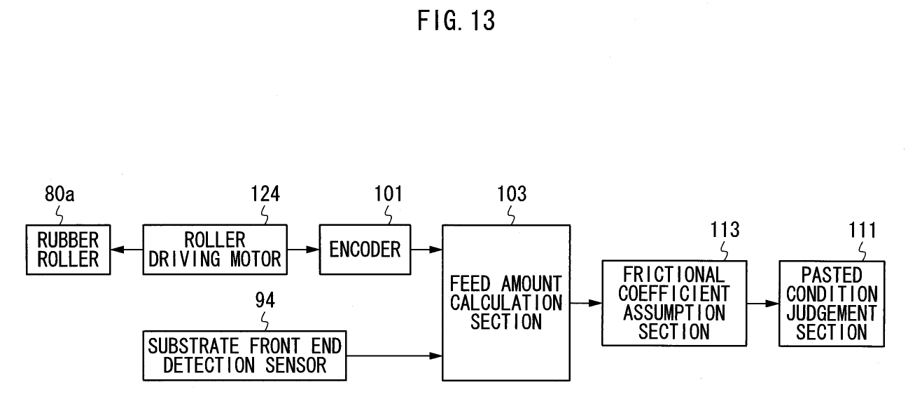

As shown in FIG. 13, the lamination controller 102 comprises a structure which controls to drive the upper rubber roller 80a constituting the pasting mechanism 46, and judges the pasted condition of the photosensitive webs 22a and 22b onto the glass substrate 24 based on the feed amount (pulse amount) of the rubber roller 80a which conveys the photosensitive webs 22a and 22b.

The rotation amount of the roller driving motor 124 which drives the upper rubber roller 80a is detected by an encoder 101 (feed amount detection section), and is supplied to the feed amount calculation section 103. The feed amount calculation section 103 calculates the feed amount of the rubber roller 80a, based on the front end detection signal of the glass substrate 24 supplied from the substrate front end detection sensor 94, and the rotation amount of the roller driving motor 124 from the encoder 101. The frictional coefficient assumption section 113 assumes the static frictional coefficient μ of the rubber roller 80a, based on the feed amount of the rubber roller 80a calculated by the feed amount calculation section 107. The pasted condition judgement section 111 judges the pasted condition of the photosensitive webs 22a and 22b with respect to the glass substrate 24, based on the static frictional coefficient μ of the rubber roller 80a assumed by the frictional coefficient assumption section 113.

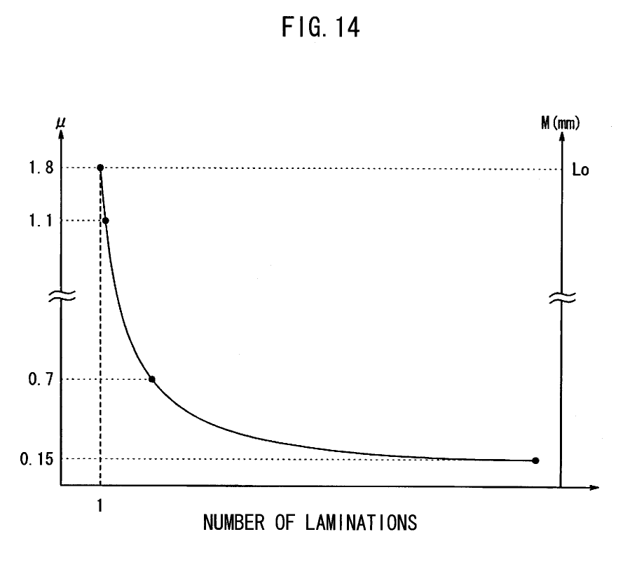

FIG. 14 is obtained by plotting the static frictional coefficient μ of the upper rubber roller 80a with respect to the number of laminations of the pasted substrates 24a when the pasted substrates 24a are continuously produced. In this case, as the number of laminations increases, the static frictional coefficient μ decreases. The reason for this is considered to be; the reduction of the static frictional coefficient μ of the surface of the rubber roller 80a, the adhesion of a part of the material of the base film 26 onto the rubber roller 80a, and the like.

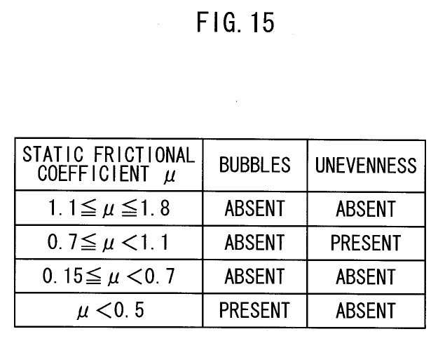

On the other hand, the relationship between the static frictional coefficient μ and the presence/absence of bubbles, striped unevenness, concentration unevenness, and the like in the produced pasted substrate 24a was examined, resulting in a finding that, as shown in FIG. 15, bubbles are not mixed when the static frictional coefficient μ is within a range of 0.15≦μ≦1.8, and striped unevenness, concentration unevenness, and the like do not occur when the static frictional coefficient μ is within a range of μ<0.7 or 1.1≦μ≦1.8. Accordingly, if the static frictional coefficient μ is set within a range of 0.15≦μ≦0.7 or 1.1≦μ≦1.8, the occurrence of bubbles, striped unevenness, concentration unevenness, and the like can be all avoided, and an excellent quality photosensitive laminate 106 can be produced.

Moreover, using the relationship between the static frictional coefficient μ and the feed amount of the rubber roller 80a with respect to the glass substrate 24, the pasted condition of the photosensitive webs 22a and 22b with respect to the glass substrate 24 can be judged. That is, as shown in FIG. 14, as the static frictional coefficient μ of the rubber roller 80a decreases, the feed amount M of the rubber roller 80a decreases. The reason is considered to be that, since the contact part between the rubber roller 80a and the photosensitive webs 22a and 22b becomes more slippery as the static frictional coefficient μ decreases, the photosensitive webs 22a and 22b are conveyed according to the movement of the glass substrate 24, more quickly than the rubber roller 80a.

Here, as shown in FIG. 13, the rotation amount from the start of lamination of the roller driving motor 124 which drives to rotate the rubber roller 80a is detected by the encoder 101, and is supplied to the feed amount calculation section 103. The feed amount calculation section 103 calculates the feed amount M of the rubber roller 80a from the rotation amount at the time point when the lamination is completed and the front end of the glass substrate 24 is detected by the substrate front end detection sensor 94. In this case, assuming that the contact part between the rubber roller 80a and the photosensitive webs 22a and 22b is not slippery, then as shown in FIG. 4, the feed amount M becomes equal to the feed amount M₀ of the glass substrate 24 between the rubber roller 80a and the substrate front end detection sensor 94, however as the static frictional coefficient μ decreases, the feed amount M also decreases according to this.

The frictional coefficient assumption section 113 assumes the static frictional coefficient μ of the rubber roller 80a, based on the feed amount M calculated by the feed amount calculation section 103. The static frictional coefficient μ assumed by the frictional coefficient assumption section 113 is supplied to the pasted condition judgement section 111, and whether or not there is a possibility of an occurrence of bubbles, striped unevenness, concentration unevenness, and the like, is judged based on the static frictional coefficient μ. In this case, for example, if the static frictional coefficient μ is within a range of 0.15≦μ≦0.7 or 1.1≦μ≦1.8, it can be judged that the photosensitive laminate 106 is produced in conditions where bubbles, striped unevenness, concentration unevenness, and the like, do not occur. Moreover, if the static frictional coefficient μ is out of the above range, the production of a defective photosensitive laminate 106 can be avoided beforehand by performing processing such as cleaning or replacing of the rubber roller 80a so that the static frictional coefficient μ comes within a desired range.

Next is a description of an embodiment for producing a photosensitive laminate 106 in an excellent condition by suppressing the relative displacement of the paste positions of a plurality of photosensitive webs 22a and 22b, in the manufacturing apparatus 20 shown in FIG. 1 or the manufacturing apparatus 300 shown in FIG. 8. In this embodiment, the first and second detecting mechanisms 47a and 47b may have a structure as shown in FIG. 12.

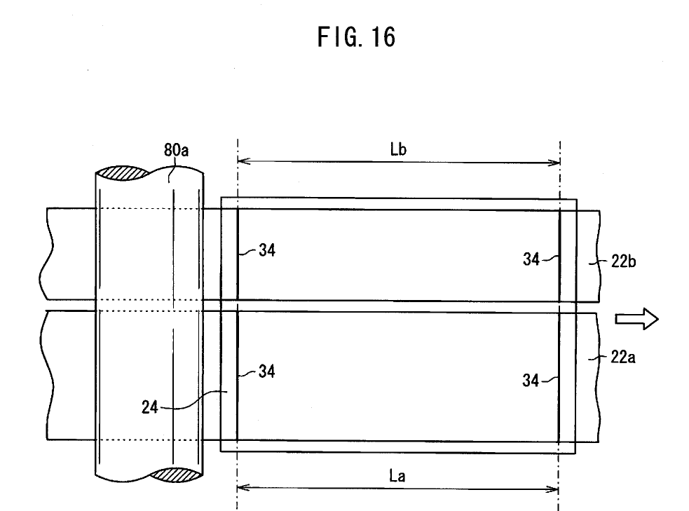

FIG. 16 shows the glass substrate 24 pasted with two photosensitive webs 22a and 22b by the rubber rollers 80a and 80b constituting the pasting mechanism 46. In this case, the length between two half cut sites 34 of the photosensitive web 22a pasted on the glass substrate 24 is referred to as La, and the length between two half cut sites 34 of the photosensitive web 22b pasted on the glass substrate 24 is referred to as Lb.

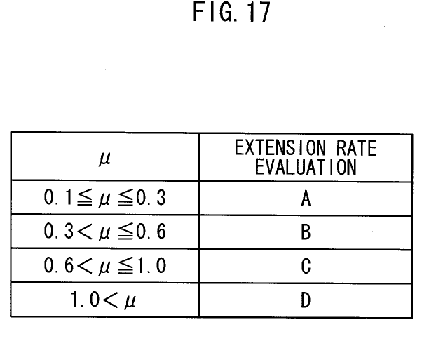

The length of the respective pasted photosensitive webs 22a and 22b is referred to as L₀ assuming that the photosensitive webs 22a and 22b are not extended, the extension rate α1(%) of the photosensitive web 22a is defined as α1=(La/L₀−1)×100, and the extension rate α2(%) of the photosensitive web 22b is defined as α2=(Lb/L₀−1)×100. Evaluation was performed by measuring the respective extension rates α1 and α2 with variation of the static frictional coefficient μ with respect to the flexible base film 26 of the rubber roller 80a. The acceptable ranges of the extension rates α1 and α2 are set within 0.1% and 1.0%. The results are shown in FIG. 17.

If the static frictional coefficient μ is set within a range of 1.0<μ, the extension rates α1 and α2 exceed the acceptable range, requiring processing such as adjustment of the half cut sites 34 by the first and second processing mechanisms 36a and 36b (Extension rate evaluation: D).

If the static frictional coefficient μ is set within a range of 0.6<μ≦1.0, the extension rates α1 and α2 occasionally exceed the acceptable range in some cases (Extension rate evaluation: C). Moreover, if the static frictional coefficient μ is set within a range of 0.3<μ≦0.6, the extension rates α1 and α2 come within the acceptable range in many cases, and an excellent pasted condition can be obtained with a considerable probability (Extension rate evaluation: B). Furthermore, if the static frictional coefficient μ is set within a range of 0.1≦μ≦0.3, the extension rates α1 and α2 are within the acceptable range, and an excellent pasted condition can be obtained (Extension rate evaluation: A).

From the above result, it is understood that a decrease in the static frictional coefficient μ of the rubber roller 80a with respect to the flexible base film 26 can bring the extension rates α1 and α2 within the acceptable range. Moreover, if the static frictional coefficient μ is set within a range of 0.1≦μ≦0.3, the relative displacement of the paste positions of the photosensitive webs 22a and 22b can be stably kept within the acceptable range, and a very excellent pasted condition can be obtained.

Next is a description of an embodiment for producing a high quality photosensitive laminate 106 without mixed bubbles due to wrinkles in the photosensitive webs 22a and 22b, in the manufacturing apparatus 20 shown in FIG. 1 or the manufacturing apparatus 300 shown in FIG. 8. In this embodiment, the first and second detecting mechanisms 47a and 47b may have a structure as shown in FIG. 12.

In this embodiment, the surface temperature of the upper rubber roller 80a is set within a range of 95° C.±10° C., and more preferably a range of 95° C.±5° C., and the surface temperature of the lower rubber roller 80b is set within a range of 120° C.±10° C., and more preferably a range of 120° C.±5° C.

In this case, since the surface temperature of the rubber roller 80a in slidable contact with the photosensitive webs 22a and 22b is set relatively low, occurrence of wrinkles in these photosensitive webs 22a and 22b due to high temperatures can be satisfactorily prevented. On the other hand, the surface temperature of the rubber roller 80b in slidable contact with the glass substrate 24 is set to a temperature capable of sufficiently heating the photosensitive resin layer 28.

By so doing, effects can be obtained in which the occurrence of bubbles due to wrinkles can be effectively prevented in the photosensitive webs 22a and 22b, and in which a high quality lamination processing can be reliably performed.

Next is a description of an embodiment for producing a high quality photosensitive laminate 106 without wrinkles and unevenness by pressingly bonding the glass substrate 24 and the photosensitive webs 22a and 22b with an even pressing force, in the manufacturing apparatus 20 shown in FIG. 1 or the manufacturing apparatus 300 shown in FIG. 8. In this embodiment, the first and second detecting mechanisms 47a and 47b may have a structure as shown in FIG. 12.

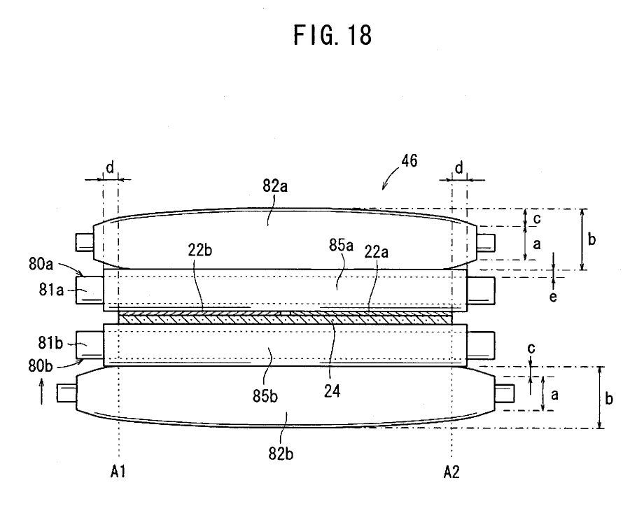

FIG. 18 shows the structure of the rubber rollers 80a and 80b and the backup rollers 82a and 82b constituting the pasting mechanism 46.

The rubber rollers 80a and 80b are formed by covering rubber materials 85a and 85b over a predetermined range on the outer periphery of shafts 81a and 81b, whose peripheral shapes are straight in the axial direction. In this case, the ranges covered with the rubber materials 85a and 85b are set to be outside by just a distance d=5 to 30 mm, from the opposite sides of the glass substrate 24 in the orthogonal direction to the conveyance direction. Moreover, the thicknesses e of the rubber materials 85a and 85b are set within a range of e=0.5 to 3.0 mm.

The backup rollers 82a and 82b are formed in a crown shape whose diameter is gradually increased from the opposite ends to the central portion. The crown amount c of the backup rollers 82a and 82b is defined as c=(b−a)/2 assuming that the maximum diameter of the central portion of the backup rollers 82a and 82b is b and the minimum diameter of the opposite ends is a. The crown amount c is set within a range of 0.3 to 1.5 mm, and more preferably a range of 0.5 to 0.8 mm.

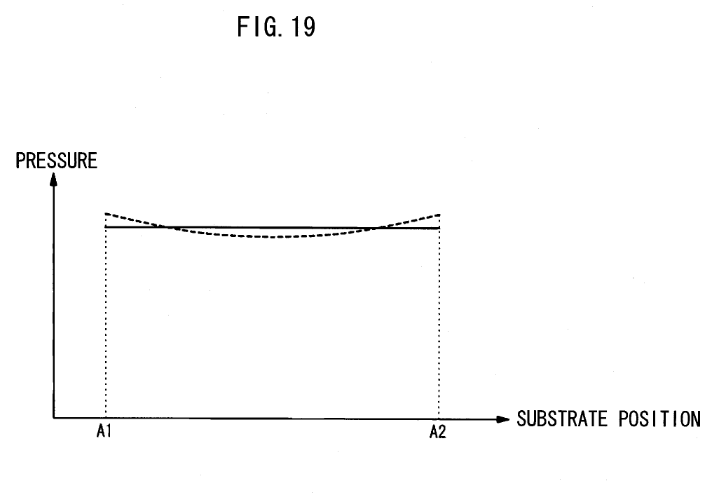

By constructing in such a manner, when a pressing force is applied to the rubber rollers 80a and 80b by the backup rollers 82a and 82b, the peripheral shape of the backup rollers 82a and 82b is changed from the crown shape into a straight shape by the pressing force, and thus, when the backup rollers 82a and 82b are displaced by a predetermined amount, a substantially even pressure is applied to the photosensitive webs 22a and 22b and the glass substrate 24 through the rubber rollers 80a and 80b. Moreover, since the opposite sides of the glass substrate 24 and the opposite ends of the rubber materials 85a and 85b are set separated by just a predetermined distance d, excessive pressure occurring at the opposite ends of the rubber materials 85a and 85b are not focused on the opposite sides of the glass substrate 24 as shown by the broken lines. As a result, as shown by the solid line of FIG. 19, a substantially even pressure can be obtained in a space between the point A1 and the point A2 corresponding to the opposite sides of the glass substrate 24.

In this manner, since the pressure becomes substantially even in a space between the point A1 and the point A2 of the glass substrate 24, the photosensitive webs 22a and 22b are not wrinkled, and unevenness in the pasted condition does not occur, enabling realization of an excellent transfer condition.

By setting the crown amount c of the backup rollers 82a and 82b which apply a pressing force onto the rubber rollers 80a and 80b, to 0.3 to 1.5 mm, and more preferably 0.5 to 0.8 mm, the pressure in a space between the point A1 and the point A2 of the glass substrate 24 can be made even with respect to a predetermined pressing force of the rubber rollers 80a and 80b.

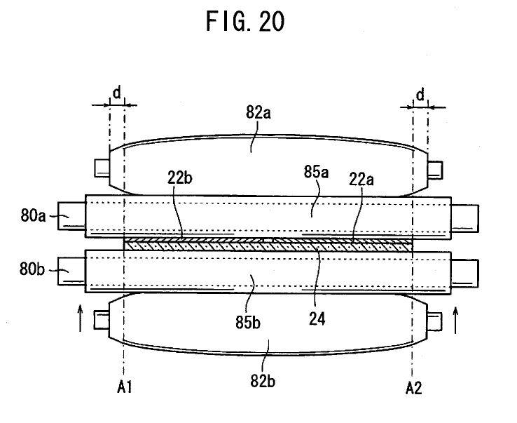

Moreover, in the abovementioned structure, the range of the distance d between the opposite sides of the glass substrate 24 and the opposite ends of the rubber materials 85a and 85b is made from 5 to 30 mm, to thereby make the pressing force even. However, as shown in FIG. 20, the width of the rubber materials 85a and 85b may be set sufficiently greater than the width of the glass substrate 24, while the opposite ends of the backup rollers 82a and 82b come to the outside of the opposite sides of the glass substrate 24 by just the distance d=5 to 30 mm. In this case, the effect of excessive pressure occurring by the contact of the opposite ends of the backup rollers 82a and 82b with the rubbers 85a and 85b can be avoided, to obtain a substantially even pressing force.

Furthermore, in the abovementioned structure, the upper and lower backup rollers 82a and 82b are in a crown shape. However, a similar effect can be obtained, even if only one of the backup rollers 82a and 82b is formed in a crown shape. If only one of the backup rollers 82a and 82b is formed in a crown shape, the crown amount c is suitably set within a range of c=0.6 to 3.0 mm, being as an additional value to the case where the both of the backup rollers 82a and 82b are formed in a crown shape.

### Second Aspect of the Invention

The photosensitive transfer material used in formation of a rib for manufacturing a color filter utilizing an ink jet method, as well as the rib using the material, and a method for forming the rib in the first embodiment of the second aspect of the invention will be explained in detail.

<Photosensitive Transfer Material>

The photosensitive transfer material of the invention is a transfer material for forming ribs compartmenting regions to which an ink is imparted, on a permanent support upon formation of a colored region (hereinafter, also referred to as “pixel”) by an ink jet format.

The photosensitive transfer material of the invention has at least a thermoplastic resin layer and a photosensitive resin layer in this order from a provisional support side, on the provisional support, and is constructed so that a melt viscosity (η_{K}) of the photosensitive resin layer at 100° C. and a melt viscosity (η_{Cu}) of the thermoplastic resin layer at 100° C. satisfy a relationship of η_{K}/η_{Cu}>2.

The photosensitive transfer material may have another layer such as an intermediate layer between the thermoplastic resin layer and the photosensitive resin layer, if necessary.

In the photosensitive transfer material of the invention, a value of a ratio η_{K}/η_{Cu} of melt viscosities of the photosensitive resin layer and the thermoplastic resin layer as constitutional layers at 100° C. is greater than 2. When the value of η_{K}/η_{Cu} is greater than 2, occurrence of a defect generated by breaking of a part of a wall of a formed rib (breaking defect) can be prevented, and a rib can be stably manufactured.

The value of η_{K}/η_{Cu}, from a viewpoint of prevention of occurrence of a breaking defect, is preferably 4 or more, more preferably 6 or more. An upper limit of η_{K}/η_{Cu}, from a viewpoint of better adherability between the photosensitive resin layer and a substrate, is preferably less than 5000, more preferably less than 500, and further preferably less than 50.

Like this, in the invention, by adopting a value of a ratio η_{K}/η_{Cu} of melt viscosities at 100° C. of the photosensitive resin layer and the thermoplastic resin layer constituting the photosensitive transfer material, which is greater than 2, that is, rendering the photosensitive resin layer hard and the thermoplastic resin layer soft in a predetermined range, occurrence of a breaking defect of formed ribs can be prevented. Thereby, color mixing occurring when an ink is imparted by ink jet to a region surrounded by ribs is prevented, and a color filter having a better color purity and hue, and consequently, a display device excellent in display property can be manufactured.

A melt viscosity can be measured by the following method.

A coating solution for forming the photosensitive resin layer, and a coating solution for forming the thermoplastic resin layer are coated on a glass plate, respectively, dried in an oven at 80 to 100° C. for about 2 minutes to prepare a dry film having a thickness of around 5 to 20 μm, and the film is vacuum-dried at about 40° C. for around 6 hours. A vacuum degree at vacuum drying is preferably 0.1 to 80 mmHg, more preferably 1 to 50 mmHg, most preferably 5 to 30 mmHg. After vacuum drying, the film is peeled from the glass plate to obtain a sample. When the film is not peeled well, the film is collected by cutting to obtain a measurement sample.

When a coating solution is not available, the photosensitive resin layer and the thermoplastic resin layer are peeled, respectively, from the photosensitive transfer material to obtain a measurement sample.

Measurement is performed at a temperature of 100° C. and a frequency of 1 Hz using a viscoelasticity measuring device (trade name: DnyAlyser DAS-100, manufactured by Jasco International Co. Ltd).

As a method of rendering a value of a ratio η_{K}/η_{Cu} greater than 2, there are a hardening method of making the photosensitive resin layer hard, and a softening method of softening the thermoplastic resin layer. Details of these methods will be described below in the item of each layer.

In addition, from a viewpoint of more effectively preventing a breaking defect of a rib, the thermoplastic resin layer and the photosensitive resin layer have independently a preferable viscosity range. In this regard, it is not always necessary to satisfy this independent preferable viscosity range, but even when a viscosity is outside these preferable viscosity ranges, it is possible to stably form a rib by adjusting a balance between the thermoplastic resin layer and the photosensitive resin layer so as to satisfy the relationship of η_{K}/η_{Cu}>2.

These independent preferable viscosity ranges will be described later.

—Thermoplastic Resin Layer—

The photosensitive transfer material of the invention has at least one thermoplastic resin layer.

It is preferable that the thermoplastic resin layer is alkali-soluble from a viewpoint that alkali development becomes possible, and contaminant of a transference subject with the thermoplastic resin layer itself which has overflown at transference can be prevented. The thermoplastic resin layer is a layer which has the function as a cushion material effectively preventing deteriorated transference occurring due to irregularities present on a transference subject upon transference of the photosensitive resin layer described later onto a transference subject, and can be deformed corresponding to irregularities on a transference subject when the photosensitive transfer material is adhered to the transference subject by heating.

In the invention, a thickness of the thermoplastic resin layer is preferably 2 to 50 μm from a viewpoint of the transference property. When a thickness is within the range, peeling from a provisional support at transference can be performed better without damaging a peeling surface, and fine pattern formation becomes possible accompanying with deteriorated light exposure due to variation in a thickness. A thickness is more preferably 5 to 40 μm, particularly preferably 10 to 30 μm.

The thermoplastic resin layer can be constructed using at least a thermoplastic resin, and can be constructed appropriately using other component, if necessary.

The thermoplastic resin can be appropriately selected without any limitation, and is preferably at least one kind selected from, for example, a saponificate of ethylene and an acrylic acid ester copolymer, a saponificate of styrene and a (meth)acrylic acid ester copolymer, a saponificate of vinyltoluene and a (meth)acrylic acid ester copolymer, a saponificate of poly(meth)acrylic acid ester, and a (meth)acrylic acid ester copolymer of butyl (meth)acrylate and vinyl acetate.

In addition to the above resins, among organic polymers listed in “Plastic Performance Handbook” (The Japan Plastic Industry Federation, edited by ALL JAPAN PLASTIC PRODUCTS INDUSTRIAL FEDERATION, published by Kogyo Chosakai Publishing, Inc. on Oct. 25, 1968), those soluble in an aqueous alkali solution may be used.

As the thermoplastic resin contained in the thermoplastic resin layer, a resin which realizes a substantial softening point of 80° C. or less of the thermoplastic resin layer is preferable.

These thermoplastic resins may be used alone, or two or more kinds may be used together. From a viewpoint of sufficient cushion property and easy removal after transference, it is preferable to use resins having two kinds of different properties (high-molecular polymer P^{H} and low-molecular polymer P^{L} described later) by mixing them.

In the invention, “(meth)acrylic acid” collectively refers to acrylic acid and methacrylic acid, and this is also true in the case of a derivative thereof.

Among thermoplastic resins contained in the thermoplastic resin layer, preferable is a resin having a weight average molecular weight in the range of 50000 to 500000 (Tg=0 to 140° C.), and further preferable is a resin having a weight average molecular weight in the range of 60000 to 200000 (Tg=30 to 110° C.). Specific examples of these resins include resins which are soluble in an aqueous alkali solution described in each gazette of Japanese Patent Application Publication (JP-B) Nos. 54-34327, 55-38961, 58-12577, and 54-25957, JP-A No. 61-134756, JP-B No. 59-44615, JP-A Nos. 54-92723, 54-99418, 54-137085, 57-20732, 58-93046, 59-97135, 60-159743, 60-247638, 60-208748, 60-214354, 60-230135, 60-258539, 61-169829, 61-213213, 63-147159, 63-213837, 63-266448, 64-55551, 64-55550, 2-191955, 2-199403, 2-199404, 2-208602, and 5-241340.

Particularly preferable is a methacrylic acid/2-ethylhexyl acrylate/benzyl methacrylate/methyl methacrylate copolymer described in JP-A No. 63-147159.

Among various thermoplastic resins, on a low-molecular side, preferable is a resin having a weight average molecular weight in the range of 3000 to 200000 (Tg=30 to 170° C.), and further preferable is a resin having a weight average molecular weight in the range of 5000 to 100000 (Tg=60 to 140° C.). Specific examples of these preferable resins can be selected from those described in the above gazettes, and particularly preferable is a styrene/(meth)acrylic acid copolymer described in each gazette of JP-B No. 55-38961, and JP-A No. 5-241340.

Furthermore, it is preferable to use resins having different two kinds of properties, specifically, a high-molecular polymer P^{H} and a low-molecular polymer P^{L} by mixing them, as described above. Herein, the low-molecular polymer is a polymer having a weight average molecular weight of 3,000 or more and less than 12000, and the high-molecular polymer is a polymer having a weight average molecular weight of 12000 or more.

From a viewpoint of sufficient cushion property and easy removal after transference, a preferable embodiment is the case where P^{L} having a weight average molecular weight of 5000 or more and less than 10000 and P^{H} having a weight average molecular weight of 50000 or more and less than 120000 are used by mixing them, and a preferable example includes the case where a methacrylic acid/2-ethylhexyl acrylate/benzyl methacrylate/methyl methacrylate copolymer (P^{H}) and a styrene/(meth)acrylic acid copolymer (P^{L}) are used by mixing them.

As a component other than the thermoplastic resin, various polymers, a supercooling substance, an adherability improving agent, a surfactant, and a releasing agent can be added to the thermoplastic resin layer in such a range that a softening point does not substantially exceed 80° C., for the purpose of regulating an adhering force with a provisional support. Tg may be adjusted by them. In addition, an organic high-molecular compound having a softening point of 80° C. or more can be also used so as to lower a substantial softening point to 80° C. or less, by adding various plasticizers having compatibility with the high-molecular compound thereto.

Specific examples of a preferable plasticizer include polypropylene glycol, polyethylene glycol, dioctyl phthalate, diheptyl phthalate, dibutyl phthalate, tricresyl phosphate, cresyldiphenyl phosphate, biphenyldiphenyl phosphate, polyethylene glycol mono(meth)acrylate, polyethylene glycol di(meth)acrylate, polypropylene glycol mono(meth)acrylate, polypropylene glycol di(meth)acrylate, an addition reaction product of an epoxy resin and polyethylene glycol mono(meth)acrylate, an addition reaction product of organic diisocyanate and polyethylene glycol mono(meth)acrylate, an addition reaction product of organic diisocyanate and polypropylene glycol mono(meth)acrylate, phthalic acid diesters, and a condensation reaction product of bisphenol A and polyethylene glycol mono(meth)acrylate.

Examples of a preferable combination of the thermoplastic resin and the plasticizer include 1) a combination of a methacrylic acid/2-ethylhexyl acrylate/benzyl methacrylate/methyl methacrylate copolymer, a styrene/(meth)acrylic acid copolymer, and a condensation reaction product of bisphenol A and polyethylene glycol mono(meth)acrylate, 2) a combination of a methacrylic acid/benzyl methacrylate copolymer, a styrene/(meth)acrylic acid copolymer, and a condensation reaction product of bisphenol A and polyethylene glycol mono(meth)acrylate, 3) a combination of a methacrylic acid/2-ethylhexyl acrylate/benzyl methacrylate/methyl methacrylate copolymer, a styrene/(meth)acrylic acid copolymer, and phthalic acid diesters, and 4) a combination of a methacrylic acid/benzyl methacrylate copolymer, a styrene/(meth)acrylic acid copolymer, and phthalic acid diesters.

An amount of the plasticizer in the thermoplastic resin layer is generally 200% by mass or less relative to the thermoplastic resin and, from a viewpoint of easy control of softening of the thermoplastic resin layer, is preferably in the range of 20 to 100% by mass.

As the surfactant, a surfactant which is miscible with the thermoplastic resin can be used.

Examples of a preferable surfactant include surfactants described in paragraphs [0015] to [0024] of JP-A No. 2003-337424, paragraphs [0012] to [0017] of JP-A No. 2003-177522, paragraphs [0012] to [0015] of JP-A No. 2003-177523, paragraphs [0010] to [0013] of JP-A No. 2003-177521, paragraphs [0010] to [0013] of JP-A No. 2003-177519, paragraphs [0012] to [0015] of JP-A No. 2003-177520, paragraphs [0034] to [0035] of JP-A No. 11-133600, and JP-A No. 6-16684.

In order to enhance adherability with the provisional support, any of a fluorine-based surfactant and/or a silicone-based surfactant (fluorine-based surfactant, or silicone-based surfactant, surfactant containing both of fluorine atom and silicon atom), or two or more kinds of them are preferably contained, and a fluorine-based surfactant is most preferable.

Alternatively, the following commercially available surfactants may be used as they are. Examples of the commercially available surfactant which can be used include a fluorine-based surfactant, and a silicone-based surfactant such as F Top EF301, and EF303 (manufactured by Shin Akita Kasei), Flolard FC430, and 431 (manufactured by Sumitomo 3M Ltd.), Megafack F-780-F, F171, F173, F176, F189, and R08 (manufactured by Dainippon Ink and Chemicals, Incorporated), and Surflon S-382, SC101, 102, 103, 104, 105, and 106 (manufactured by Asahi Glass Company). In addition, a polysiloxane polymer KP-341 (manufactured by Shin-Etsu Chemical Co., Ltd.), and Troy Sol S-366 (manufactured by Troy Chemical Co., Ltd.) can be also used as a silicone-based surfactant.

A melt viscosity (η_{Cu}) of the thermoplastic resin layer at 100° C. can be selected in a range satisfying a relationship of η_{K}/η_{Cu}>2. Within the range, η_{Cu} is preferably 200 Pa·s to 3000 Pa·s, more preferably 200 Pa·s to 2000 Pa·s, and most preferably 500 Pa·s to 2000 Pa·s.

When η_{Cu} is within the range, this is effective for preventing occurrence of a breaking defect of a rib formed by lamination and, at the same time, overflow of the thermoplastic resin layer at transference, and staining of a heat roll by lamination therefrom are prevented, transference can be performed well, compatibility with irregularities on a substrate can be maintained, and adhesion on a permanent support can be performed well.

As a means for adjusting a melt viscosity η_{Cu} of the thermoplastic resin layer within the above range, there is a method of adjusting a content of a low-molecular polymer and a content of a plasticizer in a polymer constituting the thermoplastic resin layer. When the thermoplastic resin layer is softened, the melt viscosity can be adjusted by a method of (1) increasing an amount of the plasticizer to be added, or (2) increasing a content of a low-molecular polymer to reduce a proportion of a high-molecular component.

A content ratio (P^{H}/P^{L}) of a high-molecular polymer P^{H} and a low-molecular polymer P^{L} in a polymer constituting the thermoplastic resin layer is preferably 10/90 or more and less than 70/30, more preferably 12/88 or more and less than 60/40, most preferably 15/85 or more and less than 50/50. When the ratio is within the range, occurrence of a breaking defect of a rib formed by lamination is effectively prevented and, at the same time, peelability and cushion property can be maintained.

The low-molecular polymer is a polymer having a weight average molecular weight of 3,000 or more and less than 12000, and the high-molecular polymer is a polymer having a weight average molecular weight of 12000 or more.

The weight average molecular weight in the invention is a weight average molecular weight in terms of polystyrene measured by gel permeation chromatography (GPC; elusion solvent tetrahydrofuran) (hereinafter, simply referred to as “weight average molecular weight”) (in both of the first embodiment and the second embodiment).

An amount of the plasticizer to be added is preferably 28 to 43% by mass, more preferably 30 to 40% by mass, and particularly preferably 32 to 38% by mass relative to an amount of a solid matter of a resin component and the plasticizer content in the thermoplastic resin layer. When a content of the plasticizer is within the range, it is effective in reducing a viscosity of the thermoplastic resin layer to such an extent that occurrence of a breaking defect of a rib formed by lamination and transference can be prevented and, at the same time, cushion property can be maintained, overflow of the thermoplastic resin layer at transference and staining of a heat roll of lamination therefrom can be prevented.

—Photosensitive Resin Layer—

The photosensitive transfer material of the invention has at least one photosensitive resin layer on a side not facing a provisional support of the thermoplastic resin layer provided on the provisional support. The photosensitive resin layer is a layer constituting a resin structure when the resin structure such as a rib is formed, and a composition for forming a black matrix described later can be preferably used.

A melt viscosity (η_{K}) of the photosensitive resin layer at 100° C. can be selected in a range satisfying a relationship of η_{K}/η_{Cu}>2. Within the range, η_{K} is preferably 2000 Pa·s to 1000000 Pa·s, more preferably 4000 Pa·s to 30000 Pa·s, and most preferably 10000 Pa·s to 20000 Pa·s.

When η_{K} is within the range, occurrence of a breaking defect of a rib formed by lamination is effectively suppressed and, at the same time, adherability on a permanent support can be maintained.

As a means for adjusting a melt viscosity η_{K} of the photosensitive resin layer within the above range, there is a method of (1) regulating a ratio of a monomer/a binder polymer, (2) adjusting a ratio of a pigment in a solid matter of the photosensitive resin layer, or (3) adjusting a glass transition temperature (Tg) of a binder polymer.

Particularly, examples of a method of hardening the photosensitive resin layer include (1′) reduction in a ratio (M/B) of a monomer (M)/a binder polymer (B) (preferably 0.8≦M/B≦0.5), (2′) addition of a pigment to the photosensitive resin layer to increase a ratio of a pigment in a solid matter, and (3) selection of a binder polymer having high Tg (preferably Tg≧80). Inter alia, the method of (3) does not influence physical property of the photosensitive resin layer after baking treatment, and is particularly preferable.

It is preferable that the photosensitive resin layer of the photosensitive transfer material of the invention for forming a rib is constructed so as to have the light shielding function such as a black matrix when a rib is formed. The rib can be manufactured using the same material as that of a black matrix for the known color filter. As the black matrix for the known color filter, there are, for example, a black matrix described in paragraph numbers [0021] to [0074] of JP-A No. 2005-3861, and paragraph numbers [0012] to [0021] of JP-A No. 2004-240039, and a black matrix for an ink jet described in paragraph numbers [0015] to [0020] of JP-A No. 2006-17980, paragraph numbers [0009] to [0044] of JP-A No. 2006-10875.

Components of the photosensitive resin layer will be explained in detail. The photosensitive resin layer may contain a coloring material, a binder polymer, a monomer, and a polymerization initiator and, if necessary, a polymerization inhibitor, and a surfactant.

As the coloring material, the known pigments having a hue depending on the purpose such as red, blue, green and black can be used by appropriate selection.

The photosensitive resin layer has preferably the light shielding function and, as the pigment, a black pigment is preferably used.

Examples of the black pigment include carbonaceous black (carbon black, graphite etc.), and a metal compound (titanium black etc.). As an example of carbon black, Pigment Black 7 (carbon black C.I. No. 77266) is preferable. As an example of titanium black, there are TiO₂, TiO, TiN and a mixture thereof. Among these black pigments, carbon black is preferable in that it is excellent in the light shielding property.

As the photosensitive resin layer, there are a photosensitive resin layer which can be developed with an aqueous alkali solution, and a photosensitive resin layer which can be developed with an organic solvent. From a viewpoint of safety, and the cost of a developer, the photosensitive resin layer which can be developed with an aqueous alkali solution is preferable. Furthermore, a photosensitive resin layer which has photosensitivity and can be developed with an aqueous alkali solution is more preferable, and can be constructed using a photopolymerizable composition.

Examples of the photopolymerizable composition constituting the “photosensitive transfer layer which has photosensitivity and can be developed with an aqueous alkali solution” include a photopolymerizable composition containing, as a main component, an alkali-soluble binder having an acid group such as a carboxylic acid group, a polymerizable or crosslinkable compound such as a polyfunctional acryl monomer, and a photopolymerization initiator. The composition has the property that an initiation species such as a radical is generated from a photopolymerization initiator by light exposure, polymerization of a polymerizable or crosslinkable compound, and a crosslinking reaction are caused, and progressed, and an exposed region is cured.

As the polymerizable or crosslinkable compound, a polyfunctional acryl monomer is preferable. Preferable examples of the polyfunctional acryl monomer include (meth)acrylates such as ethylene glycol di(meth)acrylate, triethylene glycol di(meth)acrylate, 1,3-butanediol di(meth)acrylate, tetramethylene glycol di(meth)acrylate, propylene glycol di(meth)acrylate, trimethylolpropane tri(meth)acrylate, 1,4-hexanediol di(meth)acrylate, pentaerythritol tetra(meth)acrylate, dipentaerythritol penta(meth)acrylate, and dipentaerythritol hexa(meth)acrylate.

As the binder containing an acid group such as a carboxylic acid group, a copolymer of an unsaturated organic acid compound such as acrylic acid, and methacrylic acid, and an unsaturated organic acid ester compound such as methyl acrylate, ethyl acrylate, and benzyl methacrylate is preferable.

Preferable examples of the photopolymerization initiator include a halomethyloxadiazole-based compound and a halomethyl-s-triazine-based compound.

A preferable content of each component in the transfer layer, as expressed by % by mass in a total solid matter, is 10% to 50% in the case of the pigment, 10% to 50% in the case of the polyfunctional acrylate monomer, 20% to 60% in the case of the carboxylic acid group-containing binder, and 1% to 20% in the case of the photopolymerization initiator.

The photopolymerizable composition which is usable in the invention is not limited to the above examples, but can be appropriately selected from the known compositions.

A thickness of the photosensitive resin layer is preferably 0.5 to 10 μm, more preferably 1.0 to 5.0 μm, and most preferably 1.5 to 3.0 μm from a viewpoint of prevention of color mixing.

—Provisional Support—

The provisional support constituting the transfer material in the invention is not particularly limited, but any can be used as long as it is a general plastic film.

Examples of a material for the plastic film include polyethylene terephthalate, polyethylene naphthalate, polybutylene terephthalate, polyarylates, polyether sulfone, polycarbonate, polyether ketone, polysulfone, polyphenylene sulfide, polyester-based liquid crystal polymer, triacetylcellulose, polypropylene, polyamides, polyimide, and polycycloolefins.

Inter alia, a biaxially stretched film of polyethylene terephthalate is preferable from a viewpoint of elasticity, transparency, heat resistance, chemical resistance, and the cost.

A thickness of the provisional support is preferably in the range of 15 to 200 μm, further preferably in the range of 30 to 150 μm. When the thickness is within the above range, the provisional support is not deformed due to heat during a drying step and a transferring step after coating, and transference can be performed well.

—Intermediate Layer—

In the transfer material in the invention, it is preferable that an intermediate layer is provided between the thermoplastic resin layer and the photosensitive resin layer for preventing mixing of both layers at coating.

A resin constituting the intermediate layer is preferably alkali-soluble. Examples of such resin include a polyvinyl alcohol-based resin, a polyvinylpyrrolidone-based resin, a cellulose-based resin, an acrylamide-based resin, a polyethylene oxide-based resin, gelatin, a vinyl ether-based resin, a polyamide resin, and a copolymer thereof. Alternatively, a resin which is rendered alkali-soluble by copolymerizing a resin, for example, polyester, which is not usually alkali-soluble, with a monomer having a carboxyl group or a sulfonic acid group, may be used.

Among them, preferable is polyvinyl alcohol. As the polyvinyl alcohol, polyvinyl alcohol having a saponification degree of 80% or more is preferable, and polyvinyl alcohol having a saponification degree of 83 to 98% is further preferable.

The resin constituting the intermediate layer is preferably used by mixing two or more kinds, and it is particularly preferable that polyvinyl alcohol and polyvinylpyrrolidone are used by mixing them. A mass ratio of both of them is preferably in the range of polyvinylpyrrolidone/polyvinyl alcohol=1/99 to 75/25, further preferably in the range of 10/90 to 50/50. When the mass ratio is within the range, the surface state of the intermediate layer can be retained better, adherability with the photosensitive resin layer provided on the intermediate layer can be retained well and, at the same time, oxygen shielding property due to the intermediate layer is obtained, and a better sensitivity can be retained.

The intermediate layer can be formed by coating a coating solution prepared using components constituting the intermediate layer. A coating solvent used for preparing a coating solution for forming the intermediate layer is not particularly limited, as long as it can dissolve the aforementioned resin. It is preferable to use water, and a mixed solvent obtained by mixing water with the water-miscible organic solvent is also preferable.

Specific examples of the preferable coating solvent for the intermediate layer include water, water/methanol=90/10, water/methanol=70/30, water/methanol=55/45, water/ethanol=70/30, water/1-propanol=70/30, water/acetone=90/10, and water/methyl ethyl ketone=95/5. These ratios indicate a ratio by mass.

A thickness of the intermediate layer is preferably 0.1 to 5 μm, further preferably 0.5 to 3 μm. When a thickness of the intermediate layer is within the range, oxygen shielding property is obtained, and removal of the intermediate layer by development can be performed in a shorter time.

—Others—

The photosensitive transfer material of the invention may have a protecting film, if necessary, in addition to the thermoplastic resin layer, the photosensitive resin layer and the intermediate layer.

Regarding details of a method for manufacturing the provisional support, the intermediate layer, and the protecting film, as well as the transfer material constituting the photosensitive resin transfer material, those described in paragraph numbers [0023] to [0066] of JP-A No. 2005-3861 can be preferably applied.

It is preferable that the photosensitive transfer material is constructed into a photosensitive resin transfer material described in JP-A No. 5-72724, that is, an integrally constructed film. Examples of a construction of the integral film include a construction in which provisional support/thermoplastic resin layer/intermediate layer/photosensitive resin layer/protecting film are laminated in this order.

<Rib and Method for Manufacturing the Same>

The rib of the invention is formed by a step of pressure-contacting the photosensitive transfer material of the invention against a permanent support so that the photosensitive resin layer contacts the permanent support (hereinafter, referred to as “transferring step” in some cases).

The rib of the invention is preferably formed by a step of pressure-contacting the photosensitive transfer material of the invention against a permanent support so that the photosensitive resin layer contacts the permanent support (transferring step), and a step of exposing at least the photosensitive resin layer after pressing to light to develop it (hereinafter, referred to as “patterning step” in some cases).

In the step of pressing against a permanent support (transferring step), at least the photosensitive resin layer forming the rib is transference-formed on the permanent support (applied with laminator). That is, the photosensitive transfer material is pressure-contacted against the permanent support so that the photosensitive resin layer contacts the permanent support, the photosensitive resin layer formed on the permanent support is exposed to light in a desired pattern manner, and further developed, thereby, the rib can be manufactured. If necessary, other steps such as a step of post-light exposure and a step of post-baking may be provided. The provisional support may be removed after transference and before pattern light exposure, or may be removed after pattern light exposure.

As the transferring step, the method described in paragraph number [0037] of JP-A No. 2006-23696, and the method of transference using a laminator described in WO 2006-4225 are also preferable in the invention. As steps of light exposure in pattern-wise, development, post-light exposure and post-baking, the method described in paragraph numbers [0038] to [0051] of JP-A No. 2006-23696 can be applied.

Since the rib of the invention is formed using the photosensitive transfer material of the invention, occurrence of a defect of wall breaking (breaking defect) is prevented, color mixing of an ink when an ink is imparted by an ink jet method is effectively prevented, and a color filter having better color property, consequently, a display device excellent in display property is obtained. In addition, since transference using the photosensitive resin transfer material is performed, this is preferable also from a viewpoint of cost saving.

As the rib, any rib may be used as long as it is obtained by a transferring method using the photosensitive transfer material of the invention and, when a color filter is manufactured, it is preferable that the rib has the light shielding function such as a black matrix.

In order to prevent color mixing of an imparted ink jet ink, the rib may be subjected to ink repulsion treatment. Examples of the ink repulsion treatment include (1) a method of kneading an ink repulsing substance into a rib (e.g. see JP-A No. 2005-36160), (2) a method of newly providing an ink repulsing layer (e.g. see JP-A No. 5-241011), (3) a method of imparting ink repulsion property by plasma treatment (e.g. see JP-A No. 2002-62420), and (4) a method of coating an ink repulsing material on an upper surface of the rib (e.g. see JP-A No. 10-123500). Particularly, (3) a method of imparting ink repulsion property to a rib formed on a substrate by plasma treatment to subject the rib to ink repulsion treatment is preferable.

A height of the rib is preferably 0.5 to 10 μm, more preferably 1.0 to 5.0 μm, and most preferably 1.5 to 3.0 μm from a viewpoint of prevention of color mixing.

It is preferable that an optical concentration of the rib is 3 to 5 in that a rib having high light shielding property (e.g. black matrix) can be formed.

The optical concentration of the rib can be obtained by measuring a transmittance optical concentration (OD¹) of a substrate with a rib on which the rib (e.g. black matrix) is formed at a wavelength of 555 nm using embodimentrophotometer (trade name: UV-2100, manufactured by Shimadzu Corporation), and measuring a transmittance optical concentration (OD⁰) of a substrate material used in each substrate with a rib (e.g. glass substrate) by a similar method, and subtracting OD⁰ from OD¹ to obtain a transmittance concentration OD(=OD¹−OD⁰) as an optical concentration.

A method for manufacturing a laminate, as well as a member for a display device manufactured by this method in the second embodiment of the second aspect of the invention will be explained in detail below.

<Method for Manufacturing Laminate>

The method for manufacturing a laminate of the invention manufactures a rib such as a black matrix for manufacturing a color filter utilizing an ink jet method, and a structure such as a colored pixel, a spacer, and a protrusion for controlling liquid crystal orientation constituting a color filter. Specifically, the method for manufacturing a laminate of the invention includes a step of using a transfer material having a matting agent-containing layer on a side opposite to a side on which a coating layer of a provisional support is provided, and transferring the coating layer on the provisional support onto a support having tension of a value in the range of from 60 N/m to 200 N/m applied to the provisional support at a time of the transferring.

In the method for manufacturing a laminate of the invention, by providing a matting agent-containing layer on a back which is a side opposite to a side on which a coating layer of a transfer material is provided, when lamination is performed by pressing against a support, occurrence of a defect produced by breaking of a part of a formed laminate (preferably rib) (breaking defect) can be effectively prevented. That is, breaking occurs gradually from lamination initiation and, for example, when lamination is continuously performed a length of 100 m or longer, an extent of occurrence of a breaking defect becomes remarkable and, particularly, occurrence of a breaking defect which becomes remarkable by this continuous treatment can be effectively prevented. Thereby, when a rib constituting a color filter is formed, color mixing which is produced when an ink is imparted to a region surrounded by ribs by ink jet is prevented, and a color filter which is better in a color purity and a hue, consequently, a display device excellent in display property can be manufactured.

The method for manufacturing a laminate of the invention manufactures a laminate forming a member for a display device such as a color filter by transferring a coating layer provided on a provisional support onto a desired support, and tension applied to the provisional support upon this transference is in the range of 60 N/m to 200 N/m. The tension herein refers to tension applied to a provisional support in a direction reverse to a direction of conveyance of the provisional support when lamination (transference) is performed.

When the tension is in the range of 60 N/m to 200 N/m, breaking does not occur in the rib at lamination. Particularly, even when lamination (e.g. a length of 100 m or longer) is continuously performed for a long time, breaking does not occur in the rib, and better lamination which does not produce a breaking defect is possible. Further, the provisional support itself is not wrinkled, and uniform surface state can be maintained. Since a breaking defect is not produced, for example, when a color filter is manufactured by imparting an ink by an ink jet method to form a colored region, color mixing is not produced, and a color filter having high contrast can be manufactured.

The tension in the invention is preferably 80 N/m to 180 N/m, more preferably 90 N/m to 160 N/m within the above range.

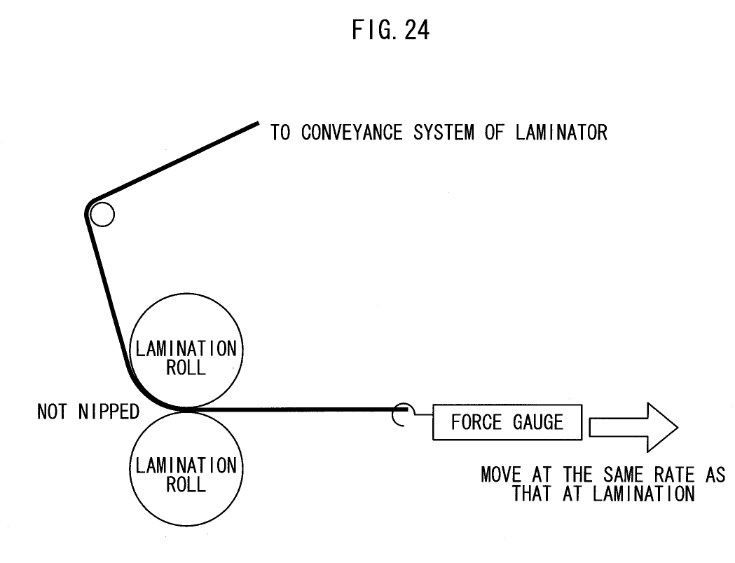

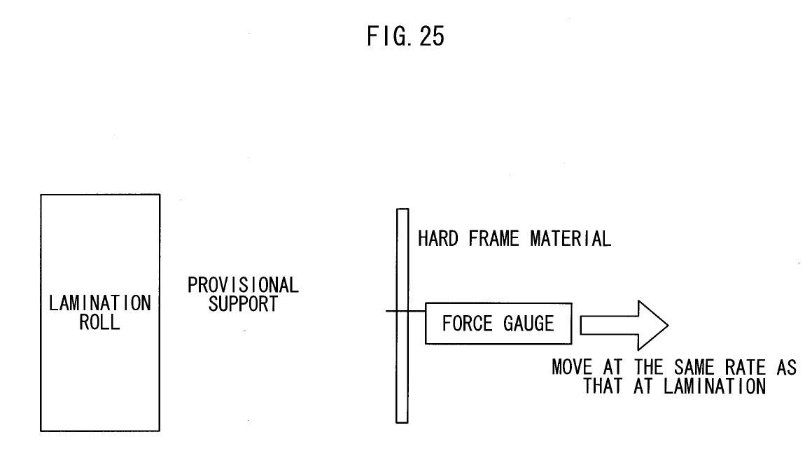

The tension can be measured by setting a tension of a laminator like actual lamination, pulling out a provisional support of a transfer material from between lamination rolls in the same direction as that of conveyance of the transfer material, holding an end part of the provisional support constituting the transfer material with hard frame materials, pulling a center of the frame materials with a force gauge in parallel with the conveyance direction, and measuring the tension in that state as shown in FIGS. 24 and 25. Specifically, the tension can be measured with a tension pickup arranged on both ends of an axis of a pass roll.

The method for manufacturing a laminate of the invention includes a step of using a transfer material having at least a provisional support, a coating layer provided on one side of the provisional support, and a matting agent-containing layer provided on the other side (hereinafter, referred to as “transfer material in the invention” in some cases), and transferring this coating layer of the transfer material onto a support (hereinafter referred to as “transferring step” in some cases). Transference can be performed by pressure-contacting the transfer material against a support so that the coating layer contacts the support and, after pressing, removing at least the provisional support.

The laminate in the invention is preferably formed by a step of pressure-contacting the transfer material in the invention against a support so that a the coating layer of the transfer material contacts the support (transferring step), and a step of exposing at least the photosensitive resin layer after pressing to light, to develop it (hereinafter, referred to as “patterning step”).

In the transferring step, at least a transfer layer forming a laminate (e.g. rib such as black matrix) is transference-formed on the support (applied with a laminator).

For example, when the transfer material is a photosensitive transfer material having a phopolymerizable resin layer as a transfer layer, the laminate can be preferably manufactured by pressure-contacting the photosensitive transfer material against a support so that phopolymererizable resin layer contacts a support, exposing the phopolymerizable resin layer formed on the support to light in a desired pattern manner, and further developing this. If necessary, other steps such as a step of post-light exposure and a step of post-baking may be provided. The provisional support may be removed after transference and before pattern light exposure, or may be removed after pattern light exposure.

As the transferring step, the method described in paragraph number [0037] of JP-A No. 2006-23696, and the method of transference using a laminator described in WO 2006-4225 are also preferable in the invention. Regarding steps of light exposure in a patter manner, development, post-exposure and post-baking, the method described in paragraph numbers [0038] to [0051] of JP-A No. 2006-23696 can be applied. In light exposure, in order to cope with scale up and high-definition, a mirror projection light exposing apparatus is suitable. The mirror projection light exposure is described in “Color PDP Technique” CMC (published on Jan. 25 in 2001), and the known light exposing apparatus can be used.

The method for manufacturing a laminate of the invention can manufacture a structure, e.g. a rib such as a black matrix, and is suitable for manufacturing preferably a member for a display device, particularly a rib such as a black matrix or a color filter. As the rib, any rib may be used as long as it is obtained by the method for manufacturing a laminate of the invention by a transferring method using the transfer material in the invention and, when a color filter is manufactured, it is preferable that the rib has the light shielding function such as a black matrix.

In order to prevent color mixing of an imparted ink jet ink, the rib may be subjected to ink repulsion treatment. Examples of the ink repulsion treatment include (1) a method of kneading an ink repulsing substance into a rib (e.g. see JP-A No. 2005-36160), (2) a method of newly providing an ink repulsion layer (e.g. see JP-A No. 5-241011), (3) a method of imparting ink repulsion property by plasma treatment (e.g. see JP-A No. 2002-62420) and (4) a method of coating an ink repulsing material on an upper side of the rib (e.g. see JP-A No. 10-123500). Particularly, (3) a method of imparting ink repulsion property to a rib formed on a substrate by plasma treatment to subject the rib to ink repulsion treatment is preferable.

A height of the rib (black matrix etc.) is preferably 0.5 to 5.0 μm, more preferably 2.0 to 3.0 μm from a viewpoint of prevention of color mixing.

Then, a transfer material used in the method for manufacturing a laminate of the invention will be described in detail.

The transfer material in the invention has a matting agent-containing layer containing a matting agent on one side of a provisional support, and has a coating layer on the other side. The coating layer in the invention includes all layers which can be formed on a side opposite to a side on which the matting agent-containing layer of the provisional support is formed, and specifically, includes a transfer layer for forming a structure, e.g. a rib such as a black matrix (e.g. photopolymerizable resin layer having light sensitivity), a thermoplastic resin layer, an intermediate layer provided between plural layers, and an oxygen shielding layer which shields oxygen. Preferably, the coating layer includes at least a transfer layer forming a structure, e.g. a rib such as a black matrix.

A preferable construction of a transfer material in the invention has a matting agent-containing layer on one side of a provisional support, and has a thermoplastic resin layer, an intermediate layer (oxygen shielding layer), and a transfer layer in this order from a provisional support side, on the other side.

—Matting Agent-Containing Layer—

The matting agent-containing layer includes a matting agent and, preferably, can be constructed using a matting agent, a binder and, if necessary, a crosslinking agent and a surfactant.

A thickness of the matting agent-containing layer is preferably in the range of 0.01 to 3.0 μm, more preferably in the range of 0.02 to 2.0 μm from a viewpoint that stable retention of a matting agent is attained, and transparency is maintained.

[Matting Agent]

The matting agent may be any of an organic particle and an inorganic particle and, preferably, is a particle having a particle diameter and a particle size distribution described later.

Examples of a material constituting the matting agent include polymethyl methacrylate, polystyrene, polycarbonate, melamine, benzoguanamine and a copolymer thereof in the case of an organic system, and silicon dioxide, titanium dioxide, and barium sulfate in the case of an inorganic system.

Among them, from a viewpoint of a hardness and heat resistance, an inorganic matting agent is preferable, and silicon dioxide is particularly preferable.

A shape of the matting agent is not particularly limited, but a spherical particle, a indeterminate particle and a regular hexahedral particle can be used. Inter alia, a spherical particle is particularly preferable.

An average particle diameter of the matting agent is preferably in the range of 0.1 to 10.0 μm, more preferably in the range of 0.15 to 3.0 μm. When the average particle diameter is within the above range, this is effective in preventing occurrence of a breaking defect at lamination, particularly, preventing occurrence of a breaking defect which becomes remarkable upon continuous lamination for a long time (e.g. a length of 100 m or longer) and, at the same time, is better in conveying property, and can suppress peeling from a layer.

The “particle diameter” referred in the invention, in the case of a spherical particle, indicates a diameter thereof, and can be measured using an electron micrograph image of a cross-section of the matting agent-containing layer. In the case of a particle other than the spherical particle, the “particle diameter” refers to a diameter when a particle is seen as a sphere having the same area as this cross-sectional area in a micrograph.

The “average particle diameter” is a number averaged particle diameter, and refers to a value obtained by obtaining the particle diameters regarding 100 particles from the electron micrograph image, and averaging them.

As the matting agent, it is preferable to use a matting agent having a sharp particle size distribution. As measure, it is preferable that, assuming the average particle diameter to be d, the number of matting agents having a particle diameter (D) in the range of 0.90 d to 1.1 d (0.90 d≦D≦1.1 d) is 70% or more of the total number of matting agents. That is, it is preferable that a matting agent having a particle diameter of d±10% relative to an average particle diameter d accounts for 70% or more of a whole. This is also true in the case of an average particle diameter indicated by d.

When this proportion is within the above range, this is effective in preventing occurrence of a breaking defect at lamination, particularly preventing occurrence of a breaking defect which becomes remarkable upon continuous lamination for a long time (e.g. a length of 100 m or longer).

Further, this proportion is preferably 90% or more.

A method of controlling a particle diameter of the matting agent in the above range can be arbitrarily selected. For example, a representative example includes a method of classifying matting agents, and selecting and using matting agents having a desirable particle diameter.

As a classification method, any of dry and wet processes may be used. As a dry process, there are methods of wind force classification and electrostatic classification. As a wet process, there is a method of classification by sedimentation. The classification method is described, for example, in “Ultrafine Particle Handbook” (supervised by Shinroku Saito, pp. 363, Fujitec Corporation, published in 1990), and “Fine Particle Technology Survey, Vol. 1: Basic Technique” (supervised by Hiroaki Yanagida, pp. 826, Fujitec Corporation, published in 1990), and the technique described therein can be also applied to the invention.

A content of the matting agent in the matting agent-containing layer is preferably in the range of 0.2 to 50 mg/m², more preferably in the range of 1 to 30 mg/m² from a viewpoint of prevention of occurrence of a breaking defect at lamination, particularly prevention of occurrence of a breaking defect which becomes remarkable upon continuous lamination for a long time (e.g. a length of 100 m or longer), as well as from a viewpoint of the effect of improving conveyance property and suppression of peeling of the matting agent particle.

[Binder]

The matting agent-containing layer can contain a binder for retaining the matting agent to form a film. The binder is not particularly limited as long as it has the film forming property, and examples thereof include polyacrylic acid ester, polymethacrylic acid ester, polyester resin, polyurethane resin, polystyrene, polyacrylonitrile, polyvinyl acetate, polyvinyl alcohol, styrene-butadiene resin, vinylidene chloride resin, vinyl chloride resin, ethylene-vinyl acetate resin, gelatin, polyvinyl alcohol, celluloses, styrene-maleic acid resin, phenol resin, and polyvinyl pyrrolidone.

Among them, a binder having a plurality of carboxylic acid groups in a molecule is preferable. As a method of introducing a carboxylic acid group into a molecule, a method of copolymerizing a monomer having a carboxylic acid group at the time of synthesizing the above resin components is preferable. An amount of the carboxylic acid group to be introduced into a resin component is preferably an amount in the range of 5 to 400, particularly preferably an amount in the range of 10 to 300 as expressed by an acid value.

A content of the binder in the matting agent-containing layer is preferably in the range of 70 to 99.5% by mass relative to a total mass of the matting agent-containing layer from a viewpoint of prevention of peeling of the matting agent.

[Other Additive]

The matting agent-containing layer can contain various additives such as a crosslinking agent, a surfactant and a solvent depending on the purpose, as long as the effect of the invention is not deteriorated.

When the layer is required to have a sufficient strength, a crosslinking agent for crosslinking the binder may be added. As the crosslinking agent, usually, a melamine resin, an epoxy resin, a block isocyanate compound, and a carbodiimide compound are used. Among them, the carbodiimide compound which can perform a crosslinking reaction at a low temperature is preferable. An addition amount of the crosslinking agent is preferably in the range of 1 to 70% by mass, more preferably in the range of 2 to 30% by mass of the binder, as expressed in a solid matter. When an addition amount of the crosslinking agent is within the above range, the better crosslinking effect is obtained while a pot life of a coating solution is retained.

Alternatively, in order to improve the coating property when the matting agent-containing layer is formed by coating, a surfactant may be added to a coating solution for forming the matting agent-containing layer. The surfactant is not particularly limited, and the known surfactant such as an anion series, a nonion series, a cation series, and a betaine series can be used. Examples of the surfactant are described in “New Edition of Surfactant Handbook (edited by Tokiyuki Yoshida et al.), Kougakutosho Ltd., published in 1987”, and these can be used by appropriate selection.

The matting agent-containing layer can be formed by dissolving materials constituting the matting agent-containing layer in an appropriate solvent to prepare a coating solution, and coating this solution on a provisional support, followed by drying.

A coating solvent for preparing a coating solution for forming a matting agent-containing layer is not particularly limited, and water, methyl alcohol, ethyl alcohol, methyl ethyl ketone, n-propanol, isopropanol, methyl ethyl ketone, methyl isobutyl ketone, toluene, and a mixture thereof can be used. Among them, water is particularly preferable from a viewpoint of the environment burden, and the cost.

In the transfer material in the invention, on a side on which the matting agent-containing layer of a provisional support is not provided, a coating layer such as a transfer layer, a thermoplastic resin layer, an intermediate layer, an undercoating layer, and a protecting layer forming a laminate (e.g. rib such as black matrix) can be provided, and preferably at least the transfer layer is provided.

Preferably, at least one layer of the coating layers contains a black pigment (more preferably carbonaceous black) and, more preferably, at least one layer of transfer layers contains a black pigment (more preferably carbonaceous black).

—Transfer Layer—

The transfer layer is constructed by appropriately selecting materials which are blended depending on the purpose of the transfer material, and details of a constituent element are the same as those of the photosensitive resin layer of the first embodiment except that there is no limitation of a viscosity ratio.

This transfer layer can be preferably formed, for example, by preparing a coating solution using the above components, and coating this containing solution on a provisional support by the known coating method, followed by drying.

If necessary, the known polymerization inhibitor and surfactant in addition to the above components may be added to the transfer layer.

A thickness of the transfer layer is preferably 0.5 to 5.0 μm, further preferably 2.0 to 3.0 μm. When the thickness is within the above range, the layer can be formed without generating a pinhole and, when a rib constituting a color filter is formed, better display quality is obtained while an optical concentration is retained.

When the transfer layer is a photopolymerizable black resin layer containing a black pigment, which is constructed to be photosensitive, a layer thickness is preferably 1.0 to 3.0 μm from a viewpoint of transmittance of exposure light, and an optical concentration is preferably 3 to 5 in that the layer having high light shielding property can be formed.

—Thermoplastic Resin Layer—

The transfer material in the invention may have a thermoplastic resin layer (preferably between a provisional support and the transfer layer) on a side on which the matting agent-containing layer of the provisional support is not provided.

Example of the resin include acryl resin, polystyrene resin, polyester, polyurethane, rubber-based resin, vinyl acetate-based resin, polyolefin-based resin and a copolymer thereof. The resin constituting the thermoplastic resin layer is not essentially alkali-soluble, but is desirably alkali-soluble from a viewpoint of easy removal at development.

Details of the thermoplastic resin layer are the same as those of the photosensitive resin layer of the first embodiment except that there is no limitation of a viscosity ratio.

—Intermediate Layer—

The intermediate layer is the same as the intermediate layer of the first embodiment.

—Provisional Support—

The provisional support is the same as the provisional support of the first embodiment.

<Member for Display Device>

The member for a display device of the invention is manufactured by the method for manufacturing a laminate of the invention and, for example, includes a colored pixel constituting a color filter, a rib such as a black matrix (including a rib for an ink jet), a spacer, and a protrusion for controlling liquid crystal orientation.

Since the member is manufactured by the method for manufacturing a laminate of the invention, a defect such as partial breaking (breaking defect) is suppressed to be little. When a rib (including a black matrix) for manufacturing a color filter is formed, color mixing generated when an ink is imparted by ink jet to a region surrounded by ribs can be prevented, and this is effective in manufacturing a color filter better in a color purity and a hue, consequently, a display device excellent in display property.

The color filter for a display device, the method for manufacturing a color filter, and the display device of the invention will be explained in detail below, but unless otherwise specified, the following explanation is common in the first embodiment and the second embodiment of the invention.

<Color Filter and Method for Manufacturing the Same>

The method for manufacturing a color filter of the invention, in the first embodiment of the invention, includes a step of forming the rib of the invention, and a step of forming a colored region between formed ribs (hereinafter, referred to as “colored region forming step” in some cases) and, in the second embodiment of the invention, includes a step of manufacturing a laminate by the method for manufacturing a laminate of the invention, and a step of imparting a coloring liquid composition by an ink jet method to form a colored region (hereinafter referred to as “colored region forming step” in some cases).

The “step of manufacturing a laminate” has a transferring step and, preferably, includes a transferring step, and a step of exposing a transferred coating layer to light in pattern-wise, and developing this to form a rib (hereinafter, referred to as “rib forming step” in some cases).

The step of manufacturing a laminate by the method for manufacturing a laminate of the invention is a “step of using a transfer material having a matting agent-containing layer on a side opposite to a side on which a coating layer of a provisional support is provided, and transferring the coating layer on the provisional support onto a support by setting tension of a value in the range of from 60 N/m to 200 N/m applied to the provisional support at a time of the transferring, and details are as described above.

In the method for manufacturing a color filter of the invention, after the rib of the invention is formed as described above, a coloring liquid composition (hereinafter, also referred to as ink) is imparted to between ribs held by ribs formed on a support, specifically, for example, when a matrix-like color filter is formed, to a concave region surrounded by ribs (preferably by an ink jet manner) to form a colored region (colored region forming step). The colored region constitutes an individual colored pixel such as red (R), green (G) and blue (B) when the color filter is formed.

The method for manufacturing a color filter of the invention preferably further has, in addition to the colored region forming step, a curing step of curing at least a formed colored region of one color by irradiation with an active energy ray, or a curing step of forming at least one or all of colored regions of a desired hue and, thereafter, curing this by heat.

—Colored Region Forming Step—

In the colored region forming step, a colored region is formed between formed ribs. It is preferable that this colored region is formed by a method of imparting a coloring liquid composition (ink) to between ribs by an ink jet method as described above. In this case, an ink jet ink for forming a colored pixel (e.g. RGB three color pixel pattern) is discharged and introduced into a concave part surrounded by ribs formed on a substrate, thereby, a color filter can be manufactured so that it is constructed of a plurality of colored pixels of two or more colors.

A pattern shape of the color filter is not particularly limited, and may be stripe-like, lattice-like, or delta arrangement-like which is general as a black matrix shape.

As an ink jet method, various methods such as a method of continuously ejecting a charged ink jet ink, and controlling this by an electric field, a method of intermittently ejecting an ink using a piezo element, and a method of heating an ink, and intermittently ejecting the ink utilizing foaming thereof can be adapted. Specifically, a method of discharging an ink using an ink jet head is preferable.

As the ink jet head (hereinafter, simply referred to as head), the known head can be applied and a continuous type, and a dot on demand type can be used.

Among the dot on demand type, in a thermal-type head, a type having an operation valve as described in JP-A No. 9-323420 is preferable from a viewpoint of discharge. In a piezo-type head, heads described in, for example, EP A277,703, and EP A278,590 can be used. Among them, the piezo head is more preferable since influence of heat on an ink jet ink can be reduced, and a usable solvent is widely selected.

It is preferable that an ejection temperature is set so that a viscosity at ejection is 5 to 30 mPa·s, and an ink temperature is controlled so that a variation width of a viscosity is within ±5%. The head is preferably operated at a driving frequency of 1 to 500 kHz.

A shape of a nozzle of the head is not necessarily required to be circle, and is not limited to an elliptical or rectangular shape. A nozzle diameter is preferably in the range of 10 to 100 μm. An opening itself of the nozzle is not necessarily true circle, but in that case, as a nozzle diameter, a diameter when a circle having an equivalent area to that of an opening is postulated is adopted.

Condition for ejecting an ink jet ink is not particularly limited, and ejection may be performed at room temperature. It is preferable that an ink is ejected by retaining an ink jet ink at 20 to 60° C., and retaining an ink viscosity constant, from a viewpoint of ejection stability. Since an organic ink jet ink has generally a higher viscosity than that of an aqueous ink, a viscosity variation width due to temperature variation is great. Since the viscosity variation greatly influences as it is on a liquid droplet size and a liquid droplet ejection rate, and easily causes image quality deterioration, it is important to retain an ink jet ink temperature constant as much as possible.

When a coloring liquid composition (ink) is imparted by an ink jet method, a permanent support having a rib may be arranged to be stationary, and an ink jet head may be moved parallel in a one-dimensional direction, or conversely, an ink jet head may be arranged to be stationary, and a permanent support may be moved parallel in a one-dimensional direction. Alternatively, an ink jet head may be moved parallel in a one-dimensional direction and, at the same time, a permanent support having a rib may be moved parallel in a one-dimensional direction approximately orthogonal to this direction.

The color filter in the invention is preferably constructed of the group (pixel group) consisting of at least three color colored regions (i.e. colored pixel) by blowing at least three color inks including RGB.

The coloring liquid composition (ink) in the invention contains at least a coloring agent, an organic solvent, a monomer and, if necessary, other component.

Regarding physical properties of an ink, a viscosity at 25° C. is preferably 10 to 100 mPa·s, and a surface tension at 25° C. is preferably 10 to 50 m N/m.

The ink used in the invention may be either oily or aqueous. A coloring material contained in the ink can be used together with a dye and a pigment, and it is preferable to use a pigment from a viewpoint of durability. In addition, a coloring ink of a coating format used in manufacturing the known color filter (e.g. coloring resin composition described in paragraphs [0034] to [0063] and [0076] to [0078] of JP-A No. 2005-3861), and a composition for an ink jet described in paragraphs [0009] to [0026] of JP-A No. 10-195358, JP-A No. 2004-339332, and JP-A No. 2002-372615 can be used.

In view of a step after formation of the colored region, a component which is cured by heating, or is cured with an energy ray such as ultraviolet ray may be added to the ink in the invention.

As the component which is cured by heating, various thermosetting resins are widely used. Examples of the component which is cured with an energy ray include an acrylate derivative and a methacrylate derivative to which a photoreaction initiator is added. Particularly, in view of heat resistance, a derivative having a plurality of acryloyl groups or methacryloyl groups in a molecule is more preferable. These acrylate derivative and methacrylate derivative which are water-soluble can be preferably used, and even those which are hardly water-soluble can be used by emulsification.

In the invention, after an ink is imparted (e.g. discharged) between ribs, a solvent contained in a liquid droplet is removed to leave a remaining ink, and the remaining ink is heated (so-called baking-treated), thereby, the remaining ink can be cured to form a colored layer. Herein, heating may be performed by one stage, or multiple stages.

Heating at one stage is to remove a solvent to leave a remaining ink, and then heat the ink at such a predetermined temperature that the ink is completely cured from beginning. Heating by multiple stages is to first initiate heating at a relatively low temperature, and thereafter, raise a heating temperature gradually, and heat at such a predetermined temperature that an ink is finally cured completely.

Examples of a method of heating include, but are not limited to, methods by heating with a hot plate, an electric furnace, or a dryer, or irradiation with an infrared ray.

Before this heating, a step of curing the remaining ink with an active energy ray may be provided.

A heating temperature and a heating time at heating depend only on a composition of an ink jet ink and a thickness of a colored region, but from a viewpoint of maintenance of a generally sufficient pixel strength, solvent resistance and alkali resistance, it is preferable that heating is performed at about 120° C. to about 250° C. for about 10 minutes to about 120 minutes.

In the invention, from a step of forming a colored region to a heating step of heating are performed preferably within 24 hours, more preferably within 12 hours, and further preferably within 6 hours. By initiating heating within the above time range without allowing to stand for a long time after formation of the colored region, aggregation of a pigment in the ink and precipitation of various binders can be prevented, and a colored region (i.e. colored pixel) better in the surface state can be formed.

As described above, for the purpose of improving durability, after the rib and the colored region (colored pixel) are formed to manufacture a color filter, an overcoating layer can be formed so as to cover a whole surface of the colored region and the rib.

The overcoating layer can protect the colored regions of R, G and B and ribs and, at the same time, can flatten a surface of the color filter. From a viewpoint that the number of steps is increased, it is preferable that the overcoating layer is not provided.

The overcoating layer can be constructed using a resin (OC agent). Examples of the resin (OC agent) include an acryl-based resin composition, an epoxy resin composition, and a polyimide resin composition. Inter alia, since transparency in a visible light region is excellent, a resin component of a coloring liquid composition (ink) has usually a main component of an acryl-based resin, and adherability is excellent, an acryl-based resin composition is desirable. Examples of the overcoating layer include overcoating layers described in paragraph numbers [0018] to [0028] of JP-A No. 2003-287618, and a commercially available product of the overcoating agent (trade name: Optomer SS6699G, manufactured by JSR).

The color filter of the invention is manufactured by the already-described method for manufacturing a color filter of the invention, and can be preferably applied to utility such as television, personal computer, liquid crystal projector, game machine, portable terminal of portable phone, digital camera, and car navigation, without any limitation. In the color filter of the invention, it is enough that the rib (e.g. rib functioning as a black matrix) is constructed of the aforementioned photosensitive transfer material of the invention, and can be constructed by forming an arbitrary color pixel such as red (R), green (G), blue (B), white (W), and violet (V).

<Display Device>

The display device of the invention is not particularly limited as long as it is provided with the aforementioned color filter of the invention. The display device of the invention includes, for example, display devices such as a liquid crystal display device, a plasma display device, an EL display device, and a CRT display device.

Definition of the display device and explanation of each display device are described in, for example, “Electronic Display Devices (Akio Sasaki, Kogyo Chosakai Publishing, Inc., published in 1990)”, and “Display Devices (Yoriaki Ibuki, Sangyo Tosho, published in 1989)”.

Inter alia, it is particularly preferable that the display device of the invention is a liquid crystal display device. The liquid crystal display device is described in, for example, “Next Generation Liquid Crystal Display Technology (edited by Tatsuo Uchida, Kogyo Chosakai Publishing, Inc., published in 1994)”. The liquid crystal display device is not particularly limited, and liquid crystal display devices of various formats described in, for example, the “Next Generation Liquid Crystal Display Technology” can be applied.

It is effective that the display device of the invention is constructed, particularly, into a liquid crystal display device of a color TFT format. The liquid crystal display device of a color TFT format is described in, for example, “Color TFT Liquid Crystal Display (Kyoritsu Shuppan Co., Ltd., published in 1996)”. Further, the display device of the invention can be also applied to a liquid crystal display device in which a field angle is expanded, of a horizontal electric field driving format such as IPS, and a pixel division format such as MVA. These formats are described in, for example, page 43 of “EL, PDP and LCD Display-Technology and Recent Trend in Market-(Toray Research Center Research Study Division, published in 2001)”.

The liquid crystal display device is constructed using various members such as an electrode substrate, a polarized film, a phase difference film, a back light, a spacer, and a field angle compensating film in addition to the color filter. These members are described in, for example, “94 Market of Liquid Crystal Display Peripheral Material-Chemicals (Kentaro Shima, CMC, published in 1994)”, and “2003 Current and Future Prospect of Liquid Crystal-Related Market (Second Volume) (Ryokichi Omote, Fuji Chimera Research Institute Inc., published in 2003)”.

In the display device of the invention, a variety of display modes such as ECB (Electrically Controlled Birefringence), TN (Twisted Nematic), IPS (In-Plane Switching), FLC (Ferroelectric Liquid Crystal), OCB (Optically Compensatory Bend), STN (Super Twisted Nematic), VA (Vertically Aligned), HAN (Hybrid Aligned Nematic), and GH (Guest Host) can be adopted.

Since the display device of the invention is provided with a color filter which suppresses color mixing and is better in a color purity and a hue by using the photosensitive transfer material of the invention as described above, it exhibits no display unevenness such as color unevenness when mounted on a television or a monitor, and can display an image having a wide color reproductivity region and a high contrast ratio. Alternatively, the display device of the invention is also preferable in a display device of a large screen such as a display for a notebook personal computer and a television monitor.

Specific means in the first embodiment of the second aspect of the invention are as follows:

<1> A photosensitive transfer material for forming a rib having at least a thermoplastic resin layer and a photosensitive resin layer in this order from a provisional support side, on the provisional support, wherein a melt viscosity η_{K} of the photosensitive resin layer at 100° C., and a melt viscosity η_{Cu} of the thermoplastic resin layer at 100° C. satisfy a relationship of η_{K}/η_{Cu}>2.

<2> The photosensitive transfer material of <1>, wherein the melt viscosity η_{K} satisfies the relationship 1000000 Pa·s>η_{K}>2000 Pa·s.

<3> The photosensitive transfer material of <1> or <2>, wherein the melt viscosity η_{Cu} satisfies the relationship 200 Pa·s<η_{Cu}<3000 Pa·s.

<4> The photosensitive transfer material of any one of <1> to <3>, wherein the photosensitive resin layer contains a pigment.

<5> The photosensitive transfer material of any one of <1> to <4>, wherein the thermoplastic resin layer contains a thermoplastic resin and a plasticizer.

<6> A method for forming a rib, comprising pressure-contacting the photosensitive transfer material of any one of <1> to <5> against a permanent support so that the photosensitive resin layer contacts the permanent support.

<7> The method for forming a rib of <6>, further comprising exposing at least the photosensitive resin layer to light after the pressure-contacting, and developing the layer.

<8> A rib formed by the method of forming a rib as defined in <6> or <7>.

<9> A method for manufacturing a color filter, comprising a step of forming a rib by the method for forming a rib as defined in <6> or <7>, and a step of forming a colored region between formed ribs.

<10> The method for manufacturing a color filter of <9>, wherein formation of the colored region is performed by a method of imparting a coloring liquid composition between the ribs by an ink jet method.

<11> A color filter manufactured by the method for manufacturing a color filter as defined in <9> or <10>.

<12> A display device provided with the color filter as defined in <11>.

Specific means in the second embodiment of the second aspect of the invention are as follows:

<13> A method for manufacturing a laminate, comprising a step of using a transfer material having a matting agent-containing layer on a side opposite to a side on which a coating layer of a provisional support is provided, and transferring the coating layer on the provisional support onto a support, having tension of a value in the range of from 60 N/m to 200 N/m applied to the provisional support at a time of the transferring.

<14> The method for manufacturing a laminate of <13>, wherein the matting agent has an average particle diameter of from 0.1 to 10.0 μm and, assuming an average particle diameter to be d, the number of matting agents having a particle diameter (D) in the range of 0.90 d to 1.1 d (0.90 d≦D≦1.1 d) is 70% or more of a total amount of the matting agents.

<15> The method for manufacturing a laminate of <13> or <14>, wherein the coating layer is a photopolymerizable black resin layer containing a black pigment.

<16> The method for manufacturing a laminate of <15>, wherein the black pigment is carbonaceous black.

<17> The method for manufacturing a laminate of <15> or <16>, wherein the photopolymerizable black resin layer has a thickness of from 1.0 to 3.0 μm, and an optical concentration of from 3 to 5.

<18> A member for a display device manufactured by the method for manufacturing a laminate as defined in any one of <13> to <17>.

<19> A method for manufacturing a color filter, comprising a step of using a transfer material having a matting agent-containing layer on a side opposite to a side on which a coating layer of a provisional support is provided, and transferring the coating layer on the provisional support onto a support, having tension of a value in the range of 60 N/m to 200 N/m applied to the provisional support at a time of the transferring; and a step of imparting a colored liquid composition by an ink jet method to form a colored region.

<20> The method for manufacturing a color filter of <19>, further comprising a step of exposing the transferred coating layer to light in pattern-wise, and developing this to form a rib, wherein formation of the colored region is performed by a method of imparting a coloring liquid composition between the ribs by an ink jet method.

<21> A color filter for a display device manufactured by the method for manufacturing a laminate as defined in any one of <13> to <17>, or the method for manufacturing a color filter of <19> or <20>.

<22> A display device provided with the member for a display device as defined in <18>, or the color filter for a display device as defined in <21>.

### EXAMPLES

The second aspect of the invention will be further specifically explained below by way of Examples. Materials, reagents, ratios, equipments, and operations shown in the following Examples can be appropriately changed as long as they are not apart from the scope of the invention. Therefore, the invention is not limited to the following Examples. In the following Examples, unless otherwise specified, “%” and “part” are both on a mass basis, and a molecular weight indicates a weight average molecular weight.

Examples related to the first embodiment of the second aspect of the invention will be shown below.

### Example 1

### Preparation of Deep Color Composition for Forming Rib

A K pigment dispersion 1, and propylene glycol monomethyl ether acetate at amounts described in the following Table 1 were weighed, mixed at a temperature of 24° C. (±2° C.) and stirred at 150 r.p.m. for 10 minutes, methyl ethyl ketone, cyclohexanone, binder 2, phenothiazine, DPHA solution, 2,4-bis(trichloromethyl)-6-[4′-(N,N-bisdiethoxycarbonylmethyl)amino-3′-bromophenyl]-s-triazine, and a surfactant 1 at amounts described in Table 1 were weighed while stirring, they were added in this order at a temperature of 25° C. (±2° C.), and stirred at a temperature of 40° C. (±2° C.) and 150 r.p.m. for 30 minutes to obtain a deep color composition K1.

Amounts described in the following Table 1 are expressed by part by mass, and details of each component are as described below.

<K pigment dispersion 1>

| | |
|---|---|
| Carbon black (trade name: Nipex35, manufactured by Degussa) | 13.1% |
| Dispersant (following Compound 1) | 0.65% |
| Polymer (random copolymer of benzyl methacrylate/methacrylic | 6.72% |
| acid = 72/28 mole ratio, molecular weight 37000) | |
| Propylene glycol monomethyl ether acetate | 79.53% |

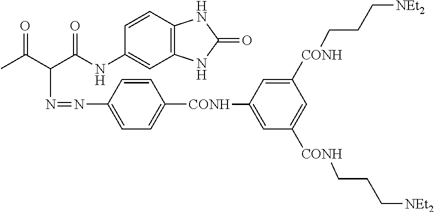

Compound 1

<B pigment dispersion 1>
Trade name: CF Blue EX3357, manufactured by Mikuni Color
<Binder 2>

| | |
|---|---|
| Polymer (random copolymer of benzyl methacrylate/methacrylic | 27% |
| acid = 78/22 mole ratio, molecular weight 38000) | |
| Propylene glycol monomethyl ether acetate | 73% |
| <Binder 3> | |
| Polymer | 27% |
| (Random copolymer of benzyl methacrylate/methacrylic | |
| acid/methyl methacrylate (=36/22/42 [mole ratio]), | |
| weight average molecular weight 38000) | |
| Propylene glycol monomethyl ether acetate | 73% |
| <DPHA solution> | |
| Dipentaerythritol hexaacrylate | 76% |
| (containing 500 ppm of polymerization inhibitor MEHQ, | |
| trade name: KAYARAD DPHA, manufactured by Nippon | |
| Kayaku Co., Ltd.) | |
| Propylene glycol monomethyl ether acetate | 24% |
| <Surfactant 1> | |
| Following structure 1 | 30% |
| Methyl ethyl ketone | 70% |

Structure 1

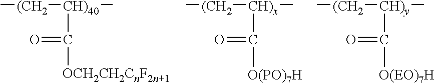

(n = 6, x = 55, y = 5, Mw = 33940, Mw/Mn = 2.55, PO: propylene oxide,
EO: ethylene oxide)

TABLE 1

| Deep color composition | K1 |
|---|---|
| K pigment dispersion 1 | 30 |
| B pigment dispersion 1 | 0.0 |
| Propylene glycol monomethyl ether acetate | 7.3 |
| Methyl ethyl ketone | 34 |
| Cyclohexanone | 8.6 |
| Binder 2 | 14 |
| DPHA solution | 5.8 |
| 2,4-bis(trichloromethyl)-6-[4′-(N,N- | 0.22 |
| bisethoxycarbonylmethyl)amino-3′-bromophenyl]-s- | |
| triazine | |
| Phenothiazine | 0.006 |
| Aforementioned surfactant 1 | 0.058 |

Unit: part

[Formation of Rib]

(Preparation of Photosensitive Transfer Material K1)

A coating solution for a thermoplastic resin layer according to the following formulation H1 was coated on a polyethylene terephthalate film provisional support (PET provisional support) of a thickness of 75 μm using a slit-like nozzle, and dried to form a thermoplastic resin layer. Then, a coating solution for an intermediate layer according to the following formulation P1 was further coated on the thermoplastic resin layer, and dried to form an intermediate layer (oxygen shielding membrane). The deep color composition K1 was further coated on this intermediate layer, and dried to form a photosensitive resin layer K1.

In this manner, the thermoplastic resin layer having a dry thickness of 14.6 μm, the intermediate layer having a dry thickness of 1.6 μm, and the photosensitive resin layer K1 having a dry thickness of 2.3 μm were laminated on the PET provisional support, and a protecting film (polypropylene film of thickness of 12 μm) was adhered to a surface of this photosensitive resin layer K1 under pressure.

In this manner, the photosensitive transfer material K1 in which the provisional support, the thermoplastic resin layer, the intermediate layer and the photosensitive resin layer K1 were incorporated, was manufactured.

Herein, a coating solution for a thermoplastic resin layer according to the following formulation H was coated on a separately prepared glass plate, and this was dried in an oven at 80° C. for 2 minutes to manufacture a dry membrane having a thickness of about 10 μm. Further, this was vacuum dried at a vacuum degree of about 15 mmHg at 40° C. for 6 hours, and a sample was peeled from the glass plate. When the sample was measured using a viscoelasticity measuring apparatus (trade name: DynAlyser DAS-100, manufactured by Jasco International Co., Ltd.) at a temperature of 100° C. and a frequency of 1 Hz, and a viscoelasticity was found to be 1800 Pa·s. Separately, the deep color composition K1 was coated on another glass plate, and this was dried in an oven at 80° C. for 2 minutes to manufacture a dry membrane having a thickness of about 10 μm. Further, this was vacuum-dried at a vacuum degree of about 15 mmHg at 40° C. for 6 hours, and a sample was peeled from the glass plate. The sample was measured at a temperature of 100° C. and a frequency of 1 Hz using a viscoelasticity measuring apparatus (trade name: DynAlyser DAS-100, manufactured by Jasco International Co., Ltd.), and a viscoelasticity was found to be 3800 Pa·s. In all cases, a rotor having a diameter of 20 mm was used, and a viscoelasticity was measured at a sample thickness of 1.5 mm.

Therefore, a ratio η_{K}/η_{Cu} of a melt viscosity in the photosensitive transfer material K1 was 2.1.

<Coating solution for thermoplastic resin layer: formulation H1>

| | | |
|---|---|---|
| Methanol | 11.1 | parts |
| Propylene glycol monomethyl ether acetate | 6.36 | parts |
| Methyl ethyl ketone | 52.4 | parts |
| Methyl methacrylate/2-ethylhexyl acrylate/benzyl | 6.80 | parts |
| methacrylate/methacrylic acid copolymer | | |
| (copolymerization compositional ratio | | |
| (mole ratio) = 55/11.7/4.5/28.8, molecular | | |
| weight = 100000, Tg = 70° C.) | | |
| Styrene/acrylic acid copolymer (copolymerization | 10.2 | parts |
| compositional ratio (mole ratio) = 63/37, | | |
| average molecular weight = 10000, Tg = 100° C.) | | |
| 2,2-bis[4-(methacryloxypolyethoxy)phenyl]propane | 9.1 | parts |
| (manufactured by Shin-Nakamura | | |
| Chemical Co., Ltd.) | | |
| Aforementioned surfactant 1 | 0.54 | part |

<Coating solution for intermediate layer: formulation P1>

| | | |
|---|---|---|
| PVA205 | 32.2 | parts |
| (Polyvinyl alcohol, manufactured by Kuraray Co., | | |
| Ltd., saponification degree = 88%, | | |
| polymerization degree 550) | | |
| Polyvinyl pyrrolidone (trade name: K-30, | 14.9 | parts |
| manufactured by ISP Japan) | | |
| Distilled water | 524 | parts |
| Methanol | 429 | parts |

Then, an alkaliless glass substrate (hereinafter, simply also referred to as “glass substrate”) was washed with a rotation brush having a nylon fur while a glass cleaning solution adjusted at 25° C. was blown with a shower for 20 seconds, and was further shower-washed with pure water. Thereafter, a silane coupling solution (0.3 mass % aqueous solution of N-β(amino ethyl)γ-aminopropyltrimethoxysilane, trade name: KBM603, manufactured by Shin-Etsu Chemical Co., Ltd.) was blown with a shower for 20 seconds, and shower-washed with pure water. This substrate was heated with a substrate pre-heating device at 100° C. for 2 minutes.

On the resulting silane coupling-treated glass substrate, a photosensitive resin layer K1 obtained by removing a protecting film from the above-obtained photosensitive transfer material K1, and exposed after removal was overlaid so that a surface thereof came in contact with a surface of the silane coupling-treated glass substrate, and lamination was performed using a large scale twin application laminator described in FIG. 24 of WO 2006-4225. Thereupon, details of the laminator are as follows.

TABLE 2

| No | Item | Specification |
|---|---|---|
| 1 | Facility performance | |
| | Lamination rate | 2.5 m/min in present Example |
| | Lamination tension | 120 N/m in present Example |
| 2 | Substrate heating part | |
| | Substrate heating | 120° C. in present Example |
| 3 | Raw material part | |
| | Width | 1250 mm in present Example |
| | Length | 1000 m in present Example |
| 4 | Lamination part | |
| | Lamination roll specification | φ110 × 2650 L (effective length |
| | | 2500 L) rubber roll |
| | Lamination pressure (linear | 120 N/cm in present Example |
| | pressure) | |
| | Lamination roll temperature | Upper lamination roll 95° C., lower |
| | | lamination roll 120° C. in present |
| | | Example |

Subsequently, the PET provisional support was peeled at an interface with the thermoplastic resin layer to remove the provisional support. After the provisional support was peeled, pattern light exposure was performed at a light exposure amount of 100 mJ/cm² with a mirror projection-type light exposing machine (trade name: MPA-8800CF, manufactured by Canon Inc.).

Then, shower development was performed with a triethanolamine-based developer (containing 30% triethanolamine, solution obtained by 12-fold diluting trade name: T-PD2, manufactured by Fuji Photo Film Co., Ltd. with pure water (mixing at a ratio of 1 part of T-PD2 and 11 parts of pure water)) at 30° C. for 50 seconds under a flat nozzle pressure of 0.04 MPa, and the thermoplastic resin layer and the intermediate layer were removed. Subsequently, the air was blown on an upper side of this glass substrate to remove a liquid, pure water was blown by shower for 10 seconds to perform washing with pure water shower, and the air was blown to reduce a stagnant liquid on the substrate.

Subsequently, using a sodium carbonate-based developer (containing 0.38 mole/liter sodium bicarbonate, 0.47 mole/liter sodium carbonate, 5% sodium dibutylnaphthalene sulfonate, anionic surfactant, antifoaming agent, and stabilizer; solution obtained by 5-fold diluting trade name: T-CD1, manufactured by Fuji Photo Film Co., Ltd. with pure water), shower development was performed at 29° C. for 30 seconds at a cone-type nozzle pressure of 0.15 MPa to develop the photosensitive resin layer K1 to obtain a pattern image.

Subsequently, a solution obtained by 10-fold diluting a cleaning agent (containing phosphate, silicate, nonionic surfactant, antifoaming agent and stabilizer; trade name: T-SD1, manufactured by Fuji Photo Film Co., Ltd.) with pure water was shower-blown at 33° C. for 20 seconds at a cone-type nozzle pressure of 0.02 MPa, and a formed pattern image was rubbed with a rotation brush having a nylon fur to remove the residue, to obtain a desired rib pattern.

Thereafter, post light exposure was performed on the glass substrate on which the rib pattern was formed, from both sides with a light exposing machine manufactured by Ushio Inc., having a metal halide lamp at a light exposure amount of 3000 mJ/cm², and this was heat-treated at 220° C. for 20 minutes to obtain a stripe-like rib having an optical concentration of 4.0, a thickness of 2.0 μm, and an opening of a width of 100 μm.

[Repulsion Inking Plasma Treatment]

The glass substrate on which the rib was formed was subjected to repulsion inking plasma treatment using a cathode coupling-format parallel plate-type plasma treatment apparatus under the following condition.

(Condition)
Gas used: CF₄
Gas flow rate: 80 sccm
Pressure: 40 Pa
RF power: 50 W
Treatment time: 30 sec

[Preparation of Coloring Liquid Composition]

Among the following components, first, the pigment, the polymer dispersant and the solvent were mixed using a three-roll and a beads mill to obtain a pigment dispersion. While the pigment dispersion was sufficiently stirred with a dissolver, other materials were added in portions to prepare a coloring liquid composition for a red (R) pixel (ink R).

<Composition of coloring liquid composition for red pixel>

| | | |
|---|---|---|
| Pigment (C.I.Pigment Red 254) | 5 | parts |
| Pigment dispersant (trade name: Solsperse 24000, | 1 | part |
| manufactured by AVECIA) | | |
| Binder | 3 | parts |
| (Random copolymer of benzyl methacrylate/methacrylic | | |
| acid (=72/28 [mole ratio]), weight | | |
| average molecular weight 37000) | | |
| First epoxy resin | 2 | parts |
| (Novolak-type epoxy resin, trade name: Epicoat154, | | |
| manufactured by Yuka Shell) | | |
| Second epoxy resin (neopentyl glycol diglycidyl ether) | 5 | parts |
| Curing agent (trimellitic acid) | 4 | parts |
| Solvent: ethyl 3-ethoxypropyonate | 80 | parts |

A coloring liquid composition for a green (G) pixel (ink G) was prepared according to the same manner as that of the coloring liquid composition for a red pixel except that C.I. Pigment Red 254 in the aforementioned composition was changed to the same amount of C.I. Pigment Green 36.

In addition, a coloring liquid composition for a blue (B) pixel (ink B) was prepared according to the same manner as that of the coloring liquid composition for a red pixel except that C.I. Pigment Red 254 in the aforementioned composition was changed to the same amount of C.I. Pigment Blue 15:6.

[Formation of Pixel by Ink Jet Method]

Using an ink jet head (trade name: SE-128, manufactured by Dimatix), and a discharge controlling device (trade name: ApolloII, manufactured by Dimatix), an ink was ejected in the following mode.

The ink jet head was mounted on an automatic two-dimensional moving stage (trade name: KS211-200, manufactured by Suruga Seiki Co., Ltd.), and discharge from a head by the discharge controlling device was synchronized while the stage was moved so as to discharge a predetermined ink amount to a concave part surrounded by ribs of the glass substrate with ribs formed thereon. Herein, inks of three colors of an ink R, an ink G, and an ink B were charged into separate heads, each head was fixed on an XY stage, and three heads were independently controlled with the discharge controlling device so that each ink reached a predetermined position.

For ejection, an ink of each color was discharged to a desired concentration, after completion of discharge, this was heated and dried with a hot plate at 100° C. for 2 minutes, and baking-treated in an oven at 230° C. for 30 minutes, thereby, a color filter in which both of ribs and colored pixels (R pixel, G pixel and B pixel) were cured better, was manufactured (hereinafter, this is referred to as “color filter substrate”).

—Evaluation of Color Filter—

An extent of color mixing on the resulting color filter substrate was evaluated by the following method.

The color filter was observed using an optical microscope and, regarding 3000 pixels arbitrarily selected from the color filter, the presence or absence of occurrence of ink color mixing were observed, followed by evaluation according to the following evaluation criteria. Results are shown in the following Table 5. Practically acceptable ranks are A rank, B rank, and C rank.

<Evaluation Criteria>

A rank: No color mixing was recognized.

B rank: One to two places of color mixing were recognized.

C rank: Three to four places of color mixing were recognized.

D rank: Five to ten places of color mixing were recognized.

E rank: Eleven or more places of color mixing were recognized.

[Manufacturing of Display Device]

An ITO (Indium Tin Oxide) transparent electrode was further formed on the R pixel, the G pixel and the B pixel as well as ribs on the above-obtained color filter substrate by sputtering. Separately, a glass substrate as a counter-substrate was prepared, and an ITO transparent electrode was similarly formed thereon by sputtering. Then, a photospacer was provided on a part corresponding to an upper part of the rib on the ITO transparent electrode, and an orientation membrane consisting of polyimide was further provided thereon.

—Formation of Protrusion for Liquid Crystal Orientation Division—

A coating solution for a photosensitive resin layer for protrusion according to the following formulation A was coated on the ITO transparent electrode on the color filter with the same slit coater as that described above, and dried to form to a photosensitive resin layer for protrusion.

Then, using a coating solution for an intermediate layer according to the above formulation P, a protecting layer having a dry thickness of 1.6 μm was provided on the photosensitive resin layer for protrusion.

<Coating solution for photosensitive resin layer for protrusion:
Formulation A>

| | | |
|---|---|---|
| Positive-type resist solution | 53.3 | parts |
| (trade name: FH-2413F, manufactured by Fuji Film | | |
| Electronic Materials Co., Ltd.) | | |
| Methyl ethyl ketone | 46.7 | parts |
| Aforementioned surfactant 1 | 0.04 | part |

Then, a proximity light exposing machine was arranged so that a position of a photomask was situated at a distance of 100 μm from a surface of the photosensitive resin layer for protrusion, and proximity light exposure was performed with an ultrahigh mercury lamp via the photomask at an irradiation energy of 150 mJ/cm². Thereafter, this was developed while a 2.38% aqueous tetramethyl ammonium hydroxide solution was sprayed to the photosensitive resin layer for protrusion with a shower-type developing device at 33° C. for 30 seconds, to develop and remove an unnecessary part (exposed part) of the photosensitive resin layer for protrusion. Thereby, protrusion patterned in a desired shape was formed at parts situated above the R pixel, the G pixel and the B pixel on the ITO transparent electrode of the color filter. Then, by baking-treating the color filter substrate with this protrusion formed thereon at 240° C. for 50 minutes, protrusion for orientation division having a height of 1.5 μm, and a longitudinal cross-sectional shape (shape of a plane parallel with a normal line direction of a glass substrate surface) of kamaboko (barrel-vaulted shape) was formed on the color filter substrate.

Thereafter, a sealing agent of an ultraviolet curing resin was coated on a position corresponding to a rib external frame provided so as to surround a periphery of a pixel group of the color filter by a dispenser format, this was adhered with a counter-substrate by adding a liquid crystal for MVA mode dropwise, and the adhered substrate was UV-irradiated and heat-treated to cure the sealing agent. Thereby, a liquid crystal cell was obtained. A polarizing plate (trade name: HLC2-2518, manufactured by Sanritz Corporation) was adhered to both sides of this liquid crystal cell and, then, back light of a cold cathode tube was constructed, which was arranged on a side which is a rear surface of the liquid crystal cell with the polarizing plate provided thereon, to obtain a liquid crystal display device.

—Evaluation of Display Device—

Electricity was passed through the display device, and a display image was visually observed and evaluated according to the following evaluation criteria. Results are shown in the following Table 5.

<Evaluation Criteria>

Normal: Display unevenness such as color unevenness was not recognized.

Unevenness: Color unevenness was recognized.

### Examples 2 to 13, Comparative Examples 1 to 2

A color filter and a liquid crystal display device were manufactured, a viscosity was measured, and color mixing was evaluated according to the same manner as that of Example 1 except that a composition of the deep color composition K1, and a composition of the coating solution for a thermoplastic resin layer (Formulation H1) were changed, respectively, as shown in the following Tables 3 and 4. Results of measurement and evaluation are shown in the following Table 5.

TABLE 3
<Deep color composition>

| | Example 1 | Example 2 | Example 3 | Example 4 | Example 5 | Example 6 | Example 7 | Example 8 | Example 9 |
|---|---|---|---|---|---|---|---|---|---|
| K pigment | 30.0 | 30.0 | 37.0 | 34.0 | 29.5 | 30.0 | 30.0 | 29.5 | 29.5 |
| dispersion 1 | | | | | | | | | |
| B pigment | 0.0 | 0.0 | 0.0 | 6.0 | 9.0 | 0.0 | 0.0 | 9.0 | 9.0 |
| dispersion 1 | | | | | | | | | |
| Propylene glycol | 7.3 | 7.3 | 7.3 | 7.3 | 7.3 | 7.3 | 7.3 | 7.3 | 7.3 |
| monomethyl ether | | | | | | | | | |
| acetate | | | | | | | | | |
| Methyl ethyl | 34 | 34 | 34 | 34 | 34 | 34 | 34 | 34 | 34 |
| ketone | | | | | | | | | |
| Cyclohexanone | 8.6 | 8.6 | 8.6 | 8.6 | 8.6 | 8.6 | 8.6 | 8.6 | 8.6 |
| Binder-2 | 14.7 | 16.0 | 10.0 | 13.0 | 9.0 | 0.0 | 0.0 | 9.0 | 9.0 |
| Binder-3 | 0.0 | 0.0 | 0.0 | 0.0 | 0.0 | 14.0 | 14.7 | 0.0 | 0.0 |
| DPHA solution | 5.5 | 5.0 | 5.2 | 5.8 | 4.4 | 5.8 | 5.5 | 4.4 | 4.4 |
| 2,4- | 0.22 | 0.22 | 0.22 | 0.22 | 0.22 | 0.22 | 0.22 | 0.22 | 0.22 |
| bis(trichloromethyl)- | | | | | | | | | |
| 6-[4′-(N,N- | | | | | | | | | |
| diethoxycarbonyl | | | | | | | | | |
| methyl)amino-3′- | | | | | | | | | |
| bromophenyl]-s- | | | | | | | | | |
| triazine | | | | | | | | | |
| Phenothiazine | 0.006 | 0.006 | 0.006 | 0.006 | 0.006 | 0.006 | 0.006 | 0.006 | 0.006 |
| Surfactant 1 | 0.058 | 0.058 | 0.058 | 0.058 | 0.058 | 0.058 | 0.058 | 0.058 | 0.058 |

| | Example | Example | Example | Example | Example | Comparative | Comparative |
|---|---|---|---|---|---|---|---|
| | 10 | 11 | 12 | 13 | 14 | Example 1 | Example 2 |
| K pigment | 30.0 | 30.0 | 30.0 | 30.0 | 30.0 | 30.0 | 30.0 |
| dispersion 1 | | | | | | | |
| B pigment | 0.0 | 0.0 | 0.0 | 0.0 | 0.0 | 0.0 | 0.0 |
| dispersion 1 | | | | | | | |
| Propylene glycol | 7.3 | 7.3 | 7.3 | 7.3 | 7.3 | 7.3 | 7.3 |
| monomethyl ether | | | | | | | |
| acetate | | | | | | | |
| Methyl ethyl | 34 | 34 | 34 | 34 | 34 | 34 | 34 |
| ketone | | | | | | | |
| Cyclohexanone | 8.6 | 8.6 | 8.6 | 8.6 | 8.6 | 8.6 | 8.6 |
| Binder-2 | 14.0 | 14.0 | 14.0 | 13.6 | 0.0 | 14.0 | 14.7 |
| Binder-3 | 0.0 | 0.0 | 0.0 | 0.0 | 14.7 | 0.0 | 0.0 |
| DPHA solution | 5.8 | 5.8 | 5.8 | 6.0 | 5.5 | 5.8 | 5.5 |
| 2,4- | 0.22 | 0.22 | 0.22 | 0.22 | 0.22 | 0.22 | 0.22 |
| bis(trichloromethyl)- | | | | | | | |
| 6-[4′-(N,N- | | | | | | | |
| diethoxycarbonyl | | | | | | | |
| methyl)amino-3′- | | | | | | | |
| bromophenyl]-s- | | | | | | | |
| triazine | | | | | | | |
| Phenothiazine | 0.006 | 0.006 | 0.006 | 0.006 | 0.006 | 0.006 | 0.006 |
| Surfactant 1 | 0.058 | 0.058 | 0.058 | 0.058 | 0.058 | 0.058 | 0.058 |

TABLE 4
<Coating solution for thermoplastic resin layer>

| | Example 1 | Example 2 | Example 3 | Example 4 | Example 5 | Example 6 | Example 7 | Example 8 | Example 9 |
|---|---|---|---|---|---|---|---|---|---|
| Methanol | 11.1 | 11.1 | 11.1 | 11.1 | 11.1 | 11.1 | 11.1 | 11.1 | 11.1 |
| Propylene glycol | 6.4 | 6.4 | 6.4 | 6.4 | 6.4 | 6.4 | 6.4 | 6.4 | 6.4 |
| monomethyl ether | | | | | | | | | |
| acetate | | | | | | | | | |
| Methyl ethyl ketone | 52.4 | 52.4 | 52.4 | 52.4 | 52.4 | 52.4 | 52.4 | 52.4 | 52.4 |
| Methyl | 6.80 | 6.80 | 6.80 | 6.80 | 6.80 | 6.80 | 6.80 | 4.70 | 8.10 |
| methacrylate/2- | | | | | | | | | |
| ethylhexyl | | | | | | | | | |
| acrylate/benzyl | | | | | | | | | |
| methacrylate/methacrylic | | | | | | | | | |
| acid copolymer | | | | | | | | | |
| (Copolymerization | | | | | | | | | |
| compositional ratio | | | | | | | | | |
| (mole | | | | | | | | | |
| ratio) = 55/11.7/4.5/28.8, | | | | | | | | | |
| molecular | | | | | | | | | |
| weight = 100000) | | | | | | | | | |
| Styrene/acrylic acid | 10.2 | 10.2 | 10.2 | 10.2 | 10.2 | 10.2 | 10.2 | 10.8 | 9.9 |
| copolymer | | | | | | | | | |
| (Copolymerization | | | | | | | | | |
| compositional ratio | | | | | | | | | |
| (mole ratio) = 63/37, | | | | | | | | | |
| average molecular | | | | | | | | | |
| weight = 10000) | | | | | | | | | |
| 2,2-bis[4- | 9.1 | 9.1 | 9.1 | 9.1 | 9.1 | 9.1 | 9.1 | 9.1 | 9.1 |
| (methacryloxypoly- | | | | | | | | | |
| ethoxy)phenyl]propane | | | | | | | | | |
| (manufactured by | | | | | | | | | |
| Shin-Nakamura | | | | | | | | | |
| Chemical Co., Ltd) | | | | | | | | | |
| Surfactant 1 | 0.54 | 0.54 | 0.54 | 0.54 | 0.54 | 0.54 | 0.54 | 0.54 | 0.54 |

| | Example | Example | Example | Example | Example | Comparative | Comparative |
|---|---|---|---|---|---|---|---|
| | 10 | 11 | 12 | 13 | 14 | Example 1 | Example 2 |
| Methanol | 11.1 | 11.1 | 11.1 | 11.1 | 11.1 | 11.1 | 11.1 |
| Propylene glycol | 6.4 | 6.4 | 6.4 | 6.4 | 6.4 | 6.4 | 6.4 |
| monomethyl ether | | | | | | | |
| acetate | | | | | | | |
| Methyl ethyl ketone | 52.4 | 52.4 | 52.4 | 52.4 | 52.4 | 52.4 | 52.4 |
| Methyl | 6.00 | 5.10 | 4.70 | 4.70 | 6.80 | 7.20 | 7.20 |
| methacrylate/2- | | | | | | | |
| ethylhexyl | | | | | | | |
| acrylate/benzyl | | | | | | | |
| methacrylate/methacrylic | | | | | | | |
| acid copolymer | | | | | | | |
| (Copolymerization | | | | | | | |
| compositional ratio | | | | | | | |
| (mole | | | | | | | |
| ratio) = 55/11.7/4.5/28.8, | | | | | | | |
| molecular | | | | | | | |
| weight = 100000) | | | | | | | |
| Styrene/acrylic acid | 9.0 | 11.9 | 10.8 | 10.8 | 10.2 | 10.8 | 10.8 |
| copolymer | | | | | | | |
| (Copolymerization | | | | | | | |
| compositional ratio | | | | | | | |
| (mole ratio) = 63/37, | | | | | | | |
| average molecular | | | | | | | |
| weight = 10000) | | | | | | | |
| 2,2-bis[4- | 9.1 | 9.1 | 9.1 | 9.1 | 9.1 | 9.1 | 9.1 |
| (methacryloxypoly- | | | | | | | |
| ethoxy)phenyl]propane | | | | | | | |
| (manufactured by | | | | | | | |
| Shin-Nakamura | | | | | | | |
| Chemical Co., Ltd) | | | | | | | |
| Surfactant 1 | 0.54 | 0.54 | 0.54 | 0.54 | 0.54 | 0.54 | 0.54 |

### Example 14

A color filter and a liquid crystal display device were manufactured, a viscosity was measured, and color mixing was evaluated according to the same manner as that of Example 7 except that a temperature of the upper lamination roll (roller contacting with provisional support) of the laminator was changed to 120° C., and a temperature of a lower lamination roll (roller contacting with substrate) was changed to 120° C. in Example 7. Results of measurement and evaluation are shown in the following Table 5.

TABLE 5

| | η_{K} | η_{CU} | | | Display |
|---|---|---|---|---|---|
| | [Pa · s] | [Pa · s] | η_{K}/η_{CU} | Color mixing | device |
| Example 1 | 3800 | 1800 | 2.1 | C | Normal |
| Example 2 | 10000 | 1800 | 5.6 | A | Normal |
| Example 3 | 7500 | 1800 | 4.2 | B | Normal |
| Example 4 | 4500 | 1800 | 2.5 | B | Normal |
| Example 5 | 18000 | 1800 | 10 | A | Normal |
| Example 6 | 3800 | 1800 | 2.1 | C | Normal |
| Example 7 | 8000 | 1800 | 4.4 | B | Normal |
| Example 8 | 18000 | 600 | 30 | A | Normal |
| Example 9 | 18000 | 3000 | 6.0 | A | Normal |
| Example 10 | 2200 | 800 | 2.8 | C | Normal |
| Example 11 | 2200 | 1000 | 2.2 | C | Normal |
| Example 12 | 2200 | 600 | 3.7 | C | Normal |
| Example 13 | 1800 | 600 | 3.0 | C | Normal |
| Example 14 | 8000 | 1800 | 4.4 | B | Normal |
| Comparative | 2200 | 2300 | 0.96 | E | Unevenness |
| Example 1 | | | | | |
| Comparative | 3800 | 2300 | 1.7 | D | Unevenness |
| Example 2 | | | | | |

As shown in the Table 5, in Examples, occurrence of color mixing was suppressed, and a displayed image was a normal image having no color unevenness. To the contrary, in Comparative Examples, color mixing occurred, and color unevenness occurred in a displayed image.

Examples according to the second embodiment of the second aspect of the invention will be shown below.

### Examples 15 to 25, Comparative Examples 3 to 5

### Manufacturing of Photosensitive Resin Transfer Material

—Matting Agent-Containing Layer

After biaxial stretching, and thermal fixation at 240° C. for 10 minutes, a polyethylene terephthalate film having a thickness of 75 μm which had been subjected to corona discharge treatment was prepared as a provisional support and, on one side thereof, the following coating solution 1 for a matting agent-containing layer was coated using a slit-like nozzle, and this was dried at 130° C. for 2 minutes to form a matting agent-containing layer having a thickness of 0.08 μm.

<Formation of coating solution 1 for matting agent-containing layer>

| Aqueous acryl resin dispersion | 30.9 | parts |
|---|---|---|
| (trade name: Julymer ET-410, manufactured by Nihon Junyaku Co., Ltd, number average | | |
| molecular weight 9700, weight average molecular weight 17000, solid matter concentration | | |
| 30%) | | |
| Aqueous carbodiimide crosslinking agent solution | 6.4 | parts |
| (trade name: Carbodilite V-02-L2, manufactured by NISSHINBO INDUSTRIES, INC., solid | | |
| matter concentration 40%) | | |
| Matting agent | (amount in the following Table 7) | |
| *Seahoster KE-W30 (Examples 15 to 24, Comparative Examples 3 to 5; silica fine | | |
| particle manufactured by Nippon Shokubai Co., Ltd., solid matter 20%, average particle | | |
| diameter 0.3 μm, the number of matting agents having a particle diameter of 0.90d ≦ D ≦ 1.1d: | | |
| 95% [based on total amount of matting agents]) | | |
| *Seahoster KE-W50 (Example 25; silica fine particle manufactured by Nippon | | |
| Shokubai Co., Ltd., solid matter 20%, average particle diameter 0.5 μm, the number of | | |
| matting agents having a particle diameter of 0.90d ≦ D ≦ 1.1d: 95% [based on total amount of | | |
| matting agents]) | | |
| Surfactant 2 | 0.73 | part |
| (trade name: Narrow Acty HN-100, manufactured by Sanyo Chemical Industries, Ltd. | | |
| Surfactant 3 | 1.44 | parts |
| (trade name: Sandet BL, manufactured by Sanyo Chemical Industries, Ltd., solid matter | | |
| concentration 43%) | | |
| Metal oxide dispersion | 131 | parts |
| (trade name: FS-10D, manufactured by Ishihara Sangyo Kaisha, Ltd., solid matter | | |
| concentration 20%) | | |
| Distilled water | (added to a total amount of 1000 | parts) |

—Protecting Layer for Protecting Matting Agent-Containing Layer—

Then, the following coating solution 1 for forming a protecting layer for protecting a matting agent-containing layer was coated on a matting agent-containing layer, and this was dried at 130° C. for 2 minutes to form a protecting layer having a thickness of 0.05 μm.

<Formulation of coating solution 1 for forming protecting layer
for protecting matting agent-containing layer>

| | | |
|---|---|---|
| Polyethylene latex | 17.8 | parts |
| (trade name: Chemipearl S120, | | |
| manufactured by Mitsui Chemicals, | | |
| Inc., solid matter concentration 27%) | | |
| Colloidal silica | 11.8 | parts |
| (trade name: Snowtex C, manufactured | | |
| by Nissan Chemical Industries, | | |
| Ltd., solid matter | | |
| concentration 20%) | | |
| Epoxy curing agent | 1.7 | parts |
| (trade name: Denacol EX-614B, | | |
| manufactured by | | |
| Nagase Chemicals Ltd.) | | |
| Aforementioned surfactant 2 | 0.52 | part |
| Aforementioned surfactant 3 | 0.59 | part |
| Distilled water | (added to a total | |
| | amount of 1000 | parts) |

—Thermoplastic Resin Layer/Intermediate Layer—

Then, a coating solution for a thermoplastic resin layer according to the formulation H1 was coated on a side opposite to a side on which the matting agent-containing layer of the provisional support was formed using a slit-like nozzle, and this was dried to form a thermoplastic resin layer.

Subsequently, a coating solution for an intermediate layer according to the aforementioned formulation P1 was further coated on this thermoplastic resin layer, and this was dried to laminate an intermediate layer (oxygen shielding membrane).

—Photosensitive Resin Layer—

Subsequently, a deep color composition K1 was prepared by the same method as that described above. Details of each component are described above.

The resulting deep color composition K1 was further coated on the intermediate layer, and this was dried to form a photosensitive resin layer K1′.

In this manner, on a side on which the matting agent-containing layer of the PET provisional support was not formed, the thermoplastic resin layer having a dry thickness of 14.6 μm, the intermediate layer having a dry thickness of 1.6 μm, and the photosensitive resin layer K1 having a dry thickness of 2.3 μm (optical concentration 4.0) were laminated to adhere a protecting film (polypropylene film having a thickness of 12 μm) to a surface of this photosensitive resin layer K1′.

In this manner, the photosensitive transfer material K1′ which had the matting agent-containing layer on one side of the provisional support, and had the thermoplastic resin layer, the intermediate layer and the photosensitive resin layer K1′ on the other side and was integrally constructed, was manufactured.

[Formation of Rib]

Then, an alkaliless glass substrate (hereinafter, simply also referred to as “glass substrate”) tilted at 7° (hereinafter, also in substrate washing and development steps, substrate was treated similarly by tilting) was washed with a rotation brush having a nylon fur while a glass cleaning agent solution (obtained by 10-fold diluting trade name: T-SD3, manufactured by Fuji Photo Film Co., Ltd., with pure water) adjusted at 25° C. was blown with shower for 20 seconds, and was further shower-washed with pure water. Thereafter, a silane coupling solution (0.3 mass % aqueous solution of N-β(aminoethyl)γ-aminopropyltrimethoxysilane, trade name: KBM603, manufactured by Shin-Etsu Chemical Co., Ltd.) was blown with shower for 20 seconds, and this was shower-washed with pure water for 5 seconds. Then, the air was blown with an air knife to remove a stagnant liquid and liquid droplets on the substrate. This substrate was heated with a substrate pre-heating device at a temperature described in the following Table 6 for 2 minutes to obtain a silane coupling-treated glass substrate.

On the resulting silane coupling-treated glass substrate, the photosensitive resin layer K1′ obtained by removing a protecting film from the above-obtained photosensitive transfer material K1′, and exposed after removal was overlaid so that a surface thereof came in contact with a surface of the silane coupling-treated glass substrate, and this was laminated using a large scale twin application laminator described in FIG. 24 of WO2006-4225. Thereafter, this substrate was cooled with a cold air for 2 minutes, and was returned to a temperature near room temperature. Details of the laminator are as follows.

A tension was measured by setting as in actual lamination except that setting of the laminator was not nipped, pulling out a provisional support of the transfer material from between lamination rolls in the same direction as that of conveyance of the transfer material, holding an end part of the provisional support constituting the transfer material with hard frame materials, and measuring a tension while a center of the frame materials was pulled with a force gauge parallel with the conveyance direction as shown in FIGS. 24 and 25.

TABLE 6

| No | Item | Manufacturing specification |
|---|---|---|
| 1 | Facility performance | |
| | Lamination rate | 2.5 m/min in present Example |
| 2 | Substrate heating part | |
| | Substrate heating | 120° C. in present Example |
| 3 | Raw material part | |
| | Width | 1250 mm in present Example |
| | Length | 1000 m in present Example |
| 4 | Lamination part | |
| | Lamination roll specification | φ110 × 2650 L (effective length |
| | | 2500 L) rubber roll |
| | Lamination pressure (linear | 120 N/cm in present Example |
| | pressure) | |
| | Lamination roll temperature | Upper lamination roll 95° C., |
| | | and lower lamination roll 120° C. in |
| | | present Example |

Subsequently, the PET provisional support was peeled at an interface with the thermoplastic resin layer to remove the provisional support. After the provisional support was peeled, pattern light exposure was performed with a mirror projection-type light exposing machine (trade name: MPA-8800CF, manufactured by Canon Inc.) at a light exposure amount of 100 mJ/cm².

Then, shower development was performed with a triethanolamine-based developer (containing 30% triethanolamine, solution obtained by 12-fold diluting trade name: T-PD2, manufactured by Fuji Photo Film Co., Ltd. with pure water (mixing at a ratio of 1 part of T-PD2 and 11 parts of pure water)) at 30° C. for 50 seconds at a flat nozzle (swung) pressure of 0.04 MPa, to remove the thermoplastic resin layer and the intermediate layer.

Subsequently, the air was blown on an upper side of this glass substrate to remove a liquid, and pure water was blown with an aquaknife. Then, pure water was blown with shower for 10 seconds, this was shower-washed with pure water, and the air was blown with an air knife to reduce a stagnant liquid on the substrate.

Subsequently, using a sodium carbonate-based developer (containing 0.38 mole/liter sodium bicarbonate, 0.47 mole/liter sodium carbonate, 5% sodium dibutylnaphthalenesulfonate, anionic surfactant, antifoaming agent, and stabilizer; solution obtained by 5-fold diluting trade name: T-CD1, manufactured by Fuji Photo Film Co., Ltd.) with pure water, shower development was performed at 29° C. for 30 seconds at a cone-type nozzle (swung) pressure of 0.15 MPa to develop the photosensitive resin layer K1, to obtain a pattern image.

Subsequently, the air was blown on an upper side of this glass substrate to remove a liquid, and pure water was blown with an aquaknife. Then, pure water was blown with shower for 10 seconds, this was shower-washed with pure water, and the air was blown with an air knife to reduce a stagnant liquid on the substrate.

Subsequently, a solution obtained by 10-fold diluting a cleaning agent (trade name: T-SD3, manufactured by Fuji Photo Film Co., Ltd.) with pure water was shower-blown at 33° C. for 20 seconds at a cone-type nozzle (swung) pressure of 0.02 MPa, four rotation brushes (shaken) having a nylon fur were arranged above and below the substrate, front side two brushes were rotated in a forward direction with a conveyance direction of the substrate, rear side two brushes were rotated in a reverse direction to the conveyance direction of the substrate, and while a cleaning shower was blown, the formed pattern image was rubbed to remove the residue to obtain a desired rib pattern.

Subsequently, the air was blown on an upper side of this glass substrate to remove a liquid, and pure water was blown with an aquaknife. Then, pure water was blown with shower for 10 seconds, this was shower-washed with pure water, and the air was blown with an air knife to remove a stagnant liquid and liquid droplets on the substrate.

Thereafter, without using a mask, post light exposure was performed on the glass substrate on which the rib pattern was formed from both sides, that is, from a surface and a back with a metal halide lamp manufactured by Ushio Inc., at each light exposure amount of 1000 mJ/cm², respectively, and this was baking-treated at 220° C. for 20 minutes. Further, this was baking-treated at 240° C. for 90 minutes to obtain a stripe-like rib (black matrix) having an optical density of 4.0, a thickness of 2.0 μm and an opening of a width of 100 μm. Hereinafter, the glass substrate with a rib provided thereon is also referred to as black matrix substrate.

—Evaluation of Black Matrix—

Herein, an optical concentration and a thickness were measured by the following methods.

1. Optical Concentration

An optical concentration of a black matrix after baking treatment was obtained by measuring a transmittance optical concentration (OD¹) of a black matrix substrate at a wavelength of 555 nm using a spectrophotometer (trade name: UV-2100, manufactured by Shimadzu Corporation), and measuring a transmittance optical concentration (OD⁰) of the glass substrate used in each black matrix substrate by the similar method, and subtracting OD⁰ from OD¹ to obtain a transmittance concentration OD(=OD¹−OD⁰).

2. Thickness

A thickness of the black matrix after baking treatment was measured using a contact-type surface roughness meter (trade name: P-10, manufactured by TENCOR).

Hereinafter, using the glass substrate with ribs formed thereon according to the second embodiment of the invention, a color filter in which ribs and colored pixels (R pixel, G pixel, and B pixel) were both cured better by the method according to the descriptions [Repulsion inking plasma treatment], [Preparation of coloring liquid composition] and [Formation of pixel by ink jet method] in Example 1 was manufactured (hereinafter, this is referred to as “color filter substrate”).

—Evaluation of Color Filter—

An extent of color mixing in the resulting color filter substrate was evaluated by the following method. Evaluation results are shown in the following Table 7.

3. Evaluation of Color Mixing

Among the aforementioned color filters, a color filter obtained by light-exposing and developing the photosensitive resin layer K1 after 300 m continuous lamination was observed with an optical microscope, and the number of pixels in which color mixing occurred was counted.

Using the above-obtained color filter substrate according to the second embodiment of the invention, a liquid crystal display device was manufactured by the method described in Example 1.

—Evaluation of Display Device—

Electricity was passed through the resulting liquid crystal display device, and the device was evaluated by contrast measurement by the following method. Evaluation results are shown in the following Table 7.

4. Evaluation of Contrast

A luminance meter (trade name: BM-5, manufactured by TOPCON CORPORATION JAPAN) was arranged at a distance of 50 cm in a normal line of a display panel surface of the liquid crystal display device, and a ratio of a luminance when the liquid crystal display device performed black display, to a luminance when the device performed white display was measured. Measurement was performed in a dark chamber. For practical evaluation, various displayed images were observed visually and, when an image was felt strongly, this was evaluated to be “A” and, when an image was not felt strongly, this was evaluated to be “B”.

### Examples 26 to 34, Comparative Examples 6 to 8

A photosensitive resin transfer material K 2′ was manufactured according to the same manner as that of Example 15 except that formation of the matting agent-containing layer and the protecting layer for protecting a matting agent-containing layer was changed to the following formation in manufacturing of the photosensitive resin transfer material of Example 15. In addition, formation and evaluation of a rib (black matrix substrate), manufacturing and evaluation of a color filter (color filter substrate), manufacturing and evaluation of a display device, and other operations were as in Example 15.

[Manufacturing of Photosensitive Resin Transfer Material K2′]

—Matting Agent-Containing Layer—

After biaxial stretching, and thermal fixation at 240° C. for 10 minutes, a polyethylene terephthalate film of a thickness of 75 μm, which had been subjected to corona discharge treatment, was prepared as a provisional support and, on one side thereof, the following coating solution 2 for a matting agent-containing layer was coated using a slit-like nozzle at 130° C. for 2 minutes to form a matting agent-containing layer having a thickness of 0.09 μm.

<Formulation of coating solution 2 for matting agent-containing layer>

| Aqueous acryl resin dispersion | 19.7 | parts |
|---|---|---|
| (trade name: Julymer ET-410, manufactured by Nihon Junyaku Co., Ltd., number average | | |
| molecular weight 9700, weight average molecular weight 17000, solid matter concentration | | |
| 30%) | | |
| Aqueous carbodiimide crosslinking agent solution | 4.0 | parts |
| (trade name: Carbodilite V-02-L2, manufactured by NISSHINBO INDUSTRIES, INC., solid | | |
| matter concentration 40%) | | |
| Seahoster KE-W30 (matting agent; silica fine particle manufactured by Nippon Shokubai | (amount in following Table 7) | |
| Co., Ltd., solid matter 20%, average particle diameter 0.3 μm, the number of matting agents | | |
| having a particle diameter of 0.90d ≦ D ≦ 1.1d: 95% [based on total amount of matting agents]) | | |
| Surfactant 4 | 0.73 | part |
| (trade name: Narrow Acty CL-95, manufactured by Sanyo Chemical Industries, Ltd.) | | |
| Surfactant 3 | 1.39 | parts |
| (trade name: Sandet BL, manufactured by Sanyo Chemical Industries, Ltd., solid matter | | |
| concentration 43%) | | |
| Metal oxide dispersion | 176 | parts |
| (trade name: TDL-1, manufactured by Mitsubishi Materials Corporation, solid matter | | |
| concentration 17%) | | |
| Distilled water | (added to a total amount of 1000 | parts) |

—Protecting Layer for Protecting Matting Agent-Containing Layer—

Then, the following coating solution 2 for forming a protecting layer for protecting a matting agent-containing layer was coated on a matting agent-containing layer, and dried at 130° C. for 2 minutes to form a protecting layer having a thickness of 0.06 μm.

<Formulation of coating solution 2 for forming protecting layer
for protecting matting agent-containing layer>

| | | |
|---|---|---|
| Polyethylene latex | 25.7 | parts |
| (trade name: Chemipearl S-75N, manufactured | | |
| by Mitsui Chemicals, Inc, solid matter | | |
| concentration 24%) | | |
| Colloidal silica | 12.4 | parts |
| (trade name: Snowtex C, manufactured by | | |
| Nissan Chemical Industries, Ltd., solid | | |
| matter concentration 20%) | | |
| Aqueous carbodiimide crosslinking agent | 0.77 | part |
| solution (trade name: Carbodilite V-02-L2, | | |
| manufactured by NISSHINBO INDUSTRIES, | | |
| INC., solid | | |
| matter concentration 40%) | | |
| Aforementioned surfactant 3 | 1.32 | parts |
| Aforementioned surfactant 4 | 0.52 | part |
| Distilled water | (added to a total | |
| | amount of 1000 | parts) |

TABLE 7

| | | | | Matting material | | | | | | |
|---|---|---|---|---|---|---|---|---|---|---|
| | | | | | Average | | | | | |
| | | Black matrix | | | particle | | | Evaluation | | |
| | Tension | Thickness | Optical | | diameter | Number | Content | Color mixing | | |
| | [N/m] | [μm] | concentration | Type | [μm] | ratio (*1) | [mg/m²] | [number/m²] | Contrast | |
| Example 15 | 120 | 2 | 4 | KE-W30 | 0.3 | 95% | 7 | 1 | A | 1250 |
| Example 16 | 120 | 2 | 4 | KE-W30 | 0.3 | 95% | 7 | 1 | A | 1250 |
| Example 17 | 60 | 2 | 4 | KE-W30 | 0.3 | 95% | 7 | 10 | A | 1200 |
| Example 18 | 80 | 2 | 4 | KE-W30 | 0.3 | 95% | 7 | 2 | A | 1240 |
| Example 19 | 140 | 2 | 4 | KE-W30 | 0.3 | 95% | 7 | 0 | A | 1250 |
| Example 20 | 200 | 2 | 4 | KE-W30 | 0.3 | 95% | 7 | 0 | A | 1250 |
| Example 21 | 120 | 1 | 4 | KE-W30 | 0.3 | 95% | 7 | 5 | A | 1180 |
| Example 22 | 120 | 3 | 4 | KE-W30 | 0.3 | 95% | 7 | 0 | A | 1250 |
| Example 23 | 120 | 2 | 5 | KE-W30 | 0.3 | 95% | 7 | 1 | A | 1300 |
| Example 24 | 120 | 2 | 3 | KE-W30 | 0.3 | 95% | 7 | 1 | A | 1150 |
| Example 25 | 120 | 2 | 4 | KE-W50 | 0.5 | 95% | 7 | 2 | A | 1240 |
| Example 26 | 100 | 2 | 4 | KE-W30 | 0.3 | 95% | 2.5 | 1 | A | 1240 |
| Example 27 | 120 | 2 | 4 | KE-W30 | 0.3 | 95% | 4 | 1 | A | 1240 |
| Example 28 | 120 | 2 | 4 | KE-W30 | 0.3 | 95% | 4.5 | 1 | A | 1240 |
| Example 29 | 120 | 2 | 4 | KE-W30 | 0.3 | 95% | 7 | 1 | A | 1240 |
| Example 30 | 140 | 2 | 4 | KE-W30 | 0.3 | 95% | 9 | 0 | A | 1250 |
| Example 31 | 140 | 2 | 4 | KE-W30 | 0.3 | 95% | 11 | 0 | A | 1250 |
| Example 32 | 140 | 2 | 4 | KE-W30 | 0.3 | 95% | 18 | 1 | A | 1240 |
| Example 33 | 140 | 2 | 4 | KE-W30 | 0.3 | 95% | 30 | 7 | A | 1200 |
| Example 34 | 140 | 2 | 4 | KE-W30 | 0.3 | 95% | 1.5 | 10 | A | 1180 |
| Comparative Example 3 | 50 | 2 | 4 | KE-W30 | 0.3 | 95% | 7 | 70 | B | 760 |
| Comparative Example 4 | 220 | 2 | 4 | KE-W30 | 0.3 | 95% | 7 | Wrinkle occurrence on | | |
| | | | | | | | | provisional support | | |
| | | | | | | | | Impossible to | | |
| | | | | | | | | manufacture color filter | | |
| Comparative Example 5 | 120 | 2 | 4 | — | — | — | — | 150 | B | 700 |
| Comparative Example 6 | 50 | 2 | 4 | KE-W30 | 0.3 | 95% | 8 | 85 | B | 750 |
| Comparative Example 7 | 220 | 2 | 4 | KE-W30 | 0.3 | 95% | 8 | Wrinkle occurrence on | | |
| | | | | | | | | provisional support | | |
| | | | | | | | | Impossible to | | |
| | | | | | | | | manufacture color filter | | |
| Comparative Example 8 | 120 | 2 | 4 | — | — | — | — | 150 | B | 700 |

*1: Number of matting agents having a particle diameter included in 0.9d ≦ D ≦ 1.1d

As shown in the Table 7, in Examples, occurrence of color mixing was suppressed, a displayed image had a high contrast, and a clear image was obtained. To the contrary, in Comparative Examples, color mixing occurred, a displayed image had a low contrast, and clearness was lacked.

When one intends to form a colored pixel utilizing an ink jet format, a wall for compartmenting regions in which one tries to form each color pixel is formed in advance, and a coloring ink is discharged into a region surrounded by the wall, thereby, a pixel can be formed. In this case, particularly, from a viewpoint of not only easy formation of pixels, and the cost, but also a precision of manufacturing a black matrix, it is desired that the wall is formed by a transferring method.

However, when this wall is formed using a transfer material having a thermoplastic resin layer and a photosensitive resin layer, a breaking defect occurs in the wall, leading to color mixing in some cases, when the wall is formed by laminating the transfer material on a desired support. Particularly, when lamination is continuously performed over a long distance, an extent of occurrence of a breaking defect becomes gradually notable depending on a distance. In addition, when a colored region is formed by discharging an ink by an ink jet method, there is great influence on color mixing, and color mixing becomes one cause for deteriorating color property of the color filter, and the display performance.

The invention has been done in view of the forgoing, and according to a first embodiment of the second aspect of the invention, there are provided a photosensitive transfer material which can prevent occurrence of a breaking defect of a rib for forming a colored region by imparting an ink by an ink jet format, and can prevent color mixing which occurs upon manufacturing of the color filter, as well as a rib in which occurrence of a breaking defect is prevented, and a method for forming the same, a color filter in which color mixing is prevented, and a method for manufacturing the same, and a display device having a favorable display property. According to a second embodiment of the second aspect of the invention, there are provided a method for manufacturing a laminate which can stably prevent a breaking defect of a laminate which is subjected to transference formation (preferably, rib for forming a colored region by imparting an ink by an ink jet method), a member for a display device in which occurrence of a breaking defect is prevented, a color filter for a display device in which color mixing upon manufacturing of a color filter is prevented, and a method for manufacturing the color filter, as well as a display device having a favorable display property (including color property and contrast).

According to the first embodiment of the second aspect of the invention, there can be provided a photosensitive transfer material which can prevent occurrence of a breaking defect of a rib for forming a colored region by imparting an ink by an ink jet method, and can prevent color mixing which occurs upon manufacturing of a color filter.

In addition, according to the first embodiment of the second aspect of the invention, there can be provided a rib in which occurrence of a breaking defect is prevented, and a method for forming the same, a color filter in which color mixing is prevented, and a method for manufacturing the same, as well as a display device having a favorable display property.

According to the second embodiment of the second aspect of the invention, there can be provided a laminate which can stably prevent a breaking defect of a laminate to be subjected to transference formation (preferably, rib for imparting an ink by an ink jet method to form a colored region).

In addition, according to the second embodiment of the second aspect of the invention, there can be provided a member for a display device in which occurrence of a breaking defect is prevented, a color filter for a display device in which color mixing upon manufacturing of a color filter is prevented, and a method for manufacturing the color filter, as well as a display device having a favorable display property (including a color property and a color contrast).

The disclosure of Japanese Patent Application Nos. 2006-263386, 2006-269997, 2006-351674, 2007-060227, 2007-114568, 2006-293013, 2006-292984, 2006-292976, 2006-293113, 2006-292987 and 2006-292793 is incorporated by reference herein in its entirety.

All publications, patent applications, and technical standards mentioned in this specification are herein incorporated by reference to the same extent as if each individual publication, patent application, or technical standard was specifically and individually indicated to be incorporated by reference.

1. A manufacturing apparatus for a photosensitive laminate which produces a photosensitive laminate by: delivering a photosensitive web having a photosensitive material layer and a protective film sequentially laminated, onto a support; forming at least a processing site corresponding to a boundary position between a peeled portion and a remaining portion, in the protective film; peeling off the peeled portion of the protective film; continuously delivering the photosensitive web together with substrates supplied at predetermined intervals, to a space between a pair of pressure rollers; arranging the remaining portion of the protective film between the substrates; and pasting the exposed photosensitive material layer onto the substrate, comprising:
a processing site detector arranged in a predetermined site on a conveyance path for the photosensitive web between a processing section which forms the processing site and the pressure rollers, that detects the position of the processing site formed in the protective film;
a dislocation amount calculation section which calculates the dislocation amount of the processing site with respect to a reference position, detected by the processing site detector; and
a processing site position adjusting section which adjusts the position of the processing site with respect to the substrate, based on the dislocation amount calculated by the dislocation amount calculation section.

2. A manufacturing apparatus for a photosensitive laminate according to claim 1, wherein the processing site position adjusting section adjusts the feed amount of the remaining portion of the photosensitive web by means of the pressure rollers, based on the dislocation amount.

3. A manufacturing apparatus for a photosensitive laminate according to claim 1, wherein the processing site position adjusting section adjusts the delivery timing for delivering the substrates to the space between the pressure rollers, based on the dislocation amount.

4. A manufacturing apparatus for a photosensitive laminate according to claim 1, wherein the processing site position adjusting section adjusts the position of the processing site by the processing section, based on the dislocation amount.

5. A manufacturing apparatus for a photosensitive laminate according to claim 1, wherein a plurality of photosensitive webs are pasted in parallel on the substrate.

6. A manufacturing apparatus for a photosensitive laminate according to claim 5, wherein the dislocation amount calculation section calculates the respective dislocation amounts of the respective photosensitive webs pasted in parallel on the substrate, to obtain the arithmetic mean value thereof; and
the processing site position adjusting section adjusts the position of the processing site with respect to the substrate, based on the arithmetic mean value.

7. A manufacturing apparatus for a photosensitive laminate according to claim 6, wherein the processing site position adjusting section adjusts the position of the processing site with respect to the substrate, assuming that the position adjustment value is a multiplication of the arithmetic mean value times a predetermined coefficient.

8. A manufacturing apparatus for a photosensitive laminate according to claim 7, wherein the coefficient is set within a range of 1.0 to 1.5.

9. A manufacturing method for a photosensitive laminate in which a photosensitive laminate is produced by: delivering a photosensitive web having a photosensitive material layer and a protective film sequentially laminated, onto a support; forming at least a processing site corresponding to a boundary position between a peeled portion and a remaining portion, in the protective film; peeling off the peeled portion of the protective film; continuously delivering the photosensitive web together with substrates supplied at predetermined intervals, to a space between a pair of pressure rollers; arranging the remaining portion of the protective film between the substrates; and pasting the exposed photosensitive material layer onto the substrate, comprising:
detecting the position of the processing site formed in the protective film;
calculating the detected dislocation amount of the processing site with respect to a reference position; and
adjusting the position of the processing site with respect to the substrate, based on the calculated dislocation amount.

10. A manufacturing method for a photosensitive laminate according to claim 9, wherein the feed amount of the remaining portion of the photosensitive web by means of the pressure rollers is adjusted based on the dislocation amount.

11. A manufacturing method for a photosensitive laminate according to claim 9, wherein the delivery timing for delivering the substrates to the space between the pressure rollers is adjusted based on the dislocation amount.

12. A manufacturing method for a photosensitive laminate according to claim 9, wherein the position of the processing site is adjusted based on the dislocation amount.

13. A manufacturing method for a photosensitive laminate according to claim 9, wherein: a plurality of photosensitive webs are pasted in parallel on the substrate; the respective dislocation amounts of the respective photosensitive webs are calculated and the arithmetic mean value thereof is obtained; and the position of the processing site with respect to the substrate is adjusted based on the arithmetic mean value.

14. A manufacturing method for a photosensitive laminate according to claim 13, wherein the position of the processing site with respect to the substrate is adjusted, assuming that the position adjustment value is a multiplication of the arithmetic mean value times a predetermined coefficient.

15. A manufacturing method for a photosensitive laminate according to claim 14, wherein the coefficient is set within a range of 1.0 to 1.5.

16-70. (canceled)
